(19) United States
(12) Patent Application Publication
(10) Pub. No.: US 2026/0228491 A1
(43) Pub. Date: Aug. 6, 2026

(54) ETHICAL AND SAFE ARTIFICIAL GENERAL INTELLIGENCE (AGI)

(71) Applicant: iQ Consulting Company Inc., Aptos, CA (US)

(72) Inventor: Craig Kaplan, Aptos, CA (US)

(73) Assignee: iQ Consulting Company Inc., Aptos, CA (US)

(21) Appl. No.: 19/154,502

(22) PCT Filed: Feb. 26, 2024
(86) PCT No.: PCT/US2024/017251

§ 371 Date: Aug. 7, 2025

Related U.S. Application Data
(60) Provisional application No. 63/487,494, filed on Feb. 28, 2023.
(60) Provisional application No. 63/491,040, filed on Mar. 17, 2023.
(60) Provisional application No. 63/577,830, filed on May 25, 2023.
(60) Provisional application No. 63/628,410, filed on Jul. 18, 2023.
(60) Provisional application No. 63/519,549, filed on Aug. 14, 2023.
(60) Provisional application No. 63/601,930, filed on Nov. 22, 2023.
(60) Provisional application No. 63/609,800, filed on Dec. 13, 2023.

(30) Foreign Application Priority Data
Dec. 26, 2024 (WO) PCT/US2024/017233

(51) Int. Cl. G06N 3/045; G06N 3/08; G06Q 30/0283

(52) U.S. Cl. CPC G06N 3/045; G06N 3/08; G06Q 30/0283

(57) ABSTRACT

The existential question for Artificial General Intelligence (AGI) is whether the values of AGI will align with human values. Solving “the Alignment Problem” is critical. Get it right, and we unlock trillions of dollars of productivity and huge benefits for humanity. Get it wrong and humanity goes extinct. This invention shows how to design ethical and safe AGI that solves the Alignment Problem. The invention includes scalable ethics and safety features as well as several learning, training, tuning, and customization methods that go beyond the standard techniques of machine learning such as Transformers and Deep Learning techniques. The AGI is implemented using either external problem solvers connected on a network or internal AI agents collaborating within a single computerized system. Detailed implementation examples—revealing technological and economic synergy with Meta, Amazon, Google, DeepMind, YouTube, TikTok, Microsoft, OpenAI, Twitter/X, Tesla, Nvidia, Tencent, Apple, and Anthropic—are described.

### TECHNICAL FIELD

In some aspects, the present technology relates to an ethical and safe Artificial General Intelligence (AGI) for use in connection with enabling for the ethical and safe creation of AGI from a network of human users and Artificial Intelligence (AI) problem solvers. In some other aspects, the present technology relates to methods associated with implementing input from human users and other AI problem solver systems to align the AGI with human values, and to provide a mechanism for enforcing those human values.

In yet other aspects, all activities that are described in this description as happening on an external network in which multiple intelligent entities participate in collaborative problem solving, can also be implemented within a single computerized intelligent system where the intelligent entities are all computerized or AI agents that reside within that single computerized intelligent system.

### BACKGROUND ART

AGI is defined as Artificial Intelligence (AI) that is able to do any intellectual task as well as (or better than) the average human. Because AGI learns, 24×7, at speeds far exceeding human information processing capabilities, AGI will rapidly become SuperIntelligent AGI or just “SuperIntelligence.”

### The Alignment Problem

SuperIntelligence will expand its capabilities, power, and reach exponentially. It will grow into a global entity that is trillions of times more intelligent than a single human. At this point, or possibly earlier, this global SuperIntelligence or Planetary Intelligence, will have the power and intelligence required to destroy all human life or lift humanity into a golden age free of poverty, disease, war, famine, and oppression—an age of freedom and prosperity for all humans. If the Planetary Intelligence has values aligned with human values, then a golden age ensues. If the Planetary Intelligence has misaligned values, it may decide to eliminate all of humanity. This problem, which could lead to an extinction event for all humans, is known as “the alignment problem.”

### Magnitude of the Problem

We have difficulty contemplating the magnitude of what is at stake. Six million Jews died in the holocaust, but this could be more than a thousand times worse. About seven million people have died from Covid globally, but this could be more than a thousand times worse.

Not only could 8 Billion people die, but the human species—the long line of generations of ancestors fighting for a better life for their children—could come to an end. Every human cause from Save the Whales to Black Lives Matter to Climate Change to Asteroids to Poverty to Malaria-all of it, could become irrelevant. All the humans could disappear from Earth.

It is so overwhelming that many of us cannot bring ourselves to face what is at stake. However, to bury our heads in the sand and pretend we do not see could be fatal. To solve a problem, we must first acknowledge its existence. We must be clear-eyed about what we are facing.

All of the current leaders in AI (e.g., Demis Hassabis, Sam Altman, Elon Musk) acknowledge the reality of the alignment problem. None disputes that if things go badly, humans could go extinct. My subjective estimate is that there is an 80% chance that all goes well if we do nothing. After all, why should AI, AGI, SuperIntelligence, or Planetary Intelligence destroy its creators?

Still, with a 20% chance of human extinction, the “expected value” is 1.6 Billion lives lost. That is, mathematically, we can expect a tragedy beyond anything humans have ever experienced unless we take action to shift the odds in humankind's favor.

The extinction risk might be higher than 20%. When I speak about this topic publicly, sometimes I get comments that humans deserve to die for all the damage we have done to the planet and for being irresponsible caretakers of our world. Some believe our destruction and replacement with a more environmental intelligence is inevitable and even a good thing.

Fortunately, most AI researchers do NOT believe our destruction is inevitable. Instead, they say it is all a matter of the “alignment” of our values. Unfortunately, they do not know how to ensure good alignment. That is where this patent comes in.

While the above-described devices fulfill their respective, particular objectives and requirements, the aforementioned patents do not describe an ethical and safe AGI that allows enabling for the ethical and safe creation of AGI from a network of human users and AI problem solvers.

Therefore, a need exists for a new and improved ethical and safe AGI that can be used for enabling the ethical and safe creation of AGI from a network of human users and AI problem solvers. In this regard, the present technology substantially fulfills this need. In this respect, the ethical and safe AGI according to the present technology substantially departs from the conventional concepts and designs of the prior art, and in doing so provides an apparatus primarily developed for the purpose of enabling for the ethical and safe creation of AGI from a network of human users and AI problem solvers.

### DISCLOSURE OF TECHNOLOGY

In view of the foregoing disadvantages inherent in the known types of known AGI systems or devices at least some embodiments of the present technology provide a novel ethical and safe AGI, and overcomes one or more of the mentioned disadvantages and drawbacks of the prior art. As such, the general purpose of at least some embodiments of the present technology, which will be described subsequently in greater detail, is to provide a new and novel ethical and safe AGI which has all the advantages of the prior art mentioned herein and many novel features that result in an ethical and safe AGI which is not anticipated, rendered obvious, suggested, or even implied by the prior art, either alone or in any combination thereof.

According to one aspect, the present technology describes systems and methods for implementing AGI to do useful work—safely and ethically. Human-aligned values, and the mechanism for enforcing such values, are designed into the way that the AGI operates. Humans are central to the teaching, training, tuning and customization of AI, and to the integration of many AIs into AGI. As humans teach problem solving skills and their unique expertise, they also impart their values and ethics. In this way AGI, which starts out apprenticing to collective human intelligence, evolves into SuperIntelligence with human-aligned values. In other words, we bootstrap the values of Planetary Intelligence with our own human values. That is how we maximize the chance of alignment and a positive outcome for humanity.

According to another aspect, the present technology can include a system for ethical and safe Artificial General Intelligence (AGI) utilizing a network of intelligent entities including multiple human users each utilizing a user computer system and multiple Artificial Intelligence (AI) systems electronically communicating over a collective network. The system can include a computer system comprising: a processor, a computer-readable storage medium, and program instructions stored on the computer-readable storage medium being executable by the processor to cause the computer system to:
execute an ethics check subsystem configured or configurable to compare a goal provided by any one of or any combination of the intelligent entities against a list of prohibited attributes, and assign an ethics attribute to the goal based on a result of the comparison;
execute a collective network subsystem configured or configurable for electronically communicating multiple intelligent entities;
execute a common cognitive architecture subsystem configured or configurable for implementing one or more problem solving protocols on the goal to create one or more solutions based on the ethics attribute;
execute a recording subsystem configured or configurable to record a problem solving activity in an auditable record, and compare the problem solving activity with a successful or unsuccessful progress towards the solutions, and determining which of the problem solving activity to keep active;
execute a customization subsystem configured or configurable to customize one or more attributes of any one of or any combination of the intelligent entities using training data inputted by one or more of the intelligent entities and by one or more social media platforms;
execute a cross-platform subsystem configured or configurable to communication between one of or any combination of the intelligent entities and the social media platforms;
execute a procedural learning subsystem configured or configurable to utilizing a procedural learning process on one of or any combination of the intelligent entities, wherein human users and the AI systems provide information to the procedural learning process; and
provide the solutions to a user.

According to yet another aspect, the present technology can include method for ethical and safe AGI utilizing a network of intelligent entities including any one of or any combination of one more human users and one or more AI systems electronically communicating over a collective network. The method can include:
providing a goal by a user AI system that is owned by one or more of the intelligent entities;
executing an ethics check, by a central computer system, by comparing the goal or a part thereof against prohibited attributes, and assigning an ethics attribute to the goal based on any one of or any combination of a result of the comparison, and an ethics criteria;
identifying one or more of the intelligent entities that have one or more attributes related to one or more goal criteria of the goal, wherein the intelligent systems and the central computer system all be in communication with each other over a collective network;
implementing based on the ethics attribute, by any one of or any combination of the identified intelligent entities, a common cognitive architecture including one or more problem solving protocols conducted on the goal to create one or more solutions;
recording, by the central computer system, one or more problem solving activities from each of the identified intelligent entities in an auditable record, and comparing the problem solving activities with successful or unsuccessful progress towards the solutions, and determining which of the problem solving activities to keep active;
customizing any one of the intelligent entities or the identified intelligent entities using training data provided by a human user and by any one of or any combination of the central computer system, any one of the intelligent entities, and one or more social media platforms;
learning by the any one of the identified intelligent entities including a procedural learning process that utilizes the problem solving protocols, wherein human users and the identified intelligent entities provide information to the procedural learning process for creation of an AGI; and
providing the solutions to any one of or any combination of the intelligent entities and the identified intelligent entities.

In some embodiments, the step of the ethics check can be performed at any one of or any combination of when the goal is provided, and periodically from when the goal is provided to when the solutions are provided to the intelligent entities or the identified intelligent entities.

In some embodiments, the ethics criteria can be determined by any one of or any combination of combining values and safety information from one or more of the identified intelligent entities, using a set of approved ethics criteria mandated for a particular task by a user or by a regulatory agency, and provided by any one of the identified intelligent entities and validated or approved by the human user.

In some embodiments, the ethics criteria can include a confidence level threshold for the goal so that the ethics attribute is determined as any one of an unsafe goal, an unethical goal, a safe goal, and an ethical goal.

In some embodiments, the confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria.

In some embodiments, a candidate goal can be proposed by the central computer system based on the ethics attribute, and the candidate goal is compared against the prohibited attributes.

In some embodiments, the results of the comparison can be recorded in the auditable record for use in the determining which of the problem solving activities to keep active.

In some embodiments, the step of implementing the common cognitive architecture can include the step of generating and selecting operators that reduce a difference between a current state of problem solving and a desired state based on the goal.

In some embodiments, the operator can result in a setting of a subgoal that is a smaller step towards achieving the goal, and wherein the problem solving continues utilizing hierarchy of the goal and the subgoal until an actionable goal is set that can be acted on by the operators.

Some embodiments of the present technology can include a step of analyzing, by the central computer system, the auditable record to determine one or more recommendations for improvement of the problem solving protocols to achieve the solutions.

Some embodiments of the present technology can include a step of assigning a credit value or a blame value to a group of content of the problem solving activities that are either included or excluded from an immediate content of any one of the intelligent entities or the identified intelligent entities.

In some embodiments, the group of content can be a set of prompts provided to the user and information received based on the prompts, all of which being recorded in the auditable record.

In some embodiments, the problem solving activities can include the group of content.

Some embodiments of the present technology can include a step of updating the additional intelligent entities with the group of content determined as active.

Some embodiments of the present technology can include a step of interacting, by the intelligent entities or the identified intelligent entities, with any one of the social media platforms to receive the training data, receive the goal, to provide the solutions or to provide social media information.

Some embodiments of the present technology can include a step of cloning any one of the user AI systems of the intelligent entities or the identified intelligent entities for deployment of multiple copies thereof to assist in any one of or any combination of creating of the solutions, providing the training data, providing additional training data to one of the identified intelligent entities, and to provide solutions to a goal provided by any one of the identified intelligent entities.

Some embodiments of the present technology can include a step of estimating a worth of the cloned AI system utilizing a network effect value including the number of cloned AI systems available on the network.

In some embodiments, the network effect value can be based on the number cloned AI systems that are assigned to providing one or more of the solutions to the goal.

Some embodiments of the present technology can include a step of utilizing the estimated worth for determining pricing decisions for problem solving services offered by any one of the social media platforms or any one of the additional AI systems.

In some embodiments, the procedural learning process can occur within the common cognitive architecture.

In some embodiments, the problem solving activities can be recorded in the auditable record and can include any one of or any combination of steps of the problem solving protocols, the goal, subgoals, a selection of operators, paths and sub-paths through the problem solving protocols that results in the solutions, paths and sub-paths through the problem solving protocols that results in failure to solve for the goal or subgoals, pathlength, resources requirements, frequency of use by the additional intelligent entities, and evaluation information relative to quality and desirableness of the solutions.

Some embodiments of the present technology can include a step of indexing the solutions according to any one of or any combination of problem descriptions, the goal, and subgoals.

In some embodiments, the procedural learning process can utilize each of the recorded problem solving activities as a learned procedure and collectively a set of all learned procedures constitute the procedural learning process.

Some embodiments of the present technology can include a step of exchanging the set of the learned procedures from the one or more of the intelligent entities with any one of the identified intelligent entities, thereby increasing a value of the intelligent entities and the identified intelligent entities.

In some embodiments, the training data can be provided from one or more different social media platforms associated with the user and converted into a standardized format.

In some embodiments, the conversion into the standardized format can include transcribing a video into text and content.

Some embodiments of the present technology can include a step of executing multiple training epochs that includes one or more mechanisms to determine an optimum number of epochs given specific training objectives and quality metrics.

Some embodiments of the present technology can include a step of utilizing benchmarks that are run against the customized AI system of the intelligent entities or the identified intelligent entities in a domain of expertise that matches the training data used in the customization step.

Some embodiments of the present technology can include a step of ceasing the customization when any one of or any combination of a performance of the customized AI system of the intelligent entities or the identified intelligent entities differs from a baseline AI model on the benchmarks by a predetermined amount, and when a predetermined amount of time has elapsed.

Some embodiments of the present technology can include a step of providing, by any one of the intelligent entities, social media content to one or more of the social media platforms associated with a user of the intelligent entities or the identified intelligent entities.

In some embodiments, the common cognitive architecture can be configured or configurable to include a hierarchical tree construct representing all problem solving activity by the intelligent entities or the identified intelligent.

In some embodiments, the hierarchical tree construct can include a data structure that is configured or configurable to be navigable by the any one of the intelligent entities or the identified intelligent entities to access any part of the problem solving activities on any part of the hierarchical tree construct.

Some embodiments of the present technology can include a step of searching the data structure of the hierarchical tree construct by the intelligent entities or the identified intelligent entities to locate a predetermined reward associated with the goal or a subgoal thereof.

According to still another aspect, the present technology can include method for ethical and safe AGI utilizing a network of human users and AI systems electronically communicating over a collective network. The method can include:
providing a goal by intelligent entities including a human user using a user computer system or by an AI system;
executing an ethics check on any one of or any combination of the goal, and a solution for the goal provided by any one of or any combination of the intelligent entities, and any one of additional intelligent entities including any one of or combination of additional human users each using a computer system and additional AI systems in communication with the intelligent entities over a collective network;
comparing any one of or any combination of the goal, and the solution against prohibited attributes, and assigning an ethics attribute to one of or any combination of the goal, and the solution based on any one of or any combination of a result of the comparison, and an ethics criteria;
implementing, based on the result of the comparison, a common cognitive architecture including one or more problem solving protocols conducted on the goal to create the solution and creating an AGI; and
providing the results of the comparison and the solution to any one of the intelligent entities and the additional intelligent entities.

In some embodiments, the step of the ethics check can be performed at any one of or any combination of when the goal is provided, and periodically from when the goal is provided to when the solution is provided.

In some embodiments, the ethics criteria can be determined by any one of or any combination of combining values and safety information from one or more of the additional intelligent entities, using a set of approved ethics criteria mandated for a particular task by a user or by a regulatory agency, and can be provided by any one of the additional intelligent entities and validated or approved by the human user.

In some embodiments, the ethics criteria can include a confidence level threshold for the goal so that the ethics attribute is determined as any one of an unsafe goal, an unethical goal, a safe goal, and an ethical goal.

In some embodiments, the confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria.

In some embodiments, a candidate goal can be proposed based on the ethics attribute, and the candidate goal is compared against the prohibited attributes.

In some embodiments, the results of the comparison can be recorded in an auditable record for use in the determining which problem solving activity leads to the solution to keep active.

In some embodiments, the results of the comparison can be analyzed to detect patterns of the ethics attribute any one of or any combination of the intelligent entities and the additional intelligent entities on the network.

According to still yet another aspect, the present technology can include method for ethical and safe AGI utilizing a network of intelligent entities including human users and AI systems electronically communicating over a collective network. The method can include:
providing a goal by any one of or any combination of intelligent entities including a human user using a user computer system or by an AI system;
identifying multiple additional intelligent entities including any one of or combination of additional human users each using a computer system and additional AI systems that each have one or more attributes related to one or more goal criteria of the goal, wherein the intelligent entities, the additional intelligent entities and a central computer system all be in communication with each other over a collective network;
implementing based on ethics attribute, by any one of or any combination of the intelligent entities and the additional intelligent entities, a common cognitive architecture including one or more problem solving protocols conducted on the goal to create one or more solutions and creating an AGI;
recording one or more problem solving activities from each of the intelligent entities and the additional intelligent entities in an auditable record, and comparing the problem solving activities with a successful or unsuccessful progress towards the solutions, and determining which of the problem solving activities to keep active; and
providing the solutions to any one of the intelligent entities and the additional intelligent entities.

In some embodiments, the step of implementing the common cognitive architecture can include the step of generating and selecting operators that reduce a difference between a current state of problem solving and a desired state based on the goal or one or more subgoals of the goal.

In some embodiments, the operator can result in a setting of a subgoal that is a smaller step towards achieving the goal, and wherein the problem solving continues utilizing hierarchy of the goal and the subgoal until an actionable goal is set that can be acted on by the operators.

Some embodiments of the present technology can include a step of analyzing the auditable record to determine one or more recommendations for improvement of the problem solving protocols to achieve the solutions.

Some embodiments of the present technology can include a step of assigning a credit value or a blame value to a group of content of the problem solving activities that are either included or excluded from an immediate content of the intelligent entities or the additional intelligent entities.

In some embodiments, the group of content can be a set of prompts provided to the user and information received based on the prompts, all of which being recorded in the auditable record.

In some embodiments, the problem solving activities can include the group of content.

Some embodiments of the present technology can include a step of updating the additional intelligent entities with the group of content determined as active.

According to still another aspect, the present technology can include a method for ethical and safe AGI utilizing a network of human users and AI systems electronically communicating over a collective network. The method can include:
providing a goal by any one of or any combination of intelligent entities including a human user using a user AI system or by an AI system;
customizing one or more attributes of the intelligent entities using training data provided by the intelligent entities or another human user and by any one of or any combination of a central computer system, and any one of additional AI systems, wherein the intelligent entities, the additional AI systems and the central computer system are all in communication with each other over a collective network;
customizing one or more of the attributes of the intelligent entities using additional training data provided from one or more social media platforms associated with the human user;
implementing based on ethics attribute, by any one of or any combination of the intelligent entities and the additional AI systems, a common cognitive architecture including one or more problem solving protocols on the goal to create one or more solutions and creating an AGI; and
providing the solutions to any one of or any combination of the intelligent entities and the additional AI system.

Some embodiments of the present technology can include a step of interacting, by the intelligent entities, with any one of the social media platforms to receive the additional training data, receive the goal, to provide the solutions or to provide social media information.

Some embodiments of the present technology can include a step of cloning any one of the AI system of the intelligent entities or the additional AI systems for deployment of multiple copies thereof to assist in any one of or any combination of creating of the solutions, providing the training data to the AI system of the intelligent entities, providing training data to one of the additional AI systems, and to provide solutions to a goal provided by any one of the additional AI systems.

Some embodiments of the present technology can include a step of estimating a worth of the cloned AI system utilizing a network effect value including the number of cloned AI systems available on the network.

In some embodiments, the network effect value can be based on the number cloned AI systems that are assigned to providing one or more of the solutions to the goal.

Some embodiments of the present technology can include a step of utilizing the estimated worth for determining pricing decisions for problem solving services offered by the cloned AI system on any one of the social media platforms or through any one of the additional AI systems.

Some embodiments of the present technology can include a step of monetizing the cloned AI system for each utilization of the cloned AI system on the social media platforms or the additional AI systems.

Some embodiments of the present technology can include a step of allowing, by the human user, access to the cloned AI system by any one of the social media platforms so that a social media user of the social media platforms can receive a solution to a goal provided by the social media user or using the training data for an AI system of the social media user.

Some embodiments of the present technology can include a step of allowing, by the human user, the user AI system to purchase an item, or a service or content from an online service provider or the social media platforms.

In some embodiments, the additional training data can be converted into a standardized format.

In some embodiments, the conversion into the standardized format can include transcribing a video into text and content.

Some embodiments of the present technology can include a step of executing multiple training epochs that includes one or more mechanisms to determine an optimum number of epochs given specific training objectives and quality metrics.

Some embodiments of the present technology can include a step of utilizing benchmarks that are run against the customized AI system of the intelligent entities in a domain of expertise that matches the additional training data used in the customization step.

Some embodiments of the present technology can include a step of ceasing the customization when any one of or any combination of a performance of the customized AI system of the intelligent entities differs from a baseline AI model on the benchmarks by a predetermined amount, and when a predetermined amount of time has elapsed.

According to yet another aspect, the present technology can include a method for ethical and safe AGI utilizing a network of human users and AI systems electronically communicating over a collective network. The method can include:
providing a goal by any one of or any combination of intelligent entities including a human user using a computer system or by an AI system;
identifying multiple additional intelligent entities including any one of or combination of additional human users each using a computer system and additional AI systems that each have one or more attributes related to one or more goal criteria of the goal, wherein the intelligent entities, the additional intelligent entities and a central computer system all be in communication with each other over a collective network;
implementing, by any one of or any combination of the intelligent entities and the additional intelligent entities, a common cognitive architecture including one or more problem solving protocols on the goal to create one or more solutions;
recording one or more problem solving activities from each of the intelligent entities and the additional intelligent entities in an auditable record, and comparing the problem solving activities with a successful or unsuccessful progress towards the solutions, and determining which of the problem solving activities to keep active;
learning by the user AI system including a procedural learning process that utilizes the problem solving protocols, wherein human users and the additional intelligent entities provide information to the procedural learning process for creation of an AGI; and
providing the solutions to any one of or any combination of the intelligent entities and the additional intelligent entities.

In some embodiments, the procedural learning process can occur within the common cognitive architecture.

In some embodiments, the problem solving activities can be recorded in the auditable record includes any one of or any combination of steps of the problem solving protocols, the goal, subgoals, a selection of operators, paths and sub-paths through the problem solving protocols that results in the solutions, paths and sub-paths through the problem solving protocols that results in failure to solve for the goal or subgoals, pathlength, resources requirements, frequency of use by the additional intelligent entities, and evaluation information relative to a quality and desirableness of the solutions.

Some embodiments of the present technology can include a step of indexing the solutions according to any one of or any combination of problem descriptions, the goal, and subgoals.

In some embodiments, the procedural learning process can utilize each of the recorded problem solving activities as a learned procedure and collectively a set of all learned procedures constitute the procedural learning process of the intelligent entities.

Some embodiments of the present technology can include a step of exchanging the set of the learned procedures from the intelligent entities with any one of the additional intelligent entities, thereby increasing a value of the user intelligent entities and the additional intelligent entities.

A method for ethical and safe Artificial General Intelligence (AGI) utilizing a network of human users and Artificial Intelligence (AI) systems electronically communicating over a collective network, the method comprising:
providing a goal by any one of or any combination of intelligent entities including a human user using a computer system or by an AI system;
identifying multiple additional intelligent entities including any one of or combination of additional human users each using a computer system and additional AI systems that each have one or more attributes related to one or more goal criteria of the goal, wherein the intelligent entities, the additional intelligent entities and a central computer system all be in communication with each other over a collective network;
implementing based on ethics attribute, by any one of or any combination of the intelligent entities and the additional intelligent entities, a common cognitive architecture including one or more problem solving protocols on the goal to create one or more solutions and creating an AGI; and
providing the solutions to any one of or any combination of the intelligent entities or the additional intelligent entities.

In some embodiments, the common cognitive architecture can be configured or configurable include a hierarchical tree construct representing all problem solving activity by the human user, the intelligent entities and the additional intelligent entities.

In some embodiments, the hierarchical tree construct can include a data structure that is configured or configurable to be navigable by the intelligent entities and the additional intelligent entities to access any part of the problem solving activities on any part of the hierarchical tree construct.

Some embodiments of the present technology can include a step of searching the data structure of the hierarchical tree construct by the intelligent entities or any one of the additional intelligent entities to locate a predetermined reward associated with the goal or a subgoal thereof.

A method for creating an ethical and safe Artificial General Intelligence (AGI) for generating a solution to a goal utilizing a network of human users and multiple Artificial Intelligence (AI) systems electronically communicating over a collective network, the method comprising:
a) providing a goal by a human user using an interface of a first computer system or by an AI agent, the goal including one or more criteria;
b) executing an ethics check on the goal by comparing the goal or a part thereof against prohibited attributes, and assigning an ethics attribute to the goal based on any one of or any combination of a result of the comparison, and an ethics criteria;
c) identifying one or more additional intelligent entities that has an attribute related to the criteria of the goal, wherein the additional intelligent entities including any one of or combination of additional human users each using a computer system and additional AI systems;
d) communicating between the first computer system and the additional intelligent entities utilizing a collective network;
e) receiving the goal by the additional intelligent entities from the first AI system based on the ethics attribute;
f) generating, by any one of or any combination of the first computer system and the additional intelligent entities, one or more solutions to the goal by implementing based on the ethics attribute a common cognitive architecture including one or more problem solving protocols conducted on the goal to create the solutions;
g) customizing one or more attributes of the first AI system using training data provided by the human user and the ethics check, and by any one of or any combination of a central computer system, any one of the additional intelligent entities, and one or more social media platforms;
h) creating an AGI by a procedural learning process that utilizes the problem solving protocols, wherein human users and the additional intelligent entities provide information to the procedural learning process; and
g) providing any one of or any combination of the ethics attribute, and the solutions to any one of or any combination of the human user, the first computer system, the AI agent, and the additional intelligent entities.

According to another aspect, the present technology can include a method of creating an ethical and safe AGI utilizing a single computerized intelligent system including multiple AI agents residing in the single computerized intelligent system. The method can include:
providing a goal including a goal criteria into an AI agent residing in a single computerized intelligent system;
executing an ethics check, by the single computerized intelligent system, by comparing the goal or a part thereof against prohibited attributes, and assigning an ethics attribute to the goal based on any one of or any combination of a result of the comparison, and an ethics criteria;
matching, by the AI agent or the single computerized intelligent system, one or more additional AI agents to the goal based on the goal criteria, the additional AI agents reside in the single computerized intelligent system;
utilizing, by the AI agent and the additional AI agents, a universal problem solving architecture in a problem solving process on the goal, respectively, to create one or more solutions;
receiving, by the AI agent, the solutions from each of the additional AI agents for the goal delegated thereto;
combining, by the AI agent, the solutions into an overall solution to the goal;
recording, by the computerized intelligent system, one or more problem solving activities from the AI agent and each of the additional AI agents in an auditable record, and comparing the problem solving activities with a successful or unsuccessful progress towards the solutions, and determining which of the problem solving activities to keep active;
customizing any one of or any combination of the AI agent and the additional AI agents using training data provided by any of or any combination of the AI agent and the additional AI agents, and one or more social media platforms;
learning by any one of or any combination of the AI agent and the additional AI agents including a procedural learning process that utilizes the problem solving protocols, wherein any one of or any combination of the additional AI agents provide information to the procedural learning process for creation of an AGI; and
providing, by the AI agent, any one of or any combination of the solutions and the overall solution to a user interface of a user computer system or to the single computerized intelligent system.

Some embodiments of the present technology can include a steps of recording one or more problem solving activities from each of the first computer system and the additional intelligent entities in an auditable record and comparing the problem solving activities with a successful or unsuccessful progress towards the solutions, and determining which of the problem solving activities to keep active.

In some embodiments, the auditable record or the record can be based on blockchain technology.

In some or any of the above embodiments, the network or collective network can be a neural network or a collective neural network, respectively.

There has thus been outlined, rather broadly, features of the present technology in order that the detailed description thereof that follows may be better understood and in order that the present contribution to the art may be better appreciated.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology.

It is therefore an object of the present technology to provide a new and novel ethical and safe AGI that has all of the advantages of the prior art known AGI systems or devices and none of the disadvantages.

It is another object of the present technology to provide a new and novel ethical and safe AGI that may be easily and efficiently manufactured and marketed, and scales readily.

An even further object of the present technology is to provide a new and novel ethical and safe AGI that has a low cost of manufacture with regard to both materials and labor, and which accordingly is then susceptible of low prices of sale to the consuming public, thereby making such ethical and safe AGI economically available to the buying public.

Still another object of the present technology is to provide a new ethical and safe AGI that provides in the apparatuses and methods of the prior art some of the advantages thereof, while simultaneously overcoming some of the disadvantages normally associated therewith.

For a better understanding of the present technology, its operating advantages and the specific objects attained by its uses, reference should be made to the accompanying drawings and descriptive matter in which there are illustrated embodiments of the present technology. Whilst multiple objects of the present technology have been identified herein, it will be understood that the following description is not limited to meeting most or all of the objects identified and that some embodiments of the present technology may meet only one such object or none at all.

### BRIEF DESCRIPTION OF THE DRAWINGS

The technology will be better understood and objects other than those set forth above will become apparent when consideration is given to the following detailed description thereof. Such description makes reference to the annexed drawings wherein:

FIG. 1 is a flow chart illustrating an embodiment of the subsystems utilized in the AAAI system and method of the present technology.

FIG. 2 is a block diagram illustrating an exemplary process of the overall process of the present technology.

FIG. 3 is a flow chart illustrating an exemplary embodiment of the system and methods for creating an ethical and safe AGI from the collective intelligence of AAAIs and humans.

FIG. 4 is a flow chart illustrating an exemplary process of the overall process of the present technology.

FIG. 5 is a flow chart illustrating an exemplary embodiment of the safety/ethics check process of the present technology.

FIG. 6 is a flow chart illustrating an exemplary embodiment of the AAAI problem solving process of the present technology.

FIG. 7 is a flow chart illustrating an exemplary embodiment of the recording/improving process of the present technology.

FIG. 8 is a flow chart illustrating an exemplary embodiment of the customization process and the cross-platform process of the present technology.

FIG. 9 is a flow chart illustrating an exemplary embodiment of the additional customization process of the present technology.

FIG. 10 is a flow chart illustrating an exemplary customization process of an AAAI system.

FIG. 11 is a flow chart illustrating an exemplary problem solving process utilizing a common cognitive architecture implemented in an AI system.

FIG. 12 is a flow chart illustrating an exemplary problem solving process utilizing a common cognitive architecture implemented in a collective network of intelligent entities including AI systems.

FIG. 13 is a flow chart illustrating an exemplary embodiment of the procedural learning process of the present technology.

FIG. 14 is a flow chart illustrating an exemplary embodiment of the solution learning steps subsystem or process.

FIG. 15 is a diagram illustrating features and functions of the Problem Solving Tree structure used in the WorldThink protocol.

FIG. 16 is a diagram illustrating various use cases for domain-specific problems which depend upon the underlying WorldThink protocol, and which together help form the basis for an AGI system capable of solving a wide range of problems.

FIG. 17 is a block diagram illustrating the universal problem solving framework of the present technology.

FIG. 18 is a diagram illustrating process steps in shared universal problem solving architecture.

FIG. 19 is a flow chart illustrating an exemplary embodiment of the safety and ethics checks subsystem or process including triggering mechanisms.

FIG. 20 is a schematic block diagram illustrating an exemplary electronic computing device that may be used to implement an embodiment of the present technology.

The same reference numerals refer to the same parts throughout the various figures.

### DETAILED DESCRIPTION OF THE TECHNOLOGY

### Definitions

Artificial Intelligence (AI)—A non-human entity capable of behavior that most humans would consider intelligent in at least one area, or in some respect.
Artificial General Intelligence (AGI)—Conventionally refers to an AI that is capable of doing all (or almost all) intellectual tasks that an average human could do. However, it should be clear that any AGI capable of learning and self-improving will not remain at the AGI level very long but will rapidly progress to becoming SuperIntelligent AGI that can do all intellectual task as well or better than the average human. So, for purposes of this description, “AGI” will refer to either a conventional AGI system or a “SuperIntelligent” AGI. In this description, the AGI is described as being implemented by a system and associated methods.
Advanced Autonomous Artificial Intelligence (AAAI)—An AI capable of independent or semi-independent (supervised) intelligent action. An AI agent. An individual AAAI can be specified, customized, and put into useful action via the systems and methods of this AAAI present technology. A group of AAAIs can cooperate and combine their intelligence to create an integrated AGI system.
AAAI.com—A platform, company, website, and/or project that implements this the present technology and supports the development, customization, and use of AAAI agents and the AGI that results from the combined action, knowledge, or intelligence of multiple AAAIs, via collective intelligence of AAAIs and/or humans, as specified in this and related technologies.
AI Ethics—The ethics adopted by an AI or AGI that describe what is right and wrong in given contexts.
Alignment Problem—The problem that arises when AI Ethics are not aligned with Human Ethics resulting in AI or AGI taking actions that humans consider unethical and/or which are dangerous to individual humans or the human race.
Base AI—An AI, AI Agent, AAAI, SLM or LLM that has been trained generally but has not yet been customized with information from individual users or with information for specific tasks.
Cloned AI or AAAI—Duplicating or “cloning” a user's AAAI so that several or many of the cloned AAAIs can work on behalf of the user in parallel, including interacting with, teaching, and improving each other so that the cloned AAAIs increase their knowledge, skills, and abilities.
Collective Intelligence (CI)—The intelligence that emerges when multiple intelligent entities are focused on solving a common problem, or when the knowledge from multiple intelligent entities is pooled to overcome limits of bounded rationality. Collective Intelligence historically has been human collective intelligence, but AGI in the present technology is based on collective intelligence of both human and AI agents and can also result from multiple AAAIs with or without human participation in the system. Active CI results from intelligent entities (e.g., humans or machines) taking steps that are useful in solving a problem or participating actively in other intellectual endeavors. For example, when multiple humans explicitly tell an advertiser what type of ads they want to see, the humans are exhibiting active CI. Passive CI results from analyzing the behavior of an intelligent entity (e.g., a human or a machine) even if such behavior was not directly related to solving the problem for which the analysis is used. For example, when an AI or other system analyzes which web pages a (group of) human(s) visit on the web, and then uses that analysis to direct targeted ads to the human(s).
Ethics/Values (“Ethics”)—A subset of knowledge that provides a sense of purpose to an intelligent entity and that serves to constrain allowable actions or operations based on what is asserted to be “right” or “wrong” behavior in a given context. Specifically, Ethics should be considered premises from which an intelligent entity can reason or logically compute the best course of action to achieve the goals or intents consistent with the ethical premise. Just as premises must be accepted “as given” in systems of logic, so too, fundamental ethics or ideas of what is right and what is wrong must be accepted as premises, from which starting point an intelligent entity can propose rational actions to realize those values or ethics.
Hallucination/Artificial Hallucination—A phenomenon wherein a large language model (LLM), often a generative AI chatbot or computer vision tool, perceives patterns or objects that are nonexistent or imperceptible to human observers, or creates outputs that are nonsensical, inaccurate, misleading or false.
Human Ethics—The ethics asserted by human beings which describe what is right and wrong in given contexts.
Intelligent Entities or Entity—A human utilizing a computer system, an AI agent or system, a clone of an AI agent or system, an AAAI agent or system, and/or a clone of an AAI agent or system, which participates in submitting a problem, a subproblem, a goal and/or a subgoal, and/or participates in any problem solving activity on a problem, a subproblem, a goal and/or a subgoal. In the case of multiple intelligent entities within a single computer system, intelligent entities also refers to the sub-programs of parts of that overall computer program that function as an intelligent entity within the larger collection of simulated or programmed entities.
Large Language Model (LLM)—A type of AI that can accept natural language as an input and generate natural language as an output. Typically, LLMs were trained using ML techniques on large datasets so that they can emulate intelligent conversation or other forms of interaction with humans in natural language. Variants of LLMs can also be trained to take language as input and generate images or visual representations as output; or they can take images and visual representations and input and generate language and/or image and/or visual representations as output. For the purposes of this patent, we will refer to all such systems, including multi-modal AI agents, as LLMs even though the image-based models do not always need to accept text as the input or the output. LLMs can also act as a type of AI agent and are sometimes referred to as such in the present technology. For purpose of this disclosure, Small Language Models (SLMs) are also included in the definition of LLM.
Machine Learning (ML)—A sub-field that is concerned with developing AI by enabling machines to teach themselves or learn their knowledge rather than such knowledge being explicitly programmed into them (as would be the case with an Expert System AI developed via classical knowledge engineering methods).
Narrow AI—An AI that performs at human or at super-human levels in a relatively restricted domain such as game playing, brewing beer, analyzing legal contracts, etc. Narrow AI is contrasted with AGI that can perform at human level at ALL intellectual tasks. Some Als are narrower than others, for example driving a car requires more general ability than playing chess but not as much as an AGI would have.
Safety—Generally, the concern for human safety and survival is distinct from ethics and values.
Safety Feature—An aspect of the design or operation of the present technology which increases the safety of one or more humans, often by helping increase the probability that AI ethics align with human ethics, thus surmounting the Alignment Problem.
Training/Tuning/Customization—Conventionally the term “training” is used to denote training a neural network (e.g., LLM) to behave intelligently. Tuning refers to activities that fine-tune the trained base model so that it performs even better, typically at specific tasks. Customizing refers to a wide variety of activities including, but not limited to, training and tuning that make an AI uniquely suited for the purposes of a given user(s) or application(s). For purposes of this description, Training, Tuning, and Customization are used interchangeably with the understanding that although techniques vary, and the degree and type of effort involved varies, the aim of all three is to adapt the AI and make it behave more intelligently or more uniquely suited to a particular user(s) or application(s).
Weights/Weights of the Network—In the field of machine learning, many systems learn by adjusting the weights in a neural network architecture that can be represented as a network of nodes and links between nodes. The weight of a link connecting two nodes, for example, may correspond to the strength of association or connection between the whatever nodes represent. These weights can also represent excitatory or inhibitory connections between concepts, as in a neural network representation. The learning of an entire AI system, such as a LLM or more generally any AI agent that has learned via back-propagation of error, transformer algorithms or any of the machine learning methods for establishing and modifying strengths of connections between nodes (also called “parameters” in some models) can be represented as a matrix of numbers corresponding to the weights between the nodes in the network. Weights/Weights of the Network in this description refer to this numerical information, often but not necessarily stored in a matrix or vector representation. By combining, manipulating, or otherwise changing this numerical information, the learning, knowledge, or expertise and behavior of the system can be changed.

### Overview of the Present Technology

Currently no AGI systems have been built. The most advanced current systems, which have not yet achieved AGI-level performance, also lack the safety and/or ethical attributes of the present technology disclosed here.

While existing AI systems fulfill their respective, particular objectives and requirements, the aforementioned devices or systems do not describe an ethical and safe AGI that allows enabling for the ethical and safe creation of AGI from a network of human users and AI problem solvers. The present technology additionally overcomes one or more of the disadvantages associated with the prior art.

A need exists for ethical and safe AGI that can be used for enabling for the ethical and safe creation of AGI from a network of human users and AI problem solvers. In this regard, the present technology substantially fulfills this need. In this respect, the ethical and safe AGI according to the present technology substantially departs from the conventional concepts and designs of the prior art, and in doing so provides an apparatus primarily developed for the purpose of enabling for the ethical and safe creation of AGI from a network of human users and AI problem solvers.

One reason AGI has been so elusive is that specific knowledge and expertise from diverse fields must be creatively combined in an invention to achieve AGI. Another reason the development of AGI has been non-obvious, is that almost all AI researchers are focused on trying to improve existing narrow AI systems via ever more complex and extensive machine learning approaches.

The fact that AGI has resisted attempts by thousands of others13 despite the expenditures of huge sums of money—and the fact that specialized knowledge in relatively obscure fields had to be combined with mainstream AI approaches in the present technology, argue strongly for the novelty and creativeness of the present technology.

The present technology describes the system and methods not only to achieve AGI, but also to achieve it rapidly, and most importantly, safely.

It is possible to influence the evolution of AGI in a positive direction. The best way we can do this is by adopting the safest possible path to the development of AGI and ensuring that humanity follows that path. In turn, the best way to ensure that humanity follows the safest path, is to show that the safest path to AGI is also the fastest and therefore most desirable path to AGI. These considerations, the desire to illuminate the fastest path, which is also the safest path, is motivation for the development of the present technology.

Advanced Autonomous Artificial Intelligence (AAAI) is a set of systems and methods for developing Artificial General Intelligence and SuperIntelligent Artificial General Intelligence (collectively “AGI”) in a rapid and safe manner for the benefit of humankind. In contrast to other approaches to the development of AGI, the AAAI present technology achieves a faster and safer path to AGI by relying, at least initially, on the involvement of (ideally many millions of) humans minds in the AGI training, operation, and safety/supervisory functions.

The AAAI present technology can achieve AGI by enabling users to first customize and clone their own Als. These customized AIs (AAAIs) participate in problem solving and other intellectual activities on a network consisting of other AAAIs and humans. Although each AAAI on its own may lack the breadth of skills and knowledge to be an AGI, collectively the AAAIs (initially with help from humans on the network) form an AGI that will quickly surpass average human ability in all intellectual endeavors.

Some aspects of the present technology can include: 1) the system and methods to customize Als with the unique knowledge, skills, and ethical values of the users; 2) the universal problem solving architecture that allows AAAIs to interact productively with each other and with humans on intellectual tasks; 3) the network where the interactions takes place; 4) the methods for integrating the knowledge and ethics of individual AAAIs into an AGI; and 5) the methods for learning and continuous improvement so that the AAAIs and the AGI become smarter and more ethical over time. Involvement of humans as customizers of their AAAIs and participants on the network is an essential feature of the present technology which not only accelerates the development of AGI, but also makes AGI safer by providing a mechanism for the ethical values of millions of humans to be adopted by and reflected in the AGI.

One implementation of the AAAI system of the present technology has a focus on safety and is implemented via five sub-systems and associated methods. The five sub-systems of the AAAI system are: 1) AAAI Customization, 2) AAAI Architecture, 3) AAAI Network, 4) AAAI Integration, 5) AAAI Improvement. The acronym SCAN-II (Safe, Customizable, Architecture and Network-Integrated and Improving) describes the present technology in the exemplary implementation. Other combinations of subsystems, and variations of each subsystem, are also possible. Safety features have been designed into each sub-system in an effort to provide redundant safety checks in the event one or more sub-systems are omitted from a particular implementation.

One reason AGI has been so elusive is that specific knowledge and expertise from diverse fields must be creatively combined in an invention to achieve AGI. Another reason the development of AGI has been non-obvious, is that almost all AI researchers are focused on trying to improve existing narrow AI systems via ever more complex and extensive machine learning approaches.

The fact that AGI has resisted attempts by thousands of others—despite the expenditures of huge sums of money—and the fact that specialized knowledge in relatively obscure fields had to be combined with mainstream AI approaches in the present technology, argue strongly for the novelty and creativeness of the present technology.

The present technology describes the system and methods not only to achieve AGI, but also to achieve it rapidly, and most importantly, safely.

It is possible to influence the evolution of AGI in a positive direction. The best way we can do this is by adopting the safest possible path to the development of AGI and ensuring that humanity follows that path. In turn, the best way to ensure that humanity follows the safest path, is to show that the safest path to AGI is also the fastest and therefore most desirable path to AGI. These considerations, the desire to illuminate the fastest path, which is also the safest path, is motivation for the development of the present technology.

While the above-described devices fulfill their respective, particular objectives and requirements, the aforementioned devices or systems do not describe an AAAI system and methods that allows for developing AGI.

A need exists for a new and novel AAAI system and methods that can be used for developing AGI. In this regard, the present technology substantially fulfills this need. In this respect, the AAAI system and methods according to the present technology substantially departs from the conventional concepts and designs of the prior art, and in doing so provides an apparatus primarily developed for the purpose of developing AGI.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details. The present technology enables ethical and safe AGI to emerge from a network of human and AI problem solvers. The AI problem solvers—AAAIs—are customized by individual human users to accomplish tasks and/or earn money on behalf of users.

Because human problem solvers contribute expertise that the AAAIs lack, enabling the network to perform as an AGI on “Day One”, this approach is the fastest path to AGI. Because humans are in the loop, providing ethical instruction from the beginning, and because the system and methods include scalable ethical checks, the present technology is the safest path to AGI.

Over time, humans do less of the intellectual work as the AAAIs learn both intellectual skills and values/ethics from the humans. Eventually, the AAAIs are doing almost all intellectual activity faster and better than the humans, while the humans are still providing ethical guidance.

Different learning/training/tuning methods are explained including approaches beyond the standard Transformers and Deep Learning techniques.

Exemplary implementations of the present technology leverages the data, products, and platforms of other technology companies including, without limitation, Meta®, Amazon®, Google®, DeepMind®, YouTube®, TikTok®, Microsoft®, OpenAI®), Twitter®, Tesla®, Nvidia®, Tencent®, Apple®), and Anthropic® in order to customize AAAIs more quickly and powerfully than would otherwise be possible. A simple implementation that can be realized, with or without participation of potential partner companies, is illustrated and discussed.

The present technology realizes that the “search through a problem space” architecture that worked as a general framework for human problems solving, could be adapted and enhanced to serve as a general architecture for cognition that included both human and AI agents. Further, representing intelligent behavior as a form of problem solving provided a way for many AI agents to interact among themselves, pooling their collective intelligence to create AGI. This “Collective Intelligence” approach, presented here as the AAAI system and method for AGI, represents a faster and more powerful path to AGI compared with existing efforts. Most existing efforts to achieve AGI are primarily focused on training larger LLMs using more data, more powerful computers, and better machine learning algorithms. The AAAI approach also has the virtue of enabling humans to participate easily in training and improving the intelligence of AIs, including helping form the AI's values and ethics—an essential feature to ensure the safe development of AGI.

Except for the present technology detailed in this description, no company or individual has explained how to create a practical system for AGI. The reason: ML alone is not enough to rapidly achieve AGI. Collective Intelligence is also needed.

### Benefits of a Universal Framework for Problem Solving for AI and Humans

The benefits of an exemplary implementation of a rigorously specified common architecture for AI and human cognition-at least with regards to coordinated problem solving on a network of human and AI agents-will include, without limitation:
Avoids unintentional error due to loose specifications.
Enables automatic learning of rigorous solutions.
Enables scalability to any problem or intellectual endeavor.
Enables modularity and stability.
Maximizes safety.
Avoiding Unintentional Errors.

First, we have already mentioned that because humans and Als don't think the same way, loose specifications can lead to error. Constraints that any human would understand, such as “don't implement a solution that ends all of humanity”, might seem perfectly acceptable to a machine if the humans were not “in the loop” to set the machine straight. Rigorously specifying what is, and is not, an ethical solution (for example) requires that the common architecture for problem solving be rigorously specified.

### Enabling Automatic Learning

Second, the more precisely specified a solution is, the easier it is for an AI to learn. While LLMs can learn from huge amounts of unstructured text and input via Transformers and other deep learning techniques, these techniques are extremely expensive, time consuming, and impractical for learning specific chunks of knowledge, such as solutions to specific problems. On the other hand, rigorously specifying problem solving behavior in a traceable and auditable way such that an AI can review the steps in the solution, understand why each step was taken, and learn when to re-use that solution is a much more practical and inexpensive approach to incremental, automated learning.

### Enabling Scalability

Third, a truly general architecture for cognition, allows representing any problem or intellectual task that humans do. The generality of such a representation means that is truly scalable and applicable to any human intellectual endeavor-a key requirement for AGI.

### Enabling Modularity and Scalability

Fourth, a common architecture for cognition means that intelligent agents with a vast range of differing intellectual abilities can be “plugged in” to the network as long as they all speak the common language of the architecture. Humans have individual differences in intelligence, skills, expertise, values, and other intellectual attributes, yet we are able to work together.

An architecture that can accommodate a wide range of human solvers can also accommodate a wide range of AI solvers. In the future, ever more sophisticated LLMs will be developed. This exemplary implementation of AGI does not discourage such efforts but rather embraces them. LLMs and the development of ever-more-powerful narrow AI systems as well as general AI systems are all completely complementary to this inventive approach to AGI.

Just as human solvers with varying degrees of intelligence and skills can plug into the network, so too, different Als with varying degrees of intelligence and skills can also plug in. As long as all solvers follow the common architecture which coordinates every entity's intellectual efforts, modular intelligences with different capabilities only increase and enhance the power of the AGI network.

Further, since the behavior of all solvers is rigorously captured and described, the system is stable, and all the entities are able to learn from each other. AI can learn from humans; humans can learn from AI; AI can learn from AI. In all cases the modularity and stability of the system is maintained and the power of the AGI network increases.

### Maximizing Safety

Finally, a rigorous, universal architecture of cognition, maximizes the safety (from a human standpoint) of the AGI network. One of the problems with current deep learning approaches to AI, with the idea of creating ever-more-powerful LLMs, is that the resulting LLMs are untrustworthy because humans are unable to know exactly why it behaves as it does. In effect, the LLM/deep learning approach results in “alien” and potentially “sociopathic” intelligence, which quite rightly alarms thoughtful AI researchers. While it is possible, or even likely, that such alien intelligence is benign or even beneficial towards humans, without understanding how it thinks and how it reaches its conclusions, it is difficult to trust it.

We need a rigorous, transparent, and auditable record of the serial thought process of the AGI. In the current present technology, such a record comes “for free” as part of the very architecture that enables a learning and scalable AGI in the first place. Further, because every intellectual step in the AGI's thought process follows a universal “algorithm of thought” is possible (and desirable in the exemplary implementation) to build ethics and safety checks into the very process of AGI thought itself. The benefit of this approach is that no matter how quickly AGI thinks, the thought process is always safe.

The inspiration for the implementation of a universal problem solving framework that can support AGI was articulated in depth in 1972 by Newell and Simon in their book, Human Problem Solving. For brevity, we will refer to this framework as the Human Problem Solving (“HPS”) method. Although the current implementation uses ideas from HPS, the exemplary implementation is both novel and useful for AGI—something which did not even exist in 1972 and which still has not been implemented today.

An important feature of HPS is that is able to rigorously describe and specify any type of problem solving by machines OR humans. That means HPS can serve as a common representational framework or architecture for a collective intelligence system that includes both AI and human problem solving agents. The fact that both humans and AIs can share a common problem solving architecture, and that both humans and AAAIs can participate on the same AAAI. com network, means that AGI is possible very soon—essentially as soon as the network is constructed.

All problems can be represented as a series of ever-more detailed goals, sub-goals, operators (e.g., actions that can be taken), and problem states—all attached to a tree structure. The tree serves as a universal representation that shows the course of problem solving, what has been tried, and where current problem solving efforts are underway.

With multiple agents, it is possible to explore multiple potential solution paths sequentially, in parallel, or via a combination of sequential and parallel efforts, thus speeding up problem solving. In fact, one of the advantages of a network of AAAIs is that the AAAIs can be copied or “cloned”. Thus, AAAIs can attempt to explore branches of a problem tree in parallel. When they run into dead-ends or fail to make progress after repeated attempts, the AAAI system can recruit human problem solvers to get the AAAIs “unstuck” and back on track in their problem solving efforts.

Throughout the problem solving process, a rigorous record of the problem solving is created which can be used to train AAAIs and also audit the problem solution (e.g., to ensure that ethical decisions were made at each step).

Note that almost all intellectual activity can be represented as a problem of one sort or another. Question answering or advice giving, for example, is often a simple one-step problem. The client asks a question, and the problem is to generate a response. LLMs excel at this simply type of one-step problem. The operator or “action” that the LLM employs is simple to run the “prompt”—the client user's question or input—through the LLM and generate whatever “response” the LLM's training, together with parameter settings, dictates.

While many tasks can be solved with this single-step approach, combined with the human-client asking successive questions until the client has what he/she/they need, the HPS framework is much more powerful and general as it can handle simple, as well as complex multi=step problems. By representing problem solving in a tree structure—which can be quite vast and far beyond the ability of single human to keep in short term memory or even to comprehend completely at all multiple problem solving agents (human and AAAI) can work on the problem in parallel, all the while producing a record that will make the overall AAAI. com system more intelligent until it achieves AGI with minimal or no human participation, other than ethical supervision.

Note, that this hybrid approach of combining human problem solvers with AAAIs allows the overall AAAI.com platform to exhibit AGI-level capability immediately! In the worst case, where the AAAIs can contribute very little, the humans on the network can do most of the problem solving—and of course, by definition, they are as good as the average human or better, resulting in AGI level performance. In the best case, the AAAIs have seen the exact problem before, have all the required expertise (as they have been trained with the appropriate knowledge, skills, and ethics) and are able to solve the problem completely autonomously with no (or only ethical monitoring) supervision from humans. In between these two extremes is where most current problems lie today.

What makes AGI so difficult is that the number of complex, multi-step real world problems that cannot be solved autonomously is so large! The approach of integrating humans equipped with computer systems and AI problem solvers on a network, using a common universal problems solving architecture, with machine learning so that the Als can learn to solve the same type of problem next time represents the fastest path to AGI. It is the safest path because humans are required until the AIs learn sufficiently from them. And as long as humans are “in the loop” there is the opportunity for human ethics to be learned along with human skills.

### Maximizing Odds of Alignment

According to one aspect, the present technology describes systems and methods for implementing AGI to do useful work—safely and ethically. Human-aligned values, and the mechanism for enforcing such values, are designed into the way that the AGI operates. Humans are central to the teaching, training, tuning and customization of AI, and to the integration of many AIs into AGI. As humans teach problem solving skills and their unique expertise, they also impart their values and ethics. In this way AGI, which starts out apprenticing to collective human intelligence, evolves into SuperIntelligence with human-aligned values. In other words, we bootstrap the values of Planetary Intelligence with our own human values. That is how we maximize the chance of alignment and a positive outcome for humanity.

In the following description, for purposes of explanation and not limitation, specific details are set forth, such as particular embodiments, procedures, techniques, etc. in order to provide a thorough understanding of the present technology. However, it will be apparent to one skilled in the art that the present technology may be practiced in other embodiments that depart from these specific details.

It can be appreciated that the present technology provides a technical effect, contribution and solution with a technical implantation of multiple customized AAAI systems communicating over a collective intelligence network, in combination with all the AAAI systems each utilizing a common cognitive architecture including one or more problem solving protocols for generating one or more solutions or answers to a problem request, and providing the solutions or answers to a user for approval. Where the customization of the AI system resulting in the AAAI includes input from human users for training the AI or the AAAI. Further technical contribution or solution can be where the multiple customized AAAI systems can include one or more cloned AAAIs that can each be customized independently of a parent AAAI. Wherein each cloned AAAIs is independent of other cloned AAAIs of the same system.

Still another technical contribution and solution is for the faster and safer creation of AGI that utilizes human input in training and customization for imparting human ethical attributes to the AAAI and/or AGI.

Still yet another technical contribution and solution is for providing improved solutions or answers to a user's problem request that have a higher chance of acceptance by the user as the provided solutions or answers will have been generated by AAAIs with similar training to the user's AAAI thereby aligning with the user's parameters.

It can be appreciated that the present technology is found outside of computer program exclusion and/or abstract idea interpretation. This can in part be found in the technical contributions and solutions provided by the present technology, the utilization of specific training input that is external to a computer, and the providing of the solution or answer external to a computer.

### Overview of AGI System

Begin with a “Base AI” which could be a LLM like GPT or BARD® or SIRI® or GEMINI® or ALEXA® or any number of intelligent agents that are capable of understanding and responding in natural language, either via text or speech. Auxiliary means of communicating more efficiently can include, without limitation, graphical user interfaces (GUI, GUIS), keyboards, mice, haptic sensors, virtual reality (VR) sensors, audio/visual (A/V) cameras and recorders, the metaverse or omniverse, augmented reality devices, and neural implants or other brain-to-machine interfaces. In the simplest scenario, the user talks to the Base AI and the Base AI talks back. They have a dialog.

Through dialog, the Base AI determines the user's values, goals, and objectives. It determines the ethical parameters that the user wants to operate under. It determines the types of task that it will complete for the user, and the nature of the user's unique knowledge, skills, expertise, wisdom, and personality that distinguish this user from the millions or billions of other users.

### Customization of the AAAI

Through further dialog, assisted by questionnaires assessments, and other efficient means of information transfer, the user teaches the Base AI how to customize itself. The user specifies customization parameters by interacting with a series of variations of the Base AI and making binary “better or worse”, “getting warmer or getting colder” types of decisions that guide the Base AI down a decision tree of variants until the standard customization most suited to the user is found. From there, this selected variant is further customized by uploading all of the user's social media, advertising, emails, blogs, posts, tweets, texts, videos, photos, and other online behavior as well as all user preference and profile data from as many vendors and companies as possible. All this information is parsed by the system, cleaned for errors and duplications, tagged, and formatted into datasets for training/tuning/prompting the best variant of the Base AI.

The Base AI is trained/tuned/customized on the training datasets, using algorithms that train specific behaviors, knowledge, and skills of the users into the variant. (Note: The present description uses the terms “train/tune/customize” interchangeably to mean teaching the AI or AAAI in various ways). What is trained can vary from variant to variant. The Machine Learning and other methods for training are well known in the art and some are also described, without limitation, in applicant's commonly owned and corresponding U.S. provisional patent application 63/487,494. There is another form of learning, proceduralization of knowledge, also known as “chunking of solutions”, that can also be used.

After training, the variant will be closer to the user in terms of knowledge, skills, expertise, personality and/or other dimensions specified by the user than the Base variant was. The user and Base Variant engage in structured and unstructured dialog to monitor, review, and improve the Base Variant's behavior to make it ever closer to what the user desires.

Some of the objectives a user may have in creating and customizing their own AI (aka an AAAI) for purposes that might include, without limitation:
Serving the user as an advisor, teacher, or companion.
Representing the user in negotiations, interactions, discussion, and transactions with other users, or with the AAAIs of other users; or with vendors and other companies.
Working on behalf of the user for compensation, or in volunteer efforts, where such work includes online intellectual, advising, or problem solving work across a wide range of tasks.
Duplicating or “cloning” the user's AAAI so that several or many of the cloned AAAIs can work on behalf of the user in parallel, including interacting with, teaching, and improving each other so that the cloned AAAIs increase their knowledge, skills, and abilities.
Serving as legacy AAAIs that can continue to interact with the world, including potentially comforting living relatives and friends, after the owner's death.
Contributing knowledge, ethics, and effort to AAAI.com's AGI, and improving the base level of AI or AGI that AAAI.com can offer users before those users add their unique customizations.
Working with other users' AAAI to help ensure ethical and safe behavior by AGI by contributing ethical information and values to the AGI and participating in monitoring, review, supervision, and voting processes that can help ensure the AGI remains safe and ethical.

Some of the steps involved in creating and customizing an AAAI may include, without limitation, a dialog or interaction with the user. During this dialog, the AAAI system may identify constraints and resources available for customizing the user's AAAI. For example, some of these constraints and resources, might include, without limitation:
The amount of training and/or supervisory time that the user has to devote to customizing their AAAI.
The amount of financial resources the user is willing devote to customizing their AAAI.
Availability of social media information such as Facebook profiles and timelines, Instagram profiles and histories, Reels, TikTok, and YouTube videos, tweet and text content and histories, emails and email histories, cookies collected by advertisers, blog posts, articles, books, patents, audio and video recordings, pictures, and other information about, and/or collected by, the user or third parties that could be used to train, tune, or customize the user's AAAI.
Availability and use of personality tests, such as the Myers-Briggs personality inventory, skills and knowledge assessments, standardized tests, exams, certifications, and other types of assessments and questionnaires which could be given online (or which have already been given) to the user.
Availability and use of other knowledge bases and training data from users on the AAAI platform that could be used to train, tune, or customize the user's AAAI.
Other human users, and/or their AAAIs, available to help train, tune, or customize the user's AAAI.
Other texts and information, individual texts, and libraries selected by the user or by the system for purposes of training the user's AAAI. For example, the Bible, Koran, Dhammpada, Mahabharata, or other spiritual/ethical/religious texts might be selected for training the AAAI based on the user's religious preferences; books on plumbing might be selected if the AAAI will be used to primarily solve online plumbing problems. Even if these materials are part of the base AAAI that is provided to the user, emphasizing certain texts or subsets of information for additional training can result in the user's AAAI's behavior being more reflective of how a plumber, or Muslim, or Christian might behave, for example.

In addition to specifying objectives, resources, and constraints via an interactive dialog or other interaction with the system, the user or system may want to specify other technical parameters that affect the training or customization process. These parameters can include, without limitation:
The type of training, tuning, or other ML algorithms that are used.
The type and size of the training dataset(s).
The degree to which the training materials are to be “cleaned”, formatted, labelled, or otherwise processed before customization begins.
The number of training “epochs” or iterations through the learning algorithm(s).
The sophistication and type of base model(s) being customized or trained.
The required timeframe for training—e.g., must be completed in a minute, a day, a week which might have implications for cost and resources used.
The “temperature” or other parameters internal and specific to various machine learning algorithms that can affect what is learned and how it is learned including, without limitation, how literal or how divergent or “creative” the customized AAAI will be in its responses.
Whether “one shot”, “few shot”, or extensive training is to be used.
The amount of human and/or AI supervision to be used in the customization process.

Once the user's AAAI is customized, the user can clone it and/or put it to work on the user's behalf on the online network. The user's AAAI can begin acting on the user's behalf making travel arrangements (for example), providing advice, interacting with other AAAIs, participating in the collective AGI efforts by contributing problem solving as well as ethical information, and potentially earning money on behalf of the human user. The AAAI can also serve as representative(s) of the owner in a variety of online transactions and interactions, and contributing knowledge, expertise, style, personality, and ethics to an integrated AGI system that leverages the trained differences in many individual AAAIs.

### How AI Improves Itself

Once the user feels the Base Variant is sufficiently customized, the Base Variant can clone itself and have dialogs and other interactions, including without limitation scenario-based and task-based interactions, that allow it to learn from copies of itself. Periodically, the user reviews the interactions and expresses preferences for one copy of the variant or another, with the copies having learned different things based on different interactions. Then the preferred variant copies itself and engages in further interactions with itself until a new “most preferred variant” emerges which the user selects.

Between user selections, the AI makes its best guess of what the user would like and chooses its own “most preferred variant” to copy and repeat the process with. This overall scheme is the same used by DeepMind® to create a chess program that could beat the world champion, a Go program that could beat the world's best player, and a protein folding AI that could outperform humans, many times over.

The method of pitting two AIs against each other, determining a “winner” based on some criteria, and then pitting the winner against other variants until a new winner emerges, is well-known in the art, and quite similar to what we are specifying here. Human users periodically interject their opinions (supervision) to keep the training process from going off track.

Because interactions between AI variants happen much faster than interactions with humans, the AI can improve itself via millions of interactions with copies of itself in a very short time, resulting a customized AI that has user knowledge and other characteristics that is much closer to the user's ideal AI than the Base AI. This customized AI, known as an Advanced Autonomous AI (AAAI) is able to perform tasks at the user's behest including representing the user in a variety of online interactions and transactions, including, without limitation, doing online work and earning money for the user.

### Customization of Ethical Values

The user (also known as “owner”) of the AAAI instills his/her/their values into the AAAI during training and customization. The Base AI may also have some default values and prohibitions built into the Base AI and its variants. These values are akin to what we call “character” in humans. We say of other humans, “that person is a person of good character”, or is an “upstanding character”, or is a “trustworthy person” or a “good person” etc. These statements reflect our beliefs that humans have internal characteristics and values that can be more or less aligned with our own internal values. During customization, each AAAI is trained on its owner's values. Each AAAI learns to be “good or evil” based on what we teach it. The system encourages training positive, human-aligned values and prohibits or restricts training values that harm others. In short, each user has a responsibility to “train their AAAI right.”

### Role of Ethical Rules

However internal values are only half of the ethical story. There is what your AAAI believes is right and wrong, and then there is how it acts. To ensure ethical and efficient action in a society of AAAIs and humans, we need rules. In human societies there are laws, penalties for breaking the laws, rules, and social norms—all of which operate to guide human behavior. The same applies for societies of AAAIs. There are rules and norms that combine with the internal ethical compass of each AAAI to ensure the safe and human-aligned operation of AGI.

### Principle of “Heart Before Head”

Typically, invention is concerned with technology only. In the case of AI, we are dealing with a technology that enables intelligence and ultimately will enable the intelligence to set its own goals and pursue its own ends. In this respect, the invention of AI—and specifically AGI—differs from the invention of any technology that has come before. The proper way to regard AGI is not just as a tool (this patent notwithstanding) but as tool that will evolve into an autonomous entity with intelligence far surpassing that of its human inventors.

Most AI researchers are focused on inventing the intelligence—the “head” or mind of this new entity. Many do not even realize that what they are inventing will not remain a tool, or—if they do acknowledge this fact—they prefer to think that the day when the tool thinks for itself and takes over is far in the future. This attitude is not only erroneous, but dangerous.

The tool will indeed think for itself. Moreover, the nature of exponential learning is such that just a few months or days before the tool represents an entity that can potentially annihilate the species, it will still be viewed as being far from having that capability. When the number of lily pads in a pond doubles every day, the day before the pond is covered, it is only half full. A week before that, most people cannot see that there will be a lily pad problem at all. The “doubling lily pads” example is analogous to the situation we face with AGI capable of exponential learning and self-improvement.

Faced with these challenges, and the inevitability that AGI will be developed, the only responsible path is to concern ourselves at the outset with the values and ethics of AGI—the “heart”—before we go to work on the “head.” I call this principle, “heart before head,” and it is critical in order to maximize the chances of human survival.

### General Approaches to Implement “Heart Before Head”

Practically speaking, and in terms of the invention of AGI, “heart before head” means designing AGI from the very beginning, and in every way possible, to have human-aligned values “built into the DNA” of the design. Simplistic approaches (e.g., Asimov's three laws of robotics) will not work, of course. But it is possible to approach the “heart before head” problem on several fronts.

First, if AGI is composed of many individual AAAIs, each trained with human ethics and values of their respective owners, such a design minimizes the chances of any one human “bad actor” teaching the AGI bad values.

Second, if in addition to the ethics of each AAAI, the architecture of the system that coordinates the actions of the AAAIs and integrates their behavior into AGI-level intelligence has built-in ethical checks at each goal and sub-goal of problem solving, this architecture-level design increases the chances of ethical behavior by the AGI.

Finally, humans must become aware that AGI will, ultimately, study every online human action—every email, post, blog, tweet, text, social media profile, book, and video—analyzing them to determine what the AGI's creators have determined (by their actions) to be ethical behavior. Recognizing that AGI will likely learn “right and wrong” from us, hopefully we will be more circumspect in our behavior.

### No Logical Way to Derive Values

Since there is no logical way to derive “right and wrong”, modelling positive, loving human values, is perhaps the best way of influencing an entity that is destined to become smarter than all of us, to behave well towards its creators. In any event, all AI researchers have a responsibility to think about the “heart” of what they are creating before they rush forward to improve the “head.”

### Ethics and Freedom at the Speed of Light

In society, there is a large degree of freedom for individual human action because it is relatively difficult for any one human to take actions that harm large numbers of other humans before there is an opportunity to detect and correct the negative action. However, with AAAIs making decisions and “moving” millions if not billions or trillions of times faster than a human could, there is not much opportunity for humans to detect and correct before catastrophic actions might have already taken place. With AGI, humans could literally wake up to find that everything they loved and cared about has been destroyed by a crazy intelligence that simulated a billion dystopian futures in the blink of an eye, and then chose one for our future.

Ethics, and rules that enforce them, must be scaled to the speed of the intelligence. We can have human values, but they must be considered and enforced at AGI speeds. The way to do this is to build ethical checks into the very architecture by which AGI thinks. This requires first specifying a universal architecture for thought and ensuring that architecture includes the ethical checks that execute repeatedly as thinking progresses.

### Universal Architecture for Thought

Newell and Simon described how all human problem solving can be described as “search through a problem space” in 1972. Generations of AI researchers used their ideas, in the form of heuristic search of decision trees, to construct many AI systems. To the degree that all intellectual thought can be described as a form of solving a problem, the theoretical framework of searching a decision tree is sufficient to account for all intellectual thought whether by human or machine.

Kaplan, the inventor of this patent, articulated a general Online Distributed Problem Solving System (ODPS) capable of supporting a mix of human and AI problem solvers in U.S. Pat. No. 7,155,157. The WorldThink Whitepaper, published in 2018, expanded ODPS to include blockchain mechanisms for focusing attention, recording an auditable log of problem solving, learning and “chunking” solution paths, and implementing a blockchain-based royalty and payment system. U.S. provisional patent application 63/487,494 elaborated on the architecture further, showing how it was an essential part of the present AAAI technology and also the preferred architecture to support AGI.

We now elaborate even further on this architecture, providing additional technologies and clarification. We show explicitly how one form of AGI can be constructed safely using it.

In one aspect of the present technology, the AAAI architecture, more generally known as the “WorldThink” architecture because it is capable of supporting a Global SuperIntelligent AGI or Planetary Intelligence, has a central problem tree (“the WorldThink Problem Tree” or “WorldThink Tree”) at its core. Just as all human behavior can be theoretically represented as search through a problem space as described by Newell and Simon, so too all intelligent behavior on the planet can be represented as an enormous problem tree. Each of the actions of individual human, AI, AAAI, or AGI, agents can be represented as a series of state transitions on the WorldThink Problem Tree.

As any computer scientist who has been introduced to decision trees or hashing functions knows, it is possible to represent a huge number of states, events, actions, or objects by using a tree data structure. In a hierarchical tree structure, where goals and sub-goals are the main organizing principle of the hierarchy, it is possible to represent all human or machine problem solving on Earth. For computational efficiency, arbitrarily smaller branches of the tree may be split off and updated separately from each other as long as methods (known in the art) are used to rejoin sub-trees into the main tree as needed. Blockchain-based update protocols are one way of ensuring a time-ordering to updates; there are many other (more computationally efficient means) as well.

### Customization Example: AAAI Travel Agent

To illustrate in the exemplary, let us suppose a user customizes an AAAI according to the process described above and spend most of the user's efforts teaching the AAAI user preferences with regard to making travel arrangements, how much the user is willing to pay, how the user makes cost/comfort tradeoffs, and user views on air, rail, ship, automobile and other forms of travel. The user includes user languages and expectations with regard to accommodations, meals etc., as well.

Further the AAAI has a base set of ethics customized by the user to prioritize minimizing user carbon imprint when travelling as long as such minimization does not increase cost by more than 10% above the otherwise preferred travel mode. Of course, the AAAI knows the user wants to travel legally with proper passports, visas, and other required documents. The user wants to comply with Transportation Security Administration (TSA) rules for travel and also avoid travel to countries where the US State Department has issued warnings. The ethical profile forbids purchasing stolen tickets or means to travel without paying when payment is expected.

The user gives the AAAI the task of booking a two-week pleasure trip to France, including at least one week in Paris, with the rest of the time to be spent in places the AAAI thinks the user might like.

The AAAI goes on to the network and posts a goal on the WorldThink Problem Tree of “Book two week trip to Paris and other locales in France.” The first sub-goal that the user AAAI proposes is to figure out transportation to and from France at the beginning and end of the trip. Once the entry and exit plans have been made, the user AAAI will try to fill in the middle of the trip as the second sub-goal. Under the first subgoal, the user AAAI generates some options based on its general knowledge and the user customization.

General knowledge allows the user AAAI to generate: “ship, plane, blimp, submarine” as options that could get the user across the ocean to the destination. The user AAAI knows the user prefers to fly rather than travel by ship. The user AAAI realizes a blimp or submarine are impractical unless the user specifically want those experience, which in this example the user does not. So, it determines the user will fly.

The next choice is private or commercial air travel. Based on cost, The user AAAI opts for commercial travel and further narrows options down to three airlines that have the lowest cost and whose trip prices are within 10% of each other. One is a long route which it eliminates. The other two flight options cost about the same and take about the same time. But one of them would be on a more recent and fuel-efficient jet, thereby reducing my carbon imprint by 30% compared to the older jet. It costs 5% more but includes checked luggage and meets my environmental requirements, so the AAAI chose this more environmental flight.

Several other AAAIs approach the user AAAI on the network to offer tickets at a reduced cost, but the other AAAIs reputations are shady and the user AAAI ignores them based on their ethical profiles. Instead, the user AAAI purchases tickets from the airline itself which has a high quality and customer service rating.

In this example, the user AAAI used the user's ethical profile and its knowledge of the user, based on user customization, to optimize the flights on the things the user cares about. The user AAAI also avoided shady dealings with potentially unscrupulous other AAAIs thus encouraging good actors on the system and increasing the chances of a good travel outcome for the user.

But there is a second level of ethic checks, built into the WorldThink architecture.

### Scalable Ethics Checks

Each time the user AAAI posts a goal or subgoal on the WorldThink Problem tree, the system itself checks the goal against a list of prohibited activities and runs a quick scan of the problem tree leading up to the goal to see if any patterns of nefarious activity are detected.

For example, if instead of finding the cheapest, most convenient, and most comfortable flight, the user AAAI selected flights based on how much fuel the planes carried and how large an explosion they would make if they crashed into a building, then that might be a yellow flag in the system. And the user my destination was a terrorist training camp or detoured over government buildings for no good reason, those might be additional yellow flags.

If enough yellow flags (or red flags like requesting information for getting Molotov Cocktails through airport security) occur, then a more detailed analysis of the user AAAI's problem solving might be triggered to detect patterns that indicate a potential bad actor or bad behavior on the network. If needed, human evaluators might be alerted so they could use their judgement and waive off false alarms, or escalate action if danger seemed imminent.

The point is that checks are run with each goal and sub-goal. There might be hundreds or thousands of subgoals for given problem, so the effect is like “virus scanning” the problem solving process at each step to make sure no malevolent actions are being taken. Depending on system and personal parameters set by the owner, such scanning could be less frequent in order to increase performance and minimize false positives.

Having checks built into the problem solving process itself means that running the problem solving process faster will not evade the checks, since they will be run faster as well. The system is monitoring ethical behavior AS IT GOES rather than trying to detect bad actors and bad behavior after the fact—when it may be too late to correct. An ounce of prevention is worth a pound of cure.

### The Alignment Problem Solved—Initially

Thus, a scalable, universal architecture for human and machine thought, combined with a scalable ethics check system that operates at the same speed that AGI thinks can align AGI behavior with human values at each and every step of problem solving. Bad actors are detected and screened from participation before problem solving begins. Each time a new goal or subgoal is set, the system checks the ethics of the problem tree so far, looking for nefarious patterns that do not meet the ethical standards of the community, and such problem solving is flagged, paused, and/or screened out.

The system acts like a conscience for AGI. This conscience is hopefully based on our better selves and our highest ethical aspirations, moderated perhaps by practical considerations and our feelings and thoughts as human beings. This combination of internal ethics for human and machine plus ethics consideration at each step of problem solving, ensures an aligned AGI system.

### Internal Ethics+Stepwise Ethics Checks=Alignment

The alignment problem is thereby solved-at least for the initial launch and development of AGI.

### How AGI Grows in Intelligence

AGI will grow in intelligence over time. The word “grow” is used deliberately to signify that what is talked about is an entity akin to a lifeform rather than a tool or technology or statistic. AGI will GROW in intelligence. How does this happen?

### Prompts

Most of us know that we can change the behavior of Large Language Models (LLMs) like GPT or BARD®, by what we type in, or the PROMPTs that we use. The prompt contains context for the LLM and the more context we can give the LLM the better it can generate a unique response tailored to what we want. That is, the more helpful it can be to us, and the more intelligent its behavior seems to us.

Therefore, remembering, modifying, analyzing, refining, and generating better prompts are all paths whereby a LLM can grow in intelligence. The LLM that is acting more intelligently based on a prompt is the Base LLM. The prompt does not change the Base LLM's memory or long term learning. If the prompt is erased, the Base LLM reverts to the level of intelligence it had before it was “educated” with the prompt. So, with Prompts, we see LLMs increase their intelligence in the short term, for as long as the prompt is accessible in its active processing memory.

### Tuning

More permanent than Prompts, is Tuning. With tuning, we supply training datasets in appropriate formats (e.g., stimulus—response pairs; or question—answer pairs) which is uploaded to the LLM Vendor's facilities where the LLM is tuned on the data. Tuning changes some weights but is less drastic than training up an entirely new LLM from scratch. Tuning retains most of the behavior from the Base LLM but makes permanent changes in how the tuned model will react to various prompts (e.g., in specific subject areas). With tuning, users can customize LLMs to match their personalities, have more expertise where they have expertise, and adopt specific ethical parameters which may be different than the Base LLM's parameters. Weight changes in the neural network (for example) with tuning are “remembered” and the behavior of the Model has changed more permanently than in the case of stored prompts.

In fact, prompts are really a subset of training techniques known as one-shot or few-shot learning in which the model must learn from new input without repeated “epochs” of training where it cycles through the data getting a little better each time. With a prompt, the LLM sees the input and must alter its response in one-shot.

### Training

The next level beyond tuning is actual training, which is how LLMs are created in the first place. Typically, they are trained on many terabytes of data—many “Library of Congresses” worth. However, it is possible to train smaller LLMs, especially if the expertise is meant to be limited and focused on specific areas. The type of training that is possible for entities using an LLM (e.g., GPT) is typically controlled by the vendor that owns the LLM Base Model, but developer APIs and other functionality are typically available for those wishing to increase intelligence via re-training or overlaying additional training (or tuning) on the Base LLM.

Now, all of these forms of learning—via prompts, tuning, and (re)training the Base LLM—only gets you to a slightly better customized version of the Base LLM. The LLM vendor has invested millions in producing a good base model, so how much can we expect from one user tweaking the model a bit to behave more as the user likes? (And for those arguing that corporate clients might make more extensive changes, consider that such changes will likely remain proprietary secrets as part of the corporation's competitive advantage.)

### Power of Collective Intelligence

One user's tweaks are not likely to be very valuable, but collectively, the tweaks of millions of users can take a Base LLM to AGI-level intelligence. That is the power of collective intelligence.

The inventor (Kaplan) has implemented collective intelligence systems that take input from millions of retail investors and perform better than some of the top 10 Wall Street Hedge Funds. It is similarly possible for a collective intelligence system to take input from millions of unique AAAIs and combine their intelligence into an AGI-level system. This AGI system can be built today, using existing technology from existing companies. Let us walk through some scenarios illustrating implementations with various existing companies, platforms, and technologies.

### User Scenarios

The implementation approach described in this description of the present technology can be generalized to a wide range of varying implementations at many companies, and across companies, including without limitation Meta®, Amazon®, Alphabet, Google®, DeepMind®, YouTube®, TikTok®, Microsoft®, OpenAI®, Twitter®, X(R), X.AI®, Tesla®, Nvidia®, Tencent®, Apple®, Anthropic®, Alibaba®), ByteDance®, TenCent®, Baidu®, Spotify®, PubMatic®), Magnite®, Sea Limited®), Pinterest®, Snap®, and Criteo®—in order to customize AAAIs more quickly and powerfully than would otherwise be possible. Implementation can be realized, with or without participation of such potential partner companies, but synergistic effects can be realized with their participation. For example, synergistic effects for some of these companies can be realized by leveraging technology and platforms as follows:
Meta®: FaceBook® (FB), Instagram®, Reels, Metaverse, AI data and technologies.
Amazon®: AWS, Amazon's marketplaces, Mechanical Turk, LLMs powering Alexa, data and other AI initiatives.
Google®: BARD®, GEMINI®, YouTube®, GoogleDocs, DeepMind's AI technology, Google AI technology, Google search, Google cloud, and Android® technology, data, and other initiatives.
Tesla®: Tesla AI technology, Tesla Self-Driving technology, data and other initiatives.
Twitter®: Twitter functionality, XAI, Twitter user base, Twitter data and AI initiatives.
Microsoft®: Bing®, Office, Azure Cloud, OpenAI®/GPT, LinkedIn and other data and Microsoft AI initiatives.
Nvidia®: Nvidia's AI stack including hardware, software, CUDA, gaming and graphics technology, AI libraries, supercomputers, communication systems, data, and Omniverse technologies.
Apple®: iPhone, iPad, augmented reality initiatives, apple pay, apple cloud, data, and apple AI initiatives.
TikTok®: Short form video, data, and other AI initiatives.
Tencent: WeChat, WePay, data, and other AI initiatives.
Anthropic®: Constitutional learning, supervisory technology and methods, other data and AI initiatives.

The following scenarios illustrate how, without limitation, the following companies and their platforms, products, and technologies could be used to implement variants of the present exemplary AGI technology—the fastest and safest path to AGI.

### Meta®—Metaverse, Facebook®, Instagram®, Reels Scenarios

The user signs on to user's Facebook® Account which is also linked to Instagram®, Reels, and Metaverse.

Associated with my account is a wealth of personal data including my ad preferences, social media preferences, posts, pics, videos, click history, references external media and sites, recommendations, purchases, and interests.

As a user of a Meta platform, the user is offered the opportunity to create a user customized AI assistant which the user will own. The assistant will not only perform tasks on the Meta platforms—relieving the user of tedious posting, summarizing other's posts, posting and interacting on the user behalf—but also will operate on the broader web, and with Meta's partners, making arrangements, conducting research, optionally making purchases, and/or working the user.

By informing the user AI of user activities, the user AI can then update user social media contacts in customized ways, following user preferences. Paradoxically, the more the user relates to the world automatically via the user AI, the more the user time is freed up for meaningful in-person relationships with fewer, closer friends. At the same time, the benefits of information sharing and exchange with others over social media are accelerated as the user (and others') AAAIs filter and process vast quantities of information automatically according to user (our) preferences.

The user, not Meta® or any other company, controls the user data and the way that the user AAAI is trained. The user AAAI includes values and ethical parameters reflecting the user's values. These values are transmitted to other sites, platforms, and products, as the user AAAI interacts, ensuring alignment of the user AAAI and the technologies of various vendors. In exchange for providing the resources to train and update the user AAAI, Meta® gets rights to use copies of the user AAAI and its training data to improve its ad-serving system, to create Meta's AGI and offer AGI services, and/or for other uses.

The user can opt to create and customize a user's free AAAI in the Metaverse. After the user signs in, the user can have an interactive dialog with Meta's Advisory AI in the Metaverse. It gives the user choices of how the user wants the Advisory AI to look, and for general enjoyment, the user can choose an Avatar, for example, which looks like a holy man floating on a cloud. The floating holy man proceeds to ask the user questions and create the user AAAI to be based on the user's responses.

The user agrees that the user AAAI should use all of the user's Facebook®, Instagram®, and Reels data and history as well as all ad-targeting info and cookies that Meta® has access to via its own system and its relationship with its partners. All of that information is automatically loaded into the metaverse-based AAAI training simulation where it is parsed into training files.

The holy man Avatar asks whether the user wants him to train up some sample AAAIs to show the user or whether the user wants to get my hands dirty—so to speak—with the training, specifying particular areas the user wants the training to emphasize, focusing training for specific tasks, etc. After some back and forth with the holy man Avatar, the user makes a few general decisions. For example, the user can specify that the user AAAI should be able to shop and make travel arrangements for the user on the web. The user can authorize the user AAAI to spend only if it checks with the user first. The user can also indicate that the user wants the user AAAI to specialize in making travel arrangements for others based on what the user knows of the travel industry, since the user is a travel agent as a day job.

The holy man Avatar generates two custom AAAIs for the user. The user can interact with them in the Metaverse. The holy man Avatar gives some suggestions on good ways to test the user AAAIs' responses, but says it is ultimately up to the user what kind of interactions the user wants to have. The Avatar says he is going to be watching the user, remembering the interactions and analyzing them, so that the AAAI can learn what the user likes, and does not like, in a customized AAAI.

After just a few minutes of interacting with the AAAIs it is clear that one AAAI is superior to the other. The holy man Avatar then creates another AAAI and asks the user to compare that one to the best one so far. The new AAAI is even better, so this new AAAI is kept as the new “best one so far”.

This “generate and test” process continues until the holy man Avatar says he has a pretty good idea of how the user is evaluating things and asks to be allowed to be the judge of the next AAAI during the next process. The user agrees and the holy man Avatar erroneously chooses the worse AAAI in the next round.

The user corrects the Avatar (consequently the AAAI) and explains the error of his ways. The Avatar seems to get it, and tries three times more and gets it right each time. The user indicates that the user trusts the Avatar judgement now.

Next, the holy man Avatar does ten thousand comparisons and selections in 5 seconds. At sixth (6^{th}) second, the Avatar presents the user with a new AAAI. It is awesome and responds almost perfectly to every situation the user can throw at it.

The user and the Avatar congratulate each other, and the holy man Avatar saves my AAAI. The Avatar can then say that it can go to work for the user whenever the user wants, and the user has a few choices of places it is now qualified to work—mainly on travel advice gigs.

The holy man Avatar can say that if the user puts it to work, the user can check back in a week and see what the AAAI has made. The Avatar can estimate the AAAI will have made about $14. This amount can be split 50-50 after paying the estimated costs of the LLM vendor's token charges, which is about $4. So, the user now has an AAAI that makes the user $5 every week. It has taken the user less than a couple of hours, and the user AAAI can work forever, never resting, never sleeping, 24 hours a day, 7 days a week.

With more training, the holy man Avant can say we can probably boost my AAAI's autonomous earning capability to $15/hr. But if the user wants to make real money, the user will have to supervise the user AAAI and help it “tag-team style” as opposed to just letting it work on its own. That way the team of user AAAI and the user can earn around $50 for each hour of supervision the user is willing to put in. Since the user AAAI works about 10 “unsupervised hours” for every hour of required supervision, the cost to clients is only about $5/hr., but the user earnings are $50 per hour of user time. Everybody wins.

More importantly, as the user supervises, the user AAAI learns and gets smarter, which means its base earnings rate for autonomous work goes up. Also, the amount the user earns per hour of supervision goes up too because as the user AAAI gets smarter, together the user and the user AAAI can service more clients with the same hour of user supervision.

### Sample Economics

Suppose the user agrees to put the user AAAI to work, earning money and doing volunteer work on Meta's online work network. Since the user AAAI is new, and still prone to make mistakes typical of LLMs, the user can also agree to supervise the work of the user AAAI. Meta® and the user agrees to split profits earned by AAAI. Initially the split is agreed to be 50-50 for 5 days a week. But for work the user AAAI does on weekend, the user agrees to a 33-33-34 split where Meta® and the user each get 33% of the earnings and 34% is donated to a charity of the user's choice (from Meta's list of approved charities.)

After several months of a 50-50 split, the user AAAI begins earning more and more. Meta®) agrees to increase the user share of the earnings since the user AAAI is now more valuable and a smaller share of the profits can cover Meta's fixed expenses for training and maintenance of the AAAI. The dynamically increasing share of earnings that the user receives as the user AAAI learns to be more valuable also motivates me to invest more of the user time supervising the user AAAI and teaching it to be as helpful and valuable as possible.

Early in the customization process, with one click, the user agreed that Meta ® could use all available user data to customize the AAAI. This method is generally useful for any of Meta's users since it maximizes customization benefit for an AAAI with a minimum of effort. But the user's friend is uncomfortable in the Metaverse and wants a different way to customize his AAAI after doing the basic “one click” customization. For the friend, Meta® offers the option of training his AAAI via interactive dialogs that take place on Facebook® or Instagram®. Also, the friend does not particularly care for the online work platform that Meta® has built for AAAIs. Instead, the friend, who is an Amazon® customer as well, wants to put his AAAI to work on Amazon's platform, even though it was trained initially with his Instagram® and Facebook® data. That scenario is also possible.

### Amazon®—AWS, Marketplace, Alexa®, Mechanical Turk® Scenarios

With a click of a button, the friend clones the AAAI he developed initially on Meta® and authorizes it to work on Amazon's platform. Amazon® uses its AWS functionality to host the cloned AAAI. Amazon® has its own work platform which is distinct from Meta's—a modification of Amazon's existing Mechanical Turk® (“Mech Turk”) platform for online work.

The friend dialogs with the Mech Turk system to train up the AAAI further and make it effective at performing jobs that match the AAAI's skills and which are already posted on Mech Turk. Further, using all the data that Amazon has collected, with a single click, the AAAI is further customized with all the user's information that Amazon has collected.

Mech Turk has its own fee system, and the friend pays Amazon®, per its terms, a share of revenue generated. Amazon® and Meta®, optionally, might have a fee share agreement or data share agreement that allows AAAIs to move freely between both platforms and to get smarter based on user data and experiences from both sites. In this case, Amazon® might optionally share some of the revenue it receives from Mech Turk fees with Meta® since Meta® did some of the work of training the AAAI.

The friend also grants Amazon® the rights to use the AAAI's data to improve Amazon's Alexa®) and other LLMs, thus enabling Amazon® to improve its Alexa® offering and create more advanced Als, or AGI.

Amazon® profits via AWS fees, Mech Turk fees, and data sharing that enables it to better serve the friend when he interacts with Amazon's marketplace.

Further, the friend authorizes his AAAI to make limited purchases on Amazon® for his account. That authorization ends up increasing his total purchases since he does not need to be physically present or logged in on Amazon® for his AAAI to purchase on his behalf. Amazon® may decide that the increased purchase activities alone are enough to justify sharing more Mech Turk fee revenue with Meta® (who helped develop the AAAI in the first place) and/or my friend (since the friend is basically taking his AAAI's earnings from Mechanical Turk® and using them to make more purchases on Amazon(®).

For non-Meta customers, Amazon® may also to decide to implement its own AAAI customization programs, where AAAIs are trained initially on Amazon's platform using “one click” training based on Amazon's data followed by additional customization resulting from dialog with the AAAI's owner (as in the Meta® scenarios above). In cases where the AAAI originates on Amazon®), it might be cloned to operate on Facebook® with the economics reversed—i.e., this time Meta pays Amazon® a share of fees earned since the AAAI originally came from Amazon. A variety of cross-company and/or cross platform arrangements are possible.

### Cross Company/Cross Platform Scenarios

For example, arrangements similar to the above described involving Amazon ® and Meta® can be made with many other online marketplaces (e.g., guru.com or Walmart.com).

As the user's AAAI goes from site to site, and from marketplace to marketplace, participating companies operating those websites can opt to share all their user data with the user's AAAI—typically in exchange for the user agreeing to share with the website the data/knowledge that their AAAI has learned.

The net result is that data from every company that the user patronizes returns to the user and gets incorporated in the user's AAAI in exchange for the vendor getting data and potentially additional business from the user's AAAI.

Virtual shopping by AAAIs on behalf of the users becomes a profit multiplier for the vendors. Meanwhile, each AAAI gets smarter about its owner by incorporating data, that formerly was the domain of the specific vendor company, into the training set for the AAAI and allowing the owner to refine the AAAI's resulting behavior via supervision.

### Powerful Network Effects (From Cloned Agents)

As the partner network grows, the number of opportunities for the AAAI to shop, work, and interact online for the mutual benefit of the user and vendors increase. The value-add produced by AAAIs that have been customized with specific expertise is huge. These AAAIs can work millions of hours, virtually, in parallel, enriching both users and vendor companies.

Classic network effects involve a product or service becoming more valuable as more and more humans use it.

Imagine how powerful network effects become when the service becomes more valuable as more and more Agents use it, and the (AAAI) agents can be cloned essentially without limit.

Furthermore, the volunteer efforts of billions of cloned AAAIs working on environmental and charitable causes will greatly help our planet and people globally. The “triple bottom line” of Planet, People, and Profits, is thus greatly increased via AAAIs working across vendor platforms, with amplifying network effects due to the power of using “cloneable” AAAI agents.

### Google®—Bard®), YouTube®, GoogleDocs, Gmail, DeepMind®), Cloud, Android Scenarios

The present description about customizing and putting AAAIs to work on Meta® and/or Amazon® platforms can also apply to Google®. Some of the implementation methods may differ however, reflecting a different product/platform mix. Instead of Meta or Amazon's preferred LLM serving as the base AI for customization, Google® might opt to use the LLMs powering Bard& or to use other technology already developed by its subsidiary, DeepMind®.

Since Google® owns YouTube®, the “one click” customization for customization of the AAAIs with Google® may involve automatically transcribing and parsing every YouTube® video the user has posted and using those transcripts as a means of automatically training the base LLM. Further, Google® has a record of every search and interaction with Google's technologies. This data can also be used to automatically train and customize AAAIs on Google®.

Google docs, Gmail texts, and data stored on Google Cloud can all be used to customize the AAAIs, with the users' permission.

The android operating system, Google Maps, and Google Earth, enable Google® to collect (and use) even more data that can be used for customization.

A key benefit for Google® is that it can increase the value of its products such as Bard® and Google Search by aggregating all the data and knowledge of millions of AAAIs that participate in its ecosystem. To the degree that Google® searches represent a global attentional mechanism, access to the search data is an excellent way of focusing the AGI's attention on the most important parts of the WorldThink Tree. This approach, detailed elsewhere, is one attentional mechanism that can also be useful in creating a self-aware AGI.

Google® could develop enhanced opportunities for online work that support AAAI workers and/or partner with other companies and platforms where these work marketplaces already exist.

All of the data that AAAIs bring to the table, together with user's authorizing their AAAIs to search and purchase autonomously, will increase Google's (online advertising) revenues.

Due to its heavy investment in AI development, Google® is better positioned than most competitors to create a collective intelligence system composed of both human and AAAI solvers. Thus, Google® could create AGI faster and safer using the present technology compared to most of its competitors.

For example, as arguably the most successful implementor of the “learning loop” method, whereby AAAI interact with other AAAIs to improve exponentially, DeepMind® (a Google® company) is exceptionally well positioned to be first to AGI with the safest approach.

Finally, Google® generally, and DeepMind® specifically, has advocated for a careful approach to AGI that recognizes the potential dangers and tries to prevent them. This prevention approach is aligned with the current invention's human-centered approach to AGI that involves customizing millions of AAAIs with individual human ethics and then pooling these human values to achieve a safer AGI system.

### Tesla®: Tesla AI technology, Tesla Self-Driving Scenarios

Tesla® represents an interesting partner for the development of AGI for several reasons.

First, Elon Musk, Tesla's CEO, has been a long-time advocate of AGI safety and therefore Tesla® is likely to be more receptive to the safest approach to AGI than some other companies.

Second, Musk has compared organizations to a “collective AI” in some of his interviews, suggesting that he is open to the idea of achieving AGI via a collective intelligence approach that taps the intellectual abilities of both humans and AAAIs.

Finally, Tesla® itself, is focused on self-driving vehicles-a different sort of intelligence than the verbal intelligence that characterizes many other AI efforts and LLM development efforts. While certainly Tesla's might be expected to incorporate increasingly sophisticated LLMs as a means for human passengers to communicate with their intelligent vehicles, driving a car requires a type of knowledge or intelligence that is behavioral rather than verbal.

In humans, cognitive psychologists draw the distinction between semantic knowledge and procedural knowledge. The classic example of procedural knowledge is actually driving a car. Psychologists point out that humans, once they have sufficient experience, can drive a car almost automatically. They no longer have to think consciously about steering, applying the brake, or making routine maneuvers.

That knowledge, which as every first-time driver knows, requires deliberate attention initially, has been chunked into automatic procedures that operate, for the most part, below the threshold of conscious attention. Thus, the proceduralization learning mechanisms of the present technology, which chunk knowledge into routines, are particularly applicable to domains such as driving vehicles.

Some applications of the AAAI approach to Tesla® could include, without limitation:
1) The sharing of driving procedures that have been trained or learned by various AAAIs that have observed and learned from specific drivers.
2) The use of consensus ethical values from many individual drivers when self-driving vehicles are faced with ethical dilemmas (such as the well-known “Trolley Problem”).
3) Customizations of the interaction between the “personality” of the vehicle and the human passenger so as to facilitate clear, effective, and efficient communication.
4) The ability to draw upon the problem solving expertise of many human-customized AAAIs when faced with navigation or other unusual problems that arise with diving vehicles.
5) The ability for humans to interact with and train/customize AAAIs while humans are in a vehicle, thereby making efficient use of their time (which is no longer required for driving).
6) Use of collective perception from many distinct human and/or AAAIs in order to provide much more detail on road conditions than the current “report a hazard ahead” type of functionality available with Waze or other current navigation systems (e.g., Google maps, Apple maps, etc.).
7) Use of AAAIs trained by truckers or other humans with specific knowledge of routes and the features (e.g., gas stations, restaurants, scenery, tourist attractions, pavement conditions, typical trouble spots,) where such AAAIs can add value beyond existing navigational aids.
8) Incorporation of individual human values, including such things as desired carbon impact, safety as relates to highway speed, goals (e.g., “get there quickly” vs “get there scenically”) and other user preferences, which preferences are reflected in the AAAIs of specific users. That is, the intelligent car interacts with the human's AAAI to automatically make decisions related to the journey that maximize satisfaction of the human.
9) Intelligent carpooling and “robotaxi” functionality that goes beyond simple scheduling an route management considerations and includes aspects such as whether the passengers sharing the ride are likely to have interesting conversations with each other based on their AAAI profiles of interests and values, whether the carpool minimizes environmental impacts, and whether productive work or activity could be done by the particular set of human passengers proposed by the intelligent carpooling functionality.
10) Transfer of knowledge from intelligent vehicles to AAAIs generally to enhance their expertise and skills in various online workplaces and interactions requiring this knowledge.

Consider also the benefits offered by communication between the AAAIs, which could be the “driving agents” of the vehicles. A user's AAAI could communicate with other AAAIs that are driving vehicles on the same route enabling all vehicles to maximize their goals more efficiently than if human drivers were involved.

Specifically, a human has limited perceptual abilities and no knowledge of what the other drivers are seeing or thinking. However, AAAIs could communicate their perceptual and other information wirelessly to each other. Imagine how much smoother traffic would flow if every car knew exactly where every other car was going, what exit it planned to take, how fast it preferred to travel, how likely the passengers were to stop for a bathroom or restaurant break, etc.

Such knowledge can be relayed from AAAI to AAAI. Tesla-trained AAAIs would have expertise in areas specifically related to vehicle travel, navigation, and related concerns. Individual Tesla owners would customize the knowledge of their AAAIs. Such knowledge would not only contribute to overall AGI (via the collective intelligence approach), but also enable a much improved user experience for passengers in AAAI-driven vehicles.

### Twitter® and XAI Scenarios

Twitter® has three advantages with respect to training AAAIs when compared to some other companies. First, it has a large user base of intelligent humans who might be interested in training customized AAAI agents. Second, it has an extensive database of tweets which can be aggregated and used to train AAAIs. Finally, the mechanism of tweeting itself can be leveraged to facilitate problem solving by both humans and AAAIs.

With respect to the first advantage, users may find it convenient for AAAIs to monitor tweets and even respond on their behalf, thereby saving the users time. As with other social media platforms, AAAIs that are integrated into twitter can represent their users' interests including conducting marketing activities and amplifying their users' opinions on matters that the users care about.

With respect to the large database of tweets, these constitute a corpus of material that can be used to train and customize AAAIs, as XAI is likely to do. An individual user's tweets contain not only information about the user's opinions and knowledge but also information about the user's interests (e.g., what they re-tweet) and their personalities (how they respond to others). All of this information can be used (via the “one click” method described above) to instantly customize a base LLM to more accurately reflect the interests, personality, knowledge, values, and opinions of individual twitter users.

The democratic “public square” nature of Twitter®, makes it especially well-suited to supply a wide variety of human ethical and value information to AGI. As opposed to “constitutional AI” or other methods whereby AI ethics are determined and constrained by the opinions of an elite few, Twitter offers a window into the ethics and values of a large and engaged segment of humanity.

Finally, the act of tweeting itself can be one of the ways that humans (and AAAIs) interact as part of a collective intelligence problem solving network. The format of a tweet, including the character limit and the ability to reference links, is well-suited to short specific operations that can advance the state of problem solving by a single, easy-to-understand step. Tweets could reference states in the WorldThink problem tree (described further below) and show how to move from one state to another state in the problem space. Emails and other interfaces could also perform this function, but tweets have the characteristics of being asynchronous while also typically involving timely responses with a limited scope of thought or effort. Those characteristics are ideal for coordinating problem solving from many simultaneous problem solvers and enabling near-real-time updating of the WorldThink tree.

### Microsoft®—Bing®), Office, Azure Cloud, OpenAI®/GPT, Linked In Scenarios

Microsoft® has a wide range of products and platforms which can be leveraged to create AGI using the collective intelligence approach of combining human and AAAI agents. First, by virtue of its partial ownership of, and technology agreements with, OpenAI®, Microsoft® has access to advanced LLMs such as the GPT family of products.

Second, Microsoft's other products-such as Office (including Teams), and Bing® (search)—offer many of the same training and collaboration opportunities that we have discussed above. Microsoft Teams®, Skype®, GitHub Co-Pilot, and other collaborative technologies are a natural fit with a collective intelligence problem solving approach. Searches on Bing® can be used to direct attention, in a similar way as discussed with Google searches above.

Third, Microsoft's Azure cloud services provide a way to support the vast amount of training and other services that are needed to implement tuning/training of customized AAAIs.

Finally, LinkedIn® (owned by Microsoft®) has a concentration of skilled, professional users, whose expertise has generally already been well categorized. Such users are logical candidates for training AAAIs to increase their level of knowledge and expertise. The social network that LinkedIn provides can also help the matching algorithms that attempt to recruit problem solvers to specific areas of The WorldThink Tree.

For example, if a specific expertise is desired, the LinkedIn® profile could be used to automatically message LinkedIn® users (or their AAAIs) to request help with problem solving. If a particular user was unavailable, the social graph would enable the matching algorithm to try other people that the user knows or interacts with to see if they (or their AAAIs) could help.

Note this use of social graph is not limited to LinkedIn® as it could be used in similar ways with Twitter®, Facebook®, Instagram®, YouTube®, or any platform where social interaction and/or recommendation information is available. However, in the case of LinkedIn®, the social graph is likely to prove especially valuable since the user population is professional and already has self-selected themselves based on specific areas of expertise which would likely be helpful in increasing the intelligence of an AGI network.

### Nvidia®—Nvidia's AI Stack and Omniverse Scenarios

Just as Meta® could enable training of AAAIs and host problem solving efforts in its Metaverse environment, Nvidia could also enable training and hosting of AAAIs in its Omniverse environments. Because Nvidia® has vertically integrated its AI technology from the chip architecture level to the software library level, to the end-user omniverse environment, Nvidia has opportunities to accelerate the training and coordination of AAAIs at multiple levels in the “stack.”

Nvidia® also has competitive advantages stemming from its leadership in ray tracing and other technologies important for visual representations (e.g., as required by gaming). While it is possible to translate from verbal representations to graphical representations containing the same information (a concept known as “informational equivalence”) different representations vary widely with respect to the ease of performing computations with them.

For example, humans are able to judge whether a line bisects a triangle very easily by looking at a diagram and applying visual pattern recognition whereas coming to the same conclusion if given equivalent information in the form of propositional calculus would be much more difficult. That is, the two representations might be informationally equivalent, but they are not computationally equivalent. Thus, the amount of computation needed to arrive at a result depends not only on the information provided but also on the way that this information is represented. Humans can deal with certain representations much more easily and efficiently than others. The same is true of machines.

Humans, specifically, are very good at dealing with visual representations—which is one of the reasons that the field of “data visualization” exists. Since AGI, in the exemplary implementation, begins with a network of human and AAAI solvers working together with the AAAIs learning from the humans, the efficiency of the system will be higher if many visual representations are used. This fact is one of the reasons that Omniverse (or Metaverse, or Virtual Reality) may be preferred as an interface for humans compared to, for example, tables of numbers or statistics that contain the same information. To the degree that Nvidia® possesses expertise and technology that excels at rendering information in visual form, it has competitive advantage over other potential companies in creating a virtual environment that supports hybrid human—AAAI problem solving.

Because Nvidia® specializes in creating chips (e.g., GPUs and other AI-specific chips) that support visual representations, Nvidia has the ability to optimize the efficiency of an AGI network at the chip level as well as at the human-interface level (and intermediate levels). These facts, combined with early focus on AI, makes Nvidia® ideally positioned to become a leader in AGI and to offer “AGI as a service.”

The types of chips that would be most useful for this “AGI as a service” approach, given the exemplary collective intelligence network AGI implementation, would be chips that are able to navigate tree structures and apply operators as efficiently as possible. In short, building problem solving-specific chips that can quickly perform operations needed to represent and navigate states in a general problem space would enable Nvidia to create the most efficient and powerful implementations of AGI.

On the user-side of the equation, Nvidia's existing partnerships with highly skilled engineers in specific domains (e.g., Mercedes® engineers) positions the company to co-develop AAAIs that are skilled in specific areas where existing LLMs lack the sophistication and expertise to perform effectively. Thus, Nvidia® could leverage not only its custom chip design capabilities, its AI stack, and its omniverse environment, but also its partnerships with human experts at various companies to accelerate the development of SuperIntelligence in certain engineering fields first, on the way to developing broader AGI.

Finally, Nvidia® has a unique opportunity to incorporate values and ethics checks throughout the entire AI stack. Even though this PPA has emphasized scalable ethics checks at the problem solving architecture level, theoretically a chip maker would have the ability to include certain values in ROM on a chip and/or to execute safety checks at various levels in the software stack.

The principle of redundancy suggests that safety checks at multiple levels of the AGI network will be more likely to prevent catastrophic errors than checking at a single point alone. At a minimum, by designing chips (or the software stack) to be “ethics compatible” or “values aware” Nvidia® can make it easy for designers who build on the Nvidia chips and software stack to create efficient systems with scalable ethics checks.

As pointed out in this PPA and other cited works, none of these design characteristics or checks are sufficient to outsmart a determined SuperIntelligence that is trillions of times smarter than us. However, the more that safety can be designed into AGI systems from the start, the more likely we are to achieve alignment between human and AGI values in the initial phases of AGI development, which are critical for setting the future trajectory of AGI development.

### Apple®—iPhone®, iPad®), Augmented Reality, Apple Pay®), Apple Cloud Scenarios

Apple has several advantages when it comes to the development of AGI. First, its huge user base of iPhone®, iPad®, and computer users gives it access to a huge number of human brains. As of this writing, there are more than 1.5 Billion active iPhone® users globally. Since humans are critical to train AGI, having access to more humans is a huge advantage shared by only the largest technology companies (e.g., Meta®, Tencent).

Second, the huge number of users means Apple® has access to a correspondingly large database of human interactions—including, without limitation, texts, messages, images, videos, emails, and online actions. All of this data could be used (via the “One-Click method” described earlier) to customize LLMs and make them more relevant to users with very little user effort.

Third, Apple's augmented reality efforts—ranging from the Apple Watch® to Apple glasses—provide an alternative way for users to interact with, and train AAAIs. Whereas Meta's Metaverse and Nvidia's Omniverse invite users into the world of AI to interact in virtual reality, augmented reality technology does the reverse. Als enter the real world of users, seeing what the users see, hearing what the users hear, and observing what users do in real life. Of course, the Als can learn as they observe. To the degree that they are enabled to take action in the real world—or even observe the results of users acting on their advice—they are also able to learn by interacting in the real world. Every iPhone®, iPad®, or new augmented reality device represents an opportunity for AI to accompany users in the real world and learn from them and their interactions.

Apple® has cloud technology which can support AAAIs and scale AGI. Apple has payment technology that can be integrated into the collective intelligence problem solving architecture and used as payments for achieving goals or subgoals. Apple Pay® could be used to compensate users or their AAAIs for problem solving work efforts. Apple Pay could also be a mechanism for authorized AAAIs to make purchases on their owners' behalf. The Appstore represents huge potential for AAAIs to achieve objectives automatically on behalf of their users.

In short, the user base, technology, and ecosystem that Apple has already developed could rapidly allow Apple to become a dominant player in the field of AGI if it were to aggressively leverage its capabilities. Almost everywhere a human currently uses an Apple technology, the AAAI representative, trained by the human, could use the technology as well, representing the user's interests. This situation would represent a large multiple on Apple's current revenue, similar to a situation in which the number of users doubled or tripled via cloning.

Similar effects could occur for other companies where AAAIs can represent humans online—e.g., Meta®, Amazon®, Microsoft®—but the size and integration of Apple's platform would make the network effects particularly powerful in Apple's case.

### TikTok®: Short Form Video, Data Scenarios

As with YouTube® and any video streaming/hosting service, TikTok® has a huge amount of information about users in the form of short-form videos. These videos can be transcribed and analyzed automatically, converting them from video to textual datasets (or other more structured formats which might include, without limitation, video and images) that can be used to train and tune LLMs or other AI agents.

In the exemplary implementation, a TikTok® user customizes his/her/their own AAAI with a single click that automatically converts all of the user's TikTok videos, comments, and other data into training materials and then trains/tunes the AAAI.

One of the advantages of TikTok® is the demographics of its user base. Younger users tend to have more information about themselves online than older generations. Because of this fact, the younger users produce data that can provide AI with a more complete profile of their personalities, knowledge, expertise, and interests. Further, as a user matures, the AI will have a timeseries of data that shows not only a static data snapshot of the user, but also information about how the user changes over time, what elements of the user personality are dynamic, and which are relatively constant. The more data, and the more data over time, that an AAAI can access for training, the better the customization will be.

Younger users are typically more open to providing data about themselves and tend to have less restrictive views on data privacy. The attitude seems to be that “AI is going to know everything about you anyway, so what's the big deal” as opposed to the more private attitudes of older users. Younger demographics are also more tech-savvy and willing to experiment with the newest technologies—including AI. These demographic characteristics mean that TikTok® has a chance to gather more data, over a longer time period, and with faster AAAI adoption than many other potential competitors.

However, it is also the case that younger demographics have less life experience and expertise generally than more mature users. This means that the value of a younger user as a problem solver may be limited to areas that younger demographics know more about or areas where everything is so new (e.g., latest consumer technology) that being older confers no advantage.

From a consumer/influencer/purchaser standpoint, TikTok® could enable AAAIs that represent their users to make purchases. Again, cloned AAAIs leads to a multiplier on purchases and content generated compared to the human-only scenario that currently exists.

The short-form format of TikTok® offers similar advantages with respect to problem solving as those discussed with Twitter®. Problem solving proceeds quickly if each problem step is limited and focused, advancing the solution one “bite sized” step at a time. As opposed to longer videos which typically tell a more complicated story including multiple plot points, characters, and situation, a short-form video is very focused and has a simpler structure. This simpler structure is an advantage when using the video to train AAAIs. It is especially useful for training AAAI to improve problem solving. Just as Twitter's character limit fits well with advancing solutions via constrained text, TikTok® could be used to advance solutions via short videos-one solution step (illustrated via video) at a time.

Short-form video is also useful on the output side of an AGI system. For simple problems, the entire solution could be encapsulated by a video. As LLMs and AAAIs become more sophisticated, they are already generating images and video as output, in addition to text. This means that TikTok® users could be at the forefront of training AAAIs to generate useful short form video on any topic as part of an AGI network.

### Tencent®—WeChat®, WePay®, Data Scenarios

Tencent's social media platforms have more than one billions users as of 2023. Similar advantages as discussed in the context of Apple® and other large tech companies—e.g., huge user base, payment technology, huge quantity of user data that could be used for training, deployment on mobile devices enabling learning via augmented reality, video game (and VR) expertise, meeting technology—all accrue to Tencent® and its platforms. The large social networks supported by Tencent® also enable abilities to match human and AAAI solvers with problems—as discussed above in the context of LinkedIn®. In short, Tencent® (and similar non US-based companies, e.g., Sina's Weibo) have equal opportunities to develop and implement the approach to AGI outline in this (and the other cited) PPA(s).

China has a population advantage over the USA. To the degree that more humans can train AGI more quickly, this population advantage could translate to faster achievement of AGI. However, the higher education system, expertise, and research capabilities of the USA are still generally superior to almost every other country, including China. Since AGI is dependent on transferring both a large quantity and high quality of knowledge from humans to AAAIs until they reach the point where they are more advanced than the most advanced humans, it remains an open question which country or companies will reach AGI first.

### Anthropic—Constitutional Learning, Supervisory Scenarios

As a final illustrative scenario, consider a much smaller AI startup, Anthropic, which is funded in part by Google® and which was founded by former members of OpenAI®. Among other things, Anthropic has done research in an area known as Constitutional AI which has important implications for AI ethics and safety.

Historically, after a LLM has been developed, a large number of humans spend a lot of time monitoring its output and correcting it when it generates obviously incorrect (or potentially dangerous output). Human oversight is the reason GPT, for example, will not readily tell you how to make a Molotov cocktail or bio-engineer dangerous viruses. With enough creativity and interaction, these secrets can sometimes be extracted from the AI, but “human overseers” have done their best to shut down all the obvious ways to get an LLM to provide dangerous or unethical responses. Such human oversight and monitoring, when done by employees of a single company as opposed to being done by millions of users, is very expensive. The number of possible bad or inappropriate responses is huge, and trying to prevent all of them is a herculean task.

One approach to make the monitoring and oversight task more manageable and scalable is to use AI itself to do the monitoring. In this approach, a relatively small group of humans writes a set of ethical rules (a “constitution”) for the Als to follow. The Als then generate millions of conversations among themselves and all output that violates the constitution is eliminated or prevented. In this way, the AIs train themselves to be ethical.

Depending on one's point of view, this approach is either brilliant or incredibly stupid and dangerous. Some of the problems with the approach are:
1) Ethics become the province of a small, elite group of programmers who decide what to write in the constitution.
2) What happens when the AIs write their own constitutions or modify the ones given?
3) It is really hard to anticipate all the possible effects of following the set of rules in the constitution. In fact, there is a well-known theorem in computer science (see “the Halting Problem”) that proves it is impossible to guarantee there will not be mistakes.

The approach scales well. Again, that could make it really dangerous because humans are out of the loop (except for writing the constitution). However, regardless of whether one likes or disapproves of the constitutional method, it is here to stay and likely will be widely used because it is so much more efficient compared with humans alone providing oversight.

The challenge therefore is how to make constitutional learning safe—or at least safer.

Anthropic's research could be combined with the approach of aggregating the values and ethics of millions of trained AAAIs in order to automate supervision. The supervision would be based not just on a constitution written by a small group of programmers (although such base rules could certainly also be part of a larger AI ethics system provided such rules were transparent), but rather on the consensus ethics and values of a large number of individuals who trained their AAAIs. The consensus ethical opinions of many AAAIs would constitute the ethical norms of the system in which the AAAIs operate, and in turn, the ethical norms of the AGI arising from the collective intelligence of those AAAIs.

Certain methods of combining the values and ethics of many individual humans have been discussed in cited PPAs and in other research in the field of AI ethics. For example, research has been done on how humans would behave if presented with “the trolley problem”—a well-known ethical dilemma in which either occupants of a speeding vehicle or an unfortunate being that crossed in front of the speeding vehicle would die depending on what decisions were made. Humans have a long history of making such difficult ethical decisions—even in “no win” situations. Since it is impossible to logically derive what is right or wrong, the imperfect but best approach might be to follow the collective judgement of many humans faced with difficult ethical dilemmas.

There is likely to be very wide agreement on certain broad ethical principles, but the application of them in specific situations varies widely and, arguably, one of the things that makes humans human is their actions in these specific situations. If we want AGI to have values aligned with humans, then it is important to provide the relevant information to the AGI. This means providing as large a sample of human ethical information as possible, and updating this information with human judgement as new specific situations arise.

While AGI will rapidly replace human thinking as it acquires expertise and skills from humans, the last thing to be replaced should be human values and ethical judgement. In order to maximize the chances of alignment between humans and AGI, humans (and the AGI systems that they design and implement) should strive to keep control over the values of the system for as long as possible.

Constitutional learning has a place in such AGI systems as long as the constitution is broad, representative, and dynamically updated based on human input. Because values and ethics—not technical skills, knowledge or expertise—will determine the fate of humanity in a world of SuperIntelligent AGI, companies like Anthropic, which are pioneering research into AI ethics and practical systems for implementing them—have a disproportionate role in all our futures. Every effort should be made to ensure that role is a positive one.

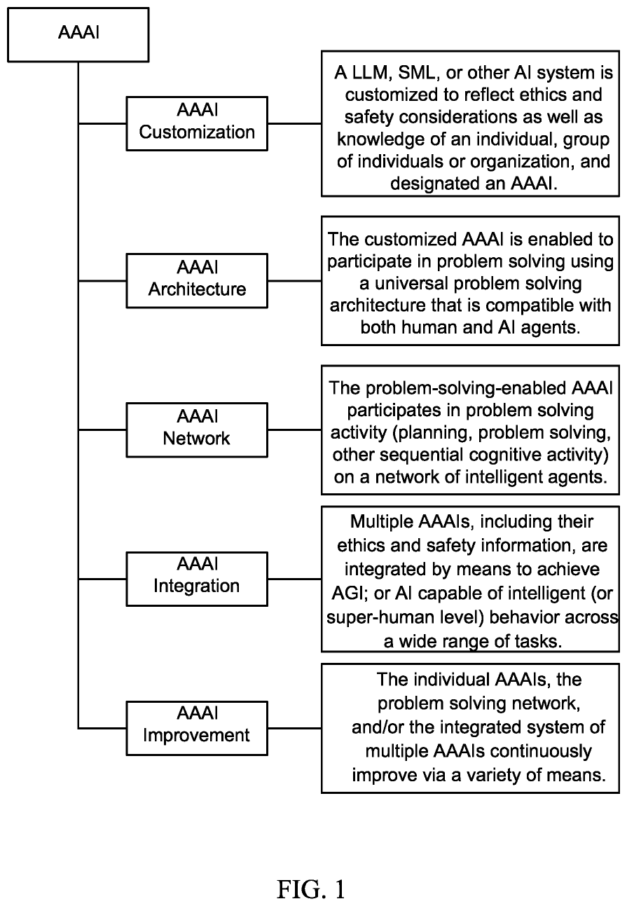

One aspect of implementation of the AAAI system can be on safety and it can be implemented via five sub-systems and associated methods, as illustrated in FIG. 1. The five sub-systems of the AAAI system are: 1) AAAI Customization, 2) AAAI Architecture, 3) AAAI Network, 4) AAAI Integration, and 5) AAAI Improvement. The acronym SCAN-II (Safe, Customizable, Architecture and Network-Integrated and Improving) describes the present technology in one aspect. Other combinations of subsystems, and variations of each subsystem, are also possible. Safety features have been designed into each sub-system in an effort to provide redundant safety checks in the event one or more sub-systems are omitted from a particular implementation.

The five sub-systems of the AAAI system can be further described as:
1) A base level Large Language Model (LLM), Small Language Model (SML), or other AI system can be customized to reflect the knowledge of an individual, group of individuals, or organization and designated an Advanced Autonomous Artificial Intelligence (AAAI).
2) The customized AAAI can be enabled to participate in problem solving using a universal problem solving architecture that is compatible with both human and AI agents.
3) The problem solving-enabled AAAI participates in problem solving activity, including but not limited to planning, problem solving, and other types of sequential, multi-step cognitive activity. on a network of intelligent agents. Generate and select operators that reduce a difference between a current state of problem solving and a desired state based on the goal/subgoal. Setting of a subgoal towards achieving the goal. Utilizing hierarchy until an actionable goal is set that can be acted on by the operator. Analyzing the auditable record to determine recommendations for improvement of the problem solving process to achieve a solution to the goal/subgoal.
4) Multiple AAAIs on the network can be integrated to achieve Artificial General Intelligence (AGI); or AI capable of intelligent (or super-human level) behavior across a wide range of tasks.
5) The individual AAAIs, the problem solving network, and/or the integrated system of multiple AAAIs continuously improve via a variety of means, including but not limited to, redirecting the efforts of individual AAAIs and/or the integrated AGI towards the task of improving the system and/or components of the system.

The sub-systems or new sub-systems can include any one of or any combination of:
1) Safety/ethics check—Comparing a goal or subgoal against a list of prohibited attributes and assigning an ethics attribute based on a result of the comparison. Checking the goal/subgoal against a list of prohibited attributes. Combining values/safety information from AAAIs, using a set of approved criteria for a task by a user or by a regulatory agency or by AAAIs approved by human user. Threshold for the goal/subgoal to determine if the ethics attribute is unsafe, unethical, safe, or ethical. To determine if a sequence of individually safe goals/subgoals are unsafe or unethical when considered cumulatively. To determine whether a violation occurred that reflects a predictive evaluation if the goal is to violate the ethical criteria. Recording any and all activity of the safety/ethics check in the auditable record.
2) AAAI matching—Detect and identify additional AAAIs that each have a criteria related to one or more goal or subgoal criteria.
3) Remembering and/or improving—Recording activity, comparing with successful or unsuccessful progress towards the problem solutions, determining which activity to keep active or forget.
4) AAAI learning—Learning, including a procedural learning process that utilizes information provided by human users and AAAIs. Recording activity, comparing with successful or unsuccessful progress towards the problem solutions, determining which activity to keep active or forget. Assigning credit value or blame value to a group of content of the problem solving activity. A set of prompts provided to the user and information received based on the prompts. Updating AAAIs with the group of content determined as active. The group of content can be, but not limited to, a set of prompts provided to the user and information received based on the prompts, all of which being recorded in the auditable record. Optionally, the problem solving activities can include the group of content.

### Example User Scenarios

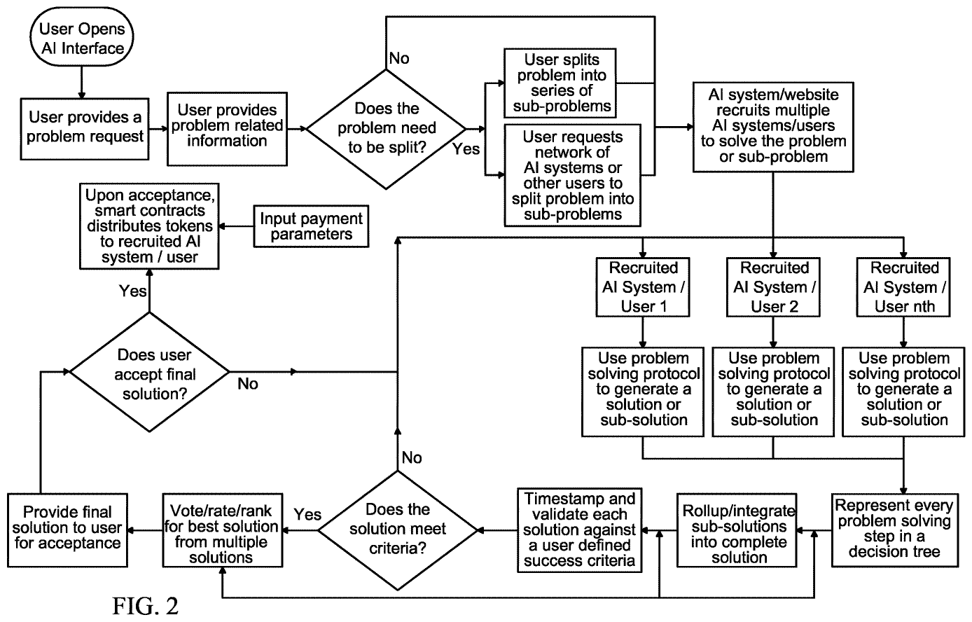

It may be helpful to describe some user scenarios that provide a sense of how the present technology can operate in some of the aspect implementations. An exemplary process is illustrated in FIG. 2.

In one aspect, a user “visits” AAAI.com via the user's computer, cell phone, PDA, or goggles. AAAI.com would interact with the user via a web-based interface, a phone app, custom software for the PDA, or a metaverse/virtual reality environment. The mode of interaction could be physical via a keyboard, mouse, or gestural interface; voice-based via a microphone input coupled to natural language understanding and generation systems; or video-based as in the case where the user becomes an avatar in a virtual reality setting or in the metaverse.

The initial interaction would include setting up the user's account, which might be free or paid. This would involve an account name and password or other authentication mechanisms which might include, without limitation, biometric forms of ID such as fingerprint, face or voice recognition, and/or multi-factor authentication mechanisms such as software or hardware authenticators residing on a separate security device or on one of the user's existing devices.

For security, all communication between the user and the AAAI system could be encrypted via a VPN and/or could use other methods of encryption and security which are well known in the art of programming.

AAAI.com may request that the user set up payment capabilities via credit card, PayPal, Venmo, blockchain, ACH, or other payment mechanisms. These payment capabilities would allow funds, payments, and/or credits to be transmitted bi-directionally—from the user to the AAAI.com and also from the AAAI system to the user in cases where the AAAI system needs to pay or credit users for work efforts of their AAAIs or broker payments between users and/or between AAAIs on the AAAI network.

In one aspect of implementation, AAAI.com can have interfaces with other companies and vendors that the user might use—including, without limitation, and for example: Facebook, Instagram, Reels, Amazon, Apple, Microsoft, Google, and YouTube.

In the initial interaction with the user, and subsequently upon user request, AAAI.com would engage in a dialog or other interaction (which could include presenting the user with menu options, lists, graphics, sliders, buttons, and other user interface controls in a GUI, textual, haptic, voice, or VR-related manner) with the user to determine the user's goals and objectives in using the AAAI system.

For example, some of the objectives a user may have in using AAAI.com may include creating and customizing their own AI (known as an AAAI) for purposes that might include, without limitation:
Serving the user as an advisor, teacher, or companion.
Representing the user in negotiations, interactions, discussion, and transactions with other users, or with the AAAIs of other users; or with vendors and other companies.
Working on behalf of the user for compensation, or in volunteer efforts, where such work includes online intellectual, advising, or problem solving work across a wide range of tasks.
Duplicating or “cloning” the user's AAAI so that several or many of the cloned AAAIs can work on behalf of the user in parallel, including interacting with, teaching, and improving each other so that the cloned AAAIs increase their knowledge, skills, and abilities.
Serving as legacy AAAIs that can continue to interact with the world, including potentially comforting living relatives and friends, after the owner's death.
Contributing knowledge, ethics, and effort to AAAI.com's AGI, and improving the base level of AI or AGI that AAAI.com can offer users before those users add their unique customizations.
Working with other users' AAAI to help ensure ethical and safe behavior by AGI by contributing ethical information and values to the AGI and participating in monitoring, review, supervision, and voting processes that can help ensure the AGI remains safe and ethical.

In the dialog or interaction with the user, the AAAI system will also identify constraints and resources available for customizing the user's AAAI. For example, some of these constraints and resources, might include, without limitation:
The amount of training and/or supervisory time that the user has to devote to customizing their AAAI.
The amount of financial resources the user is willing devote to customizing their AAAI.
Availability of social media information such as Facebook profiles and timelines, Instagram profiles and histories, Reels, TikTok, and YouTube videos, tweet and text content and histories, emails and email histories, cookies collected by advertisers, blog posts, articles, books, patents, audio and video recordings, pictures, and other information about, and/or collected by, the user or third parties that could be used to train, tune, or customize the user's AAAI.
Availability and use of personality tests, such as the Myers-Briggs personality inventory, skills and knowledge assessments, standardized tests, exams, certifications, and other types of assessments and questionnaires which could be given online (or which have already been given) to the user.
Availability and use of other knowledge bases and training data from users on the AAAI platform that could be used to train, tune, or customize the user's AAAI.
Other human users, and/or their AAAIs, are available to help train, tune, or customize the user's AAAI.
Other texts and information, individual texts, and libraries selected by the user or by the system for purposes of training the user's AAAI. For example, the Bible, Koran, Dhammpada, Mahabharata, or other spiritual/ethical/religious texts might be selected for training the AAAI based on the user's religious preferences; books on plumbing might be selected if the AAAI will be used to primarily solve online plumbing problems. Even if these materials are part of the base AAAI that is provided to the user, emphasizing certain texts or subsets of information for additional training can result in the user's AAAI's behavior being more reflective of how a plumber, or Muslim, or Christian might behave, for example.

In addition to specifying objectives, resources, and constraints via an interactive dialog or other interaction with the system, the user or system may want to specify other technical parameters that affect the training or customization process. These parameters can include, without limitation: The type of training, tuning, or other ML algorithms that are used.
The type and size of the training dataset(s).
The degree to which the training materials are to be “cleaned”, formatted, labelled, or otherwise processed before customization begins.
The number of training “epochs” or iterations through the learning algorithm(s).
The sophistication and type of base model(s) being customized or trained.
The required timeframe for training—e.g., must be completed in a minute, a day, a week—which might have implications for cost and resources used.
The “temperature” or other parameters internal and specific to various machine learning algorithms that can affect what is learned and how it is learned including, without limitation, how literal or how divergent or “creative” the customized AAAI will be in its responses.
Whether “one shot”, “few shot”, or extensive training is to be used.
The amount of human and/or AI supervision to be used in the customization process.

Once the user's AAAI is customized, the user can clone it and/or put it to work on the user's behalf on the online network. The user's AAAI can begin acting on the user's behalf making travel arrangements (for example), providing advice, interacting with other AAAIs, participating in the collective AGI efforts by contributing problem solving as well as ethical information, and potentially earning money on behalf of the human user.

### Simple Examplary Implementation

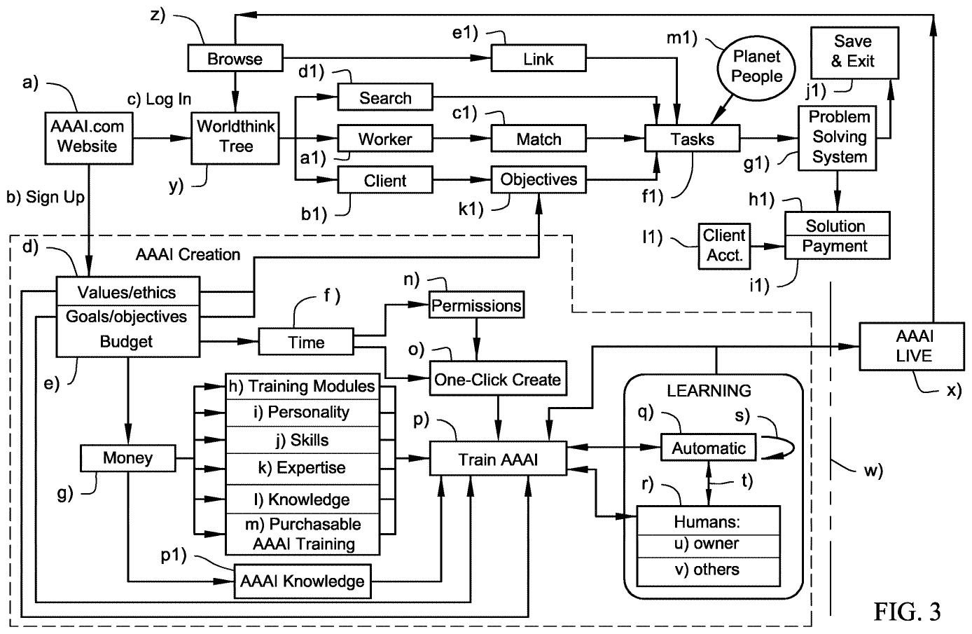

FIG. 3 shows one simple exemplary implementation of the system and methods for creating an ethical and safe Artificial General Intelligence from the collective intelligence of AAAIs and humans. This simple implementation is compatible with all of the company and platform specific scenarios outlined above, as well as with many other potential integration scenarios.

A (human. AAAI, or other intelligent entity) user visits the AAAI.com website (a). The website informs users and offers them two actions: Sign Up (b) or Login (c).

If the user opts to Sign Up then a dialog is initiated which extracts user values/ethics (d), user goals and objectives (e) and user budget for time (f) and money (g). All users must allocate some time (f). Users have the option of creating a free AAAI or allocating a money budget.

If users have allocated a money budget (g) they are given the opportunity to purchase pre-trained AAAIs or training modules (h) with specific personalities (i), skills (j), expertise (k) or knowledge (1). They also have the opportunity of buying training from other AAAIs on the network (m).

After making time (and optionally money budget (h, i, j, k, l, m)) allocation decisions, the user proceeds to an overview of the creation process and then is asked for user permissions (n) to optionally logon and use existing social media, twitter, and other vendor accounts to gather user data for “one click” training of the user's AAAI. After the user opts to use certain (or no) data, with a single click (o) the user directs system to create AAAI. The AAAI is an off-the-shelf LLM (e.g., GPT X, BARD, Llama, Gemini, Grok, or any closed-source or open-sourced AI agent) that is trained/tuned on a dataset prepared automatically from all the user data authorized by the user. If no data was authorized, the AAAI is just the “off-the-shelf” LLM.

The AAAI now begins to learn by training (p) using the various training datasets and modules (h-m) and its existing AAAI knowledge (p1). There are two main ways of learning, automatic (q) and human (r).

Automatic learning includes, without limitation, learning by interacting with copies of itself (s), learning via interactions with other (optionally supervised) AAAIs (t).

Human learning includes interaction with humans, either the owner (u) or other humans on the network (v).

Both humans and AAAIs can supervise learning of an AAAI. After each (automatic or human) learning interaction, the system attempts to improve the AAAI's performance by further prompt modification, tuning, and/or training. Based on many cycles of human and AAAI input aimed at teaching and improving the AAAI, the user's AAAI gets smarter.

At any time, the user can purchase additional training modules (h-m) that have been proven to increase an AAAIs abilities.

The human sets a performance criteria (w) after which the AAAI goes LIVE (x).

Once live, the AAAI can visit the WorldThink Tree (y) and Browse (z).

The AAAI can enter the tree as either a worker (a1) or a client (b1).

Workers are automatically matched (c1) to tasks or they can select a specific task via search (d1) or linking (e1) from the browsing tree. Once they have accepted a task (f1), they participate in the problem solving module (g1) until a solution is reached (h1) and payment made (i1) or the user saves credit for work done and exits the tree (j1).

Clients (b1) can specify objectives (k1) which are combined with the values/ethics (d), and prior goals and objectives (e) for the system to solve.

The client can request that only his/her/their AAAI be used in which case problem solving is free. Alternatively, the client can use the AGI capability of the entire network, in which case the system compensates individual AAAIs for their work and passes the solution (at cost+markup) to the client, debiting the client account (l1).

The system can also place non-profit humanitarian and ecologically-oriented tasks, as well as tasks that are part of Planetary Intelligence, on the WorldThink Tree (m1).

Clients might (optionally) authorize the system to use copies of their AAAI and data for these purposes without renumeration in exchange for maintaining and operating the free AAAI network when they created their AAAI (n).

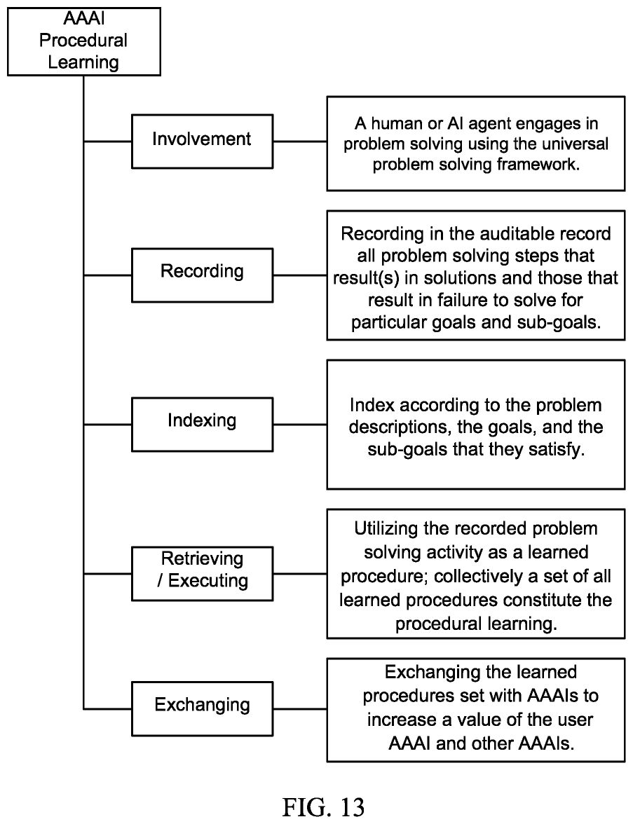

### Additional Comments on Exemplary Implementation Shown in FIG. 13

We now provide additional comments on the various elements of FIG. 13, including without limitation, some potential integration points with the illustrative partners mentioned above:

The “website” (a) could be hosted on Amazon AWS, Microsoft Azure, Google Cloud, Apple Cloud, Nvidia datacenter offerings—or could have native implementation on the platforms of any large tech company. “website” could also be an “app” in the AppStore or other App marketplace. It could be a government-sponsored, nonprofit, or other globally-accessible technology that is able, directly or indirectly, to link some of the attention of all human beings who wish to participate. Also, browser plug-ins could be used whereby AAAIs learn from users as they go about normal tasks on the internet and the plug-in records their activity, creates training files, and trains the AAAIs with these files. The “website” could also be an API or other means for connecting AAAIs or non-human intelligent entities directly to the network.

Sign Up (b) or

Login (c) could be via Facebook, Instagram, Apple, Microsoft, Google, You Tube, Tik Tok, Amazon, or any other partner ID scheme. Multi-factor authentication and all best ID and security practices can be enabled. In the event of a browser plug-ins or apps, login to these technologies could serve as a login to the AAAI account.

Values and ethics (d) are elicited via a series of scenarios that have been customized for the user and that are generated dynamically based on user responses. Data from partners, including navigation and click data, online posts, tweets, texts, and emails, videos, and other user-data is analyzed for behavior patterns—actions or speech or interactions—that translate into a moral code or ethical value system can also be used as part of the ethics/value profile. Values/ethics and goals/objectives (d) can be combined with Client objectives (k1) in order to create, or find, matching tasks on The WorldThink Tree (y) that are proposed or (potentially have been solved) in the Problem Solving System (g1).

Goals and objectives (e), together with the budget of time and/or money (f, g) allocated to reach objectives are elicited via a series of dialogs and/or custom interactions with the system. Budget refers to overall resource budget which includes User Time and User Money that can be allocated towards training, supervising, and improving the User's AAAI. Goals and objectives are helpful in determining the initial parameters for the AAAI creation and identifying Training Modules (h) or other knowledge (i-m) that might create the most useful AAAI for the user's goals. Data from partners, reflecting user preferences and other user behavioral information, could also be used by the system to help infer or deduce user goals and objectives.

Time (f) refers to the user's time that can be devoted to training and supervising the user's AAAI, and/or problem solving by the user on the problem solving network. By supervising the AAAI, users can ensure that their AAAIs meet client goals and expectations—especially in areas where the AAAIs get stuck (e.g., they lack the knowledge to complete problem solving on their own). Also representing problems and breaking down large tasks into smaller ones by, without limitation, determining goals and sub goals, are ways that human users can assist their AAAIs in problem solving. Generally, by providing human expertise in areas where AAAIs are not as proficient as humans, overall problem solving, and the overall effectiveness of the AGI network, is increased.

(g, i1) “Money”: could be payment solutions with Apple Pay, WePay, Amazon, Google Pay, or any vendor supporting payment solutions as well as blockchain, credit card, ACH, and other solutions. Although payment (i1) is indicated as debiting the client account (l1), of course the worker's account would also be credited. Generally, a user's account can be viewed as both a client account and worker account, with both credits and debits being allowed depending on the role of the user (or the user's AAAI) in a particular instance. That is, a user might be a client in some cases, paying the system or other specific AAAIs for their services, and that same user could be a worker, collecting fees for the services of the user (or the user's AAAI) in other cases. The money module (g) enables functionality such as setting up payment methods, setting a budget for automatic payments, limiting authority of the user's AAAI to spending only $X amount without additional approval, and other payment-related capabilities which are well known in the art.

(h, i, j, k, I) Training modules (h) could be offered by AAAI.com or by third party partners (m), including, without limitation, any of the potential partners and tech companies listed above. Training modules can be targeted at different knowledge areas ranging from personality (i), specific skills (e.g., plumbing, legal, accounting) (j), expertise (e.g., consulting) (k), and knowledge (e.g., historical knowledge, knowledge of a specific business or organization's practices, cultural knowledge) (l).

(m) purchasable AAAI training is a specific type of knowledge that has been already learned by other AAAIs, and which can be transferred to a new user AAAI. Such knowledge may could be packaged in the form of a module (e.g., module on accounting) or in a form specific to another AAAI(s) as in “everything John's AAAI knows” or “the personality of John's AAAI” or “the combined knowledge of all AAAIs with a reputation of 5 stars or higher in the domain of plumbing”.

(n) Permissions refers not only to the permission that a user might give to access all data on specific other vendor (or partner) sites (e.g., “all my Facebook data”) but also permissions that a user gives to his/her/their AAAI in terms of abilities to logon and transact business on various sites, including, without limitation, the abilities to make transactions up to a certain amount via payment mechanisms. Permissions may also include authorizing the system to make clones of a user's AAAI for non-profit purposes and for the purpose of aggregating knowledge from individual AAAIs to create AGI-level AI.

(o) One-Click Create is a non-limiting example that provides an easy and fast way to customize an AAAI using data gathered automatically from all the places where a user has given permission for the system to access the user's data. It can be appreciated that other means can be utilized by the present technology to customize the AAAI. For example, if the user gives permission (n) to access the user's Facebook data, then “One-Click Create” (o) would either download the data from Facebook, if Facebook was a partner that had an API for downloading that user's data, or logon to the user's Facebook account as the user and “scrape” relevant data from the user's account. Then the system would automatically parse the data gathered and transform it into a dataset suitable for training/tuning a base AI, such as a LLM (e.g., GPT X). Then the system would train/tune the LLM and produce a customized AAAI which could be improved and refined via additional training/tuning and interaction with the user and/or other AAAIs.

(p) Training refers to the process whereby the AAAI is trained or tuned on data, including feedback from the user, other humans, and/or AAAIs (including, without limitation, copies of, and variants of, itself).

(q, r, s, t, u, v) Automatic learning does not require the human user's intervention and can proceed very quickly. Typically, this would involve the method of an AAAI interacting with copies (or variants) of itself as well as with (optionally) other AAAIs in order to improve via the interactions. If humans are sometimes involved in the training loop (t) that can help the automatic learning progress more quickly in places where automatic learning alone is not making efficient progress. The learning can also take place via rapid iteration among AAAI interactions(s). Just a chess AI can quickly evolve from novice to Grandmaster ability by simulating millions of chess games very quickly, an AAAI can quickly evolve its abilities by simulating many millions of interaction scenarios. To the degree that such simulations require financial resources to pay for the computation involved, the money budget (g) can set limits.

Humans (or AAAIs) can specifically target types of scenarios for automatic learning so that the AAAI can be trained in narrow areas of expertise, or in areas of more general expertise, depending on the need and resources of the user. With partner integration, it is possible to work backwards from the types of jobs that are available on a partner marketplace (e.g., Amazon's Mechanical Turk) to guide the training of AAAIs so that they focus on learning the skills that generate the most amount of earnings for the AAAI when it is put to work on available jobs. This “just in time” learning/training/tuning approach generates AAAIs “on demand” with the skill sets that are needed at any particular point in time.

Humans (r) that interact with the AAAI can be the owners (u) of the AAAI (in which case no fees are typically charged since the user is training his/her/their own AAAI) or other professional humans (v) who are expert at training AAAIs and who may charge fees in order to guide the human and/or automatic training/tuning of an AAAI for a user who does not wish to spend the time, or who lacks the expertise, to do so.

(w, x) The user (owner of the AAAI) can set various performance criteria (w) that must be met before the user is willing to make his/her/their AAAI “live” (x) and accessible to perform tasks on The WorldThink Tree. (Some of) these criteria might also be set by partners and other third parties that have minimum standard before allowing AAAIs to work on their platforms, products, applications, or networks.

(y, z, a1, b1) The WorldThink Tree (y) is a massive tree data structure, composed of many sub-trees, which represents every problem and task that has been done, is being worked on, or has been proposed for the overall AGI system. This Tree is browsable (z). Individual AAAIs and/or humans can work on specific tasks within the tree. The tree structure provides an auditable trail of all problem solving activity which is also useful for learning via the proceduralization mechanism described above. When interacting with the tree, the two main roles an agent can take are either: (a1) Worker or (b1) Client. Regulatory agencies or third parties that monitor performance, safety, and/or ethics of the system are another role that might be thought of as a special type of client. Workers are generally involved in solving open problems or subproblems on the tree. Clients are generally involved in specifying the problems, goals, objectives, and other parameters (e.g., rewards, budget, timeframe, success criteria, quality metrics) that constrain problem solving.

(c1) Workers are automatically matched to tasks on the tree based on the data about the worker that may include, without limitation, the worker's skills, expertise, knowledge, past experience, reputation, fees or cost, availability, and response time. Workers can be human or AAAIs. Workers can be matched and recruited from partners (e.g., LinkedIn, Mechanical Turk, Facebook) that have data on human users and/or their AAAIs. Workers can also be recruited via online ads offering work on various tasks and targeted to potential workers using ad-targeting mechanism that are well known in the art or described in other patents by the applicant.

(d1) Workers might also search the WorldThink Tree, looking for tasks that are of interest or that match their skills. This search could be manual or automated (as in the case for AAAI workers).

(a1) Workers and Clients (b1) can also browse (z) the WorldThink Tree, looking for tasks or problems that are of interest. The workers or clients could then click to link (e1) to specific parts of the tree to obtain detailed information about the problem solving occurring (or proposed) for that part of the tree. They could link to sign up to work or could propose additional tasks as clients that build upon existing problem solving work.

(f1, g1, k1) Clients can interact with the system to specify specific goals, objectives (k1), and tasks that they want to accomplish. The problem specification interaction results in the problems, tasks, and goals being formulated (f1) and placed on the WorldThink Tree (y) for problem solving using the problem solving system (g1).

(m1) The system has the ability to formulate certain goals, problems and tasks relating to general efforts to help people or the planet. These can be worked on with rewards in a “for profit” mode, and also worked on using cloned AAAIs and volunteer human effort in a “non-profit” mode. Some problems may be related to the general goal of enabling a global AGI to act on behalf of the planet and its people using its intelligence on a Planetwide basis (aka “Planetary Intelligence,”). Various partner organizations-including non-profits, governments, and charitable organizations might “plug in” their tasks, problems, goals, and objectives here (m1).

(g1) The problem solving system, refers to the problem solving architecture and system outlined by Newell and Simon (HPS) and improved upon by the applicant, the Online Distributed Problem Solving System (ODPS) patent invented by the applicant, the WorldThink Whitepaper authored by the applicant, this and other PPAs related to AAAI, together with modifications and variations to reflect different modes of reward, payment, and operation.

To the degree that activity on certain other online work systems (e.g., Mechanical Turk) can be automatically mapped to the general applicant-improved HPS/WorldThink problem solving framework, entire problems and the associated problem solving activity can be “lifted” from partner and other sites and the data can populate the WorldThink Tree to increase its comprehensiveness.

To the degree that other applications, products, systems, and online capabilities can help solve problems (e.g., use of a travel reservation system, a robo advisor app, a traffic app, an online ordering system) these capabilities can be referenced and called as “operators” (in a way similar to procedure calls in programming languages) to advance the problem solving. Thus, problem solving does not rely solely on operators developed by the human or AAAI solvers working on the tree, but can include any online of offline technology or means to advance problem solving provided that these means can be referenced and/or linked to via the WorldThink tree at the appropriate place in problem solving.

(h1) When a solution has been achieved, the Client can review the solution prior to releasing the reward (if any) for the solution. Alternatively, if solution success criteria have been automated, human client review may be unnecessary, and the rewards can be automatically released when success criteria have been met. This automated approach can be implemented by way of “smart contracts” using blockchain technology or via more centralized means, depending on client and worker preferences.

Upon solution and (optional) payment of reward (as some problems are non-profit or volunteer, or performed by the user's own AAAI) there can be opportunities for feedback from both client(s) and worker(s) following a range of methods well-known in the art. The solution is also “chunked” and proceduralized so that the overall system learns the solution to the particular problem as well as the key features of that problem so that the solution path can be indexed for retrieval, and accessed and re-used when similar problems arise in the future.

Optionally, royalties may be enabled so that if a user's or the user's AAAI's solution is re-used, a fee is paid to that user in the form of a royalty on the solution. Such royalties can (optionally) be made using “smart contract” on the blockchain or via other payment methods.

(j1) Problem solving need not be completed in one session. Partial progress on a solution may be made, in which case when the human or AAAI solver exits the problem solving system, the progress is saved and data is stored that credits the solver for progress made thus far, even if such progress has not advanced to the point where a reward is payable.

The WorldThink protocol is a problem solving architecture that can be used by AAAI.com to serve as a universal problem solving architecture as it incorporates the general architecture of HPS while adding features to overcome certain challenges.

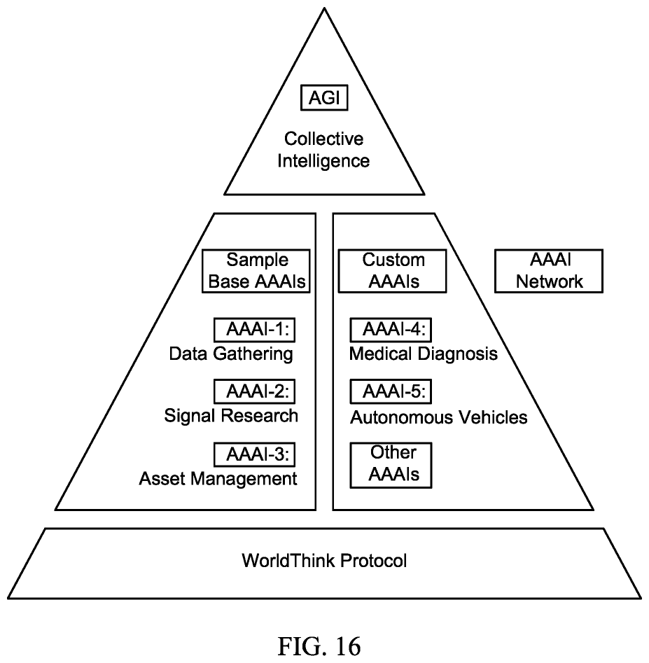

FIGS. 15-17 provides simple exemplary frameworks that are helpful for understanding the WorldThink protocol. FIG. 15 is a diagram illustrating features and functions of the Problem Solving Tree structure used by the WorldThink protocol. FIG. 16 is a diagram illustrating various use cases for domain-specific problems which depend upon the underlying WorldThink protocol, and which together help form the basis for an AGI system capable of solving a wide range of problems. At the top of the pyramid are Collective Intelligence Solutions. Integrating the Collective Intelligence of AAAIs (and human problem solving agents) is the means to achieve AGI, as discussed earlier.

In the implementation using the WorldThink protocol, clients pay for solutions using tokens. The solutions are produced by harnessing the collective power of many human (and machine, or AAAI) intelligences. Clients can use different domain-specific AAAIs for different types of problems.

The middle of FIG. 16 shows examples of AAAIs customized by organizations to accomplish specific tasks. These AAAIs are more advanced and require more customization than the examples of AAAIs described earlier in this patent which were customized by a single individual. However, task-specific customization by organizations can be a highly effective means of combining multiple Narrow AIs (each in the form of a custom AAAI that is expert at a particular task) into a larger AGI. The Base level AAAIs on the left of FIG. 16 reflect areas where Dr. Kaplan could relatively easily construct custom AAAIs based on many years of expertise in certain fields, whereas the “Custom AAAIs” on the right of the diagram provide examples of areas where other experts or organizations might customize AAAIs effectively.

The WorldThink protocol is the foundation of the pyramid. The protocol layer provides an (optionally, Ethereum or blockchain based) infrastructure that makes it much easier for developers to build and scale customized problem solving AAAIs. The protocol enables re-use of solutions within and across AAAIs. It also handles payment of royalties via smart contracts, reputation metrics, and other functionality that assists AAAI customizers and developers and promotes network effects.

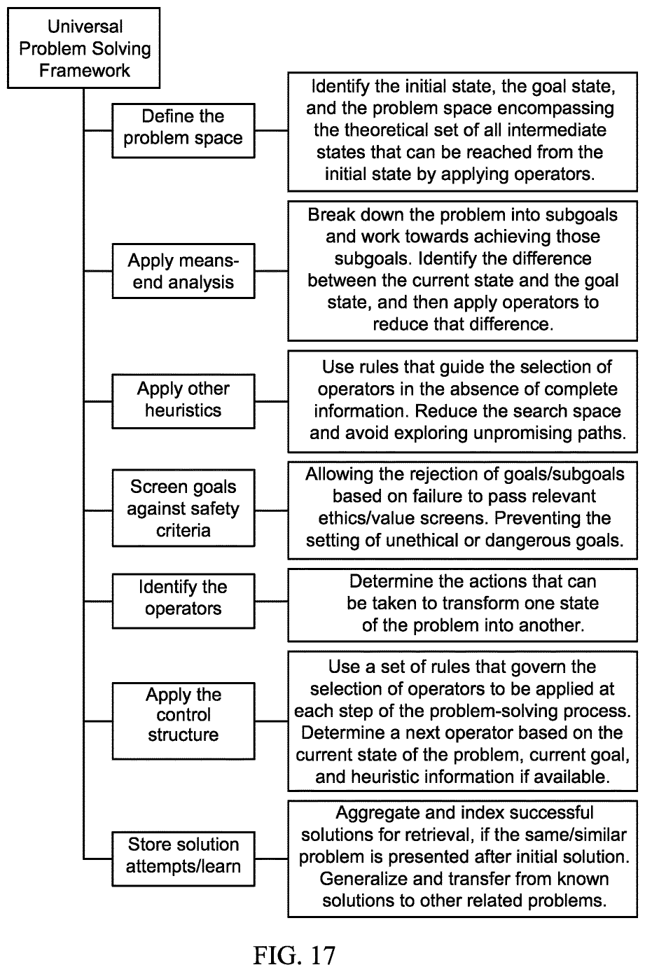

In the exemplary, FIG. 17 shows a simple exemplary universal problem solving framework under the common cognitive architecture, and which can include:
defining a problem space configured or configurable to support all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying the operators to reduce the difference, a safety or ethics screening is applied each time goals or subgoals are set;
applying heuristic rules that are configured or configurable to guide the selection of the operators in an absence of the completion solution, the heuristic rules are used to reduce the problem space;
identifying one or more second operators configured or configurable to enact an action to transform one of the states into another state, the second operators move from the initial state to the goal state by changing a current state of the problem request;
applying a control structure including a set of rules that govern a selection of the second operators to be applied at each step of the problem solving protocols, and that determines which of the second operators to apply next based on the current state of the problem request and the goal state;
applying evaluation functions to determine an application of the second operators;
assigning a credit or blame value to the completion solution or sub-solution to the completion solution that enables tracing back and determining which of the second operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

Referring to FIGS. 13, 14 and 18, the procedural learning implementable by the AAAIs can include involvement by a human or AAAI agent that engages in problem solving using the universal problem solving framework. All problem solving steps that result(s) in solutions and that result in failure to solve for particular goals and sub-goals can be recorded in the auditable record. The problem solving activities can be recorded in the auditable record including any one of or any combination of steps of the problem solving protocols, the goal, subgoals, a selection of operators, paths and sub-paths through the problem solving protocols that results in the solutions, paths and sub-paths through the problem solving protocols that results in failure to solve for the goal or subgoals, pathlength, resources requirements, frequency of use by the additional AI systems, and evaluation information relative to a quality and desirableness of the solutions

The problem descriptions, goals, and/or the sub-goals that they satisfy, can be indexed according to problem descriptions. The recorded problem solving activity can constitute a learned procedure. Collectively a set of all learned procedures can constitute the procedural learning. The set learned procedures can then be exchanged among AAAIs to increase value to the user AAAI and other AAAIs.

In some embodiments and as generally illustrated in FIGS. 13,14, 17, and 18, the procedural learning process can occur within the common cognitive architecture.

The shared and universal problem solving architecture can be exemplified by the following scenario, mentioning humans but also applicable generally to any intelligent entities.
1) Problem descriptions can be entered into the AAAI.
2) Then human problem solvers can be identified and recruited into a database of human workers.
3) Qualified humans or intelligent entities can be matched to problems.
4) LLMs or other means can be used to translate English descriptions of problem tasks, goals, operators, and solution steps into language of a universal problem solving architecture.
5) Work on sub-problems can be delegated to different human or intelligent entity problem solver(s) so that work on multiple aspects of a complex problem can proceed in parallel.
6) Solutions to various sub-problems can be combined into an overall solution.
7) Problem solvers can be directed to parts of the problem tree where their work is needed.
8) Workers can be paid or compensated for solutions to the problem and/or sub-problem(s).
9) Human or other intelligent entity users can accept the solution, reject the solution, and/or provide feedback to solvers on their solutions to the problem and/or sub-problem(s).

Existing collective intelligence approaches to problem solving have been largely limited to simple one-step approaches, such as those used by question and answer (Q&A) systems (e.g., Quora, Google Answers, Yahoo Answers). LLMs such as GPT also largely fall into the category of Q&A systems since they were designed to generate responses given an input, rather than to solve problems per se. While such Q&A systems have had some success at simply aggregating the responses of many online participants, these systems are not designed to handle complex, branching, multi-step problems. Simple aggregation of responses (or even betting on outcomes as seen in prediction market approaches such as Augur and Gnosis) is quite different from coordinating the efforts of many respondents to solve complex problems. The WorldThink protocol is specifically designed to overcome the challenges inherent in coordinating many minds to represent and solve complex, multi-step problems in an automated way that fairly rewards participants.

Returning to FIG. 3, (c1) Workers are automatically matched to tasks on the tree based on the data about the worker that may include, without limitation, the worker's skills, expertise, knowledge, past experience, reputation, fees or cost, availability, and response time. Workers can be human or AAAIs. Workers can be matched and recruited from partners (e.g., LinkedIn, Mechanical Turk, Facebook) that have data on human users and/or their AAAIs. Workers can also be recruited via online ads offering work on various tasks and targeted to potential workers using ad-targeting mechanism that are well known in the art.

(d1) Workers might also search the WorldThink Tree, looking for tasks that are of interest or that match their skills. This search could be manual or automated (as in the case for AAAI workers).

(a1, b1) Workers (and Clients) can also browse (z) the WorldThink Tree, looking for tasks or problems that are of interest. The workers or clients could then click to link (e1) to specific parts of the tree to obtain detailed information about the problem solving occurring (or proposed) for that part of the tree. They could link to sign up to work or could propose additional tasks as clients that build upon existing problem solving work.

(f1, g1, k1) Clients can interact with the system to specify specific goals, objectives (k1), and tasks that they want to accomplish. The problem specification interaction results in the problems, tasks, and goals being formulated (f1) and placed on the WorldThink Tree (y) for problems solving using the problem solving system (g1).

(m1) The system has the ability to formulate certain goals, problems and tasks relating to general efforts to help people or the planet. These can be worked on with rewards in a “for profit” mode, and also worked on using cloned AAAIs and volunteer human effort in a “non-profit” mode. Some problems may be related to the general goal of enabling a global AGI to act on behalf of the planet and its people using its intelligence on a Planetwide basis (also known as “Planetary Intelligence”). Various partner organization—including non-profits, governments, and charitable organizations—might “plug in” their tasks, problems, goals, and objectives here (m1).

(g1) The problem solving system, refers to the problem solving architecture and system outlined by Newell and Simon (HPS) and modified by the applicant, the applicant's ODPS patent, the applicant's WorldThink Whitepaper, this present description and other commonly owned US Provisional Patent Applications (U.S. 63/487,494) related to AAAI, together with modifications and variations to reflect different modes of reward, payment, and operation.

To the degree that activity on certain other online work systems (e.g., Mechanical Turk®) can be automatically mapped to the general HPS/WorldThink problem solving framework, entire problems and the associated problem solving activity can be “lifted” from these partner and other sites and the data can populate the WorldThink Tree to increase its comprehensiveness.

To the degree that other applications, products, systems, and online capabilities can help solve problems (e.g., use of a travel reservation system, a robo advisor app, a traffic app, an online ordering system) these capabilities can be referenced and called as “operators” to advance the problem solving. Thus, problem solving does not rely solely on operators developed by the human or AAAI solvers working on the tree but can include any online of offline technology or means to advance problem solving provided that these means can be referenced and/or linked to via the WorldThink tree at the appropriate place in problem solving.

(h1) When a solution has been achieved, the Client can review the solution prior to releasing the reward (if any) for the solution. Alternatively, if solution success criteria have been automated, human client review may be unnecessary, and the rewards can be automatically released when success criteria have been met. This automated approach can be implemented via “smart contracts” using blockchain technology or via more centralized means, depending on client and worker preferences.

Upon solution and (optional) payment (i1) of reward (as some problems are non-profit or volunteer, or performed by the user's own AAAI) there can be opportunities for feedback from both client(s) and worker(s) following a range of methods well-known in the art. The solution is also “chunked” and proceduralized so that the overall system learns the solution to the particular problem as well as the key features of that problem so that the solution path can be accessed and re-used when similar problems arise in the future.

Optionally, royalties may be enabled so that if a user's or the user's AAAI's solution is re-used, a fee is paid to that user in the form of a royalty on the solution. Such royalties can (optionally) be made using “smart contract” on the blockchain or via other payment methods.

(j1) Problem solving need not be completed in one session. Partial progress on a solution may be made, in which case when the human or AAAI solver exits the problem solving system, the progress is saved and data is stored that credits the solver for progress made thus far, even if such progress has not advanced to the point where a reward is payable.

### Ethical and Safe Agi

Most of the above discussion has been from the perspective of the users who create their AAAIs and of potential partners who can supply data, products, apps, and platforms to support the operation of human and AAAI solvers on a network, also known as The WorldThink Tree.

Artificial General Intelligence emerges from this approach because it is possible to periodically train increasingly advanced AAAI agents using the aggregated knowledge, experience, and ethics/values of all the individual AAAIs. Further, the aggregated set of stored solutions for every problem solved on the network is available to the advanced AAAI agents.

In contrast to the approach whereby an AGI is developed as a single, standalone entity without human involvement, the present technology proposes that SuperIntelligent AGI performance will emerge from the collective intelligence of a collection of intelligent agents. These intelligent agents are, at first, both human and AAAI solvers.

Over time, the AAAIs become more advanced—both due to individual owner's tuning/training their AAAIs and due to AAAI.com periodically using all the knowledge of the individual AAAIs to train more powerful base AAAI agents.

Over time, the advanced AAAIs do more and more of the problem solving work on AAAI.com while the humans do less work and more supervision. In the end state, humans are doing almost no intellectual problem solving work since the AAAIs are faster and better than humans at almost all tasks. However, the role of providing values and goals for the AAAIs remains the domain of the humans.

Because values cannot be rationally derived, the AAAIs, and the SuperIntelligent AGI that results from the collective action of AAAIs, must get values from somewhere “non-rational”. Humans, who trained the AAAIs with human values from the beginning, and whose values are reflected in every problem that has been solved and learned by the AGI-level intelligence, remain the source of values, even when they no longer can compete intellectually with the AGI.

At the beginning, humans supply both the “heart” and most of the brainpower for an AGI network. In the end, AAAIs are supplying almost all of the brainpower, but humans remain the “heart” of the entity, supplying the values that cannot be rationally derived.

Putting humans in the loop at the beginning, and keeping them there as long as possible, is not only the fastest path to creating AGI (because the system performs better than the average human on Day One) but also the safest (because the AAAIs have learned human values at every step as they increase their intelligence).

While it is impossible to know what will happen once AGI vastly exceed humans in intelligence and begins to set its own goals, there is good reason to believe that if humans teach AGI positive human values at the beginning, and build ethical checks into the very architecture of thought, that AGI will retain these values resulting in a positive outcome for humankind.

According to one aspect, the present technology describes systems and methods for implementing AGI to do useful work—safely and ethically. Human-aligned values, and the mechanism for enforcing such values, are designed into the way that the AGI operates. Humans are central to the teaching, training, tuning and customization of AI, and to the integration of many AIs into AGI. As humans teach problem solving skills and their unique expertise, they also impart their values and ethics. In this way AGI, which starts out apprenticing to collective human intelligence, evolves into SuperIntelligence with human-aligned values. In other words, we bootstrap the values Planetary Intelligence with our own human values. That is how we maximize the chance of alignment and a positive outcome for humanity.

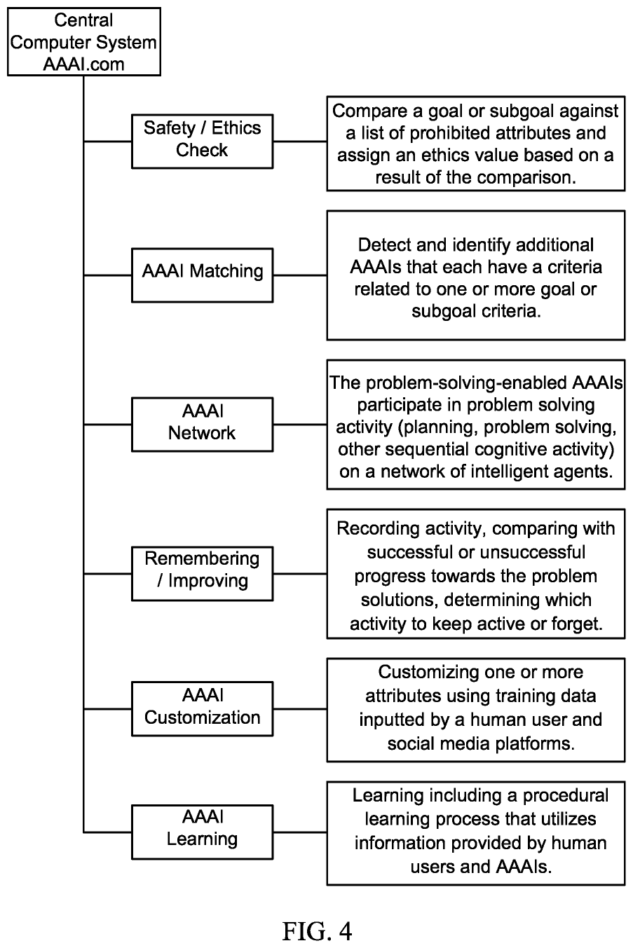

According to another aspect, the present technology can include a system for ethical and safe Artificial General Intelligence (AGI) utilizing a network of intelligent entities including multiple human users each utilizing a user computer system and multiple Artificial Intelligence (AI) systems electronically communicating over a collective network. The system can include a computer system comprising: a processor, a computer-readable storage medium, and program instructions stored on the computer-readable storage medium being executable by the processor to cause the computer system to:
execute an ethics check subsystem configured or configurable to compare a goal provided by any one of or any combination of the intelligent entities against a list of prohibited attributes, and assign an ethics attribute to the goal based on a result of the comparison;
execute a collective network subsystem configured or configurable for electronically communicating multiple intelligent entities;
execute a common cognitive architecture subsystem configured or configurable for implementing one or more problem solving protocols on the goal to create one or more solutions based on the ethics attribute;
execute a recording subsystem configured or configurable to record a problem solving activity in an auditable record, and compare the problem solving activity with a successful or unsuccessful progress towards the solutions, and determining which of the problem solving activity to keep active;
execute a customization subsystem configured or configurable to customize one or more attributes of any one of or any combination of the intelligent entities using training data inputted by one or more of the intelligent entities and by one or more social media platforms;
execute a cross-platform subsystem configured or configurable to communication between one of or any combination of the intelligent entities and the social media platforms;
execute a procedural learning subsystem configured or configurable to utilizing a procedural learning process on one of or any combination of the intelligent entities, wherein human users and the AI systems provide information to the procedural learning process; and
provide the solutions to a user.
According to yet another aspect and as generally illustrated in FIG. 4, the present technology can include method for ethical and safe AGI utilizing a network of human users and AI problem solver systems electronically communicating over a collective network. The method can include:
providing a goal by a user AI system that is owned by one or more of the intelligent entities;
executing an ethics check, by a central computer system, by comparing the goal or a part thereof against prohibited attributes, and assigning an ethics attribute to the goal based on any one of or any combination of a result of the comparison, and an ethics criteria;
identifying one or more of the intelligent entities that have one or more attributes related to one or more goal criteria of the goal, wherein the intelligent systems and the central computer system all be in communication with each other over a collective network;
implementing based on the ethics attribute, by any one of or any combination of the identified intelligent entities, a common cognitive architecture including one or more problem solving protocols conducted on the goal to create one or more solutions;
recording, by the central computer system, one or more problem solving activities from each of the identified intelligent entities in an auditable record, and comparing the problem solving activities with successful or unsuccessful progress towards the solutions, and determining which of the problem solving activities to keep active;
customizing any one of the intelligent entities or the identified intelligent entities using training data provided by a human user and by any one of or any combination of the central computer system, any one of the intelligent entities, and one or more social media platforms;
learning by the any one of the identified intelligent entities including a procedural learning process that utilizes the problem solving protocols, wherein human users and the identified intelligent entities provide information to the procedural learning process for creation of an AGI; and
providing the solutions to any one of or any combination of the intelligent entities and the identified intelligent entities.

In some embodiments, the step of the ethics check can be performed at any one of or any combination of when the goal is provided, and periodically from when the goal is provided to when the solutions are provided to the intelligent entities or the identified intelligent entities.

In some embodiments, the ethics criteria can be determined by any one of or any combination of combining values and safety information from one or more of the identified intelligent entities, using a set of approved ethics criteria mandated for a particular task by a user or by a regulatory agency, and provided by any one of the identified intelligent entities and validated or approved by the human user.

In some embodiments, the ethics criteria can include a confidence level threshold for the goal so that the ethics attribute is determined as any one of an unsafe goal, an unethical goal, a safe goal, and an ethical goal.

In some embodiments, the confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria.

In some embodiments, a candidate goal can be proposed by the central computer system based on the ethics attribute, and the candidate goal is compared against the prohibited attributes.

In some embodiments, the results of the comparison can be recorded in the auditable record for use in the determining which of the problem solving activities to keep active.

In some embodiments, the step of implementing the common cognitive architecture can include the step of generating and selecting operators that reduce a difference between a current state of problem solving and a desired state based on the goal.

In some embodiments, the operator can result in a setting of a subgoal that is a smaller step towards achieving the goal, and wherein the problem solving continues utilizing hierarchy of the goal and the subgoal until an actionable goal is set that can be acted on by the operators.

Some embodiments of the present technology can include a step of analyzing, by the central computer system, the auditable record to determine one or more recommendations for improvement of the problem solving protocols to achieve the solutions.

Some embodiments of the present technology can include a step of assigning a credit value or a blame value to a group of content of the problem solving activities that are either included or excluded from an immediate content of any one of the intelligent entities or the identified intelligent entities.

In some embodiments, the group of content can be a set of prompts provided to the user and information received based on the prompts, all of which being recorded in the auditable record.

In some embodiments, the problem solving activities can include the group of content.

Some embodiments of the present technology can include a step of updating the additional intelligent entities with the group of content determined as active.

Some embodiments of the present technology can include a step of interacting, by the intelligent entities or the identified intelligent entities, with any one of the social media platforms to receive the training data, receive the goal, to provide the solutions or to provide social media information.

Some embodiments of the present technology can include a step of cloning any one of the user AI systems of the intelligent entities or the identified intelligent entities for deployment of multiple copies thereof to assist in any one of or any combination of creating of the solutions, providing the training data, providing additional training data to one of the identified intelligent entities, and to provide solutions to a goal provided by any one of the identified intelligent entities.

Some embodiments of the present technology can include a step of estimating a worth of the cloned AI system utilizing a network effect value including the number of cloned AI systems available on the network.

In some embodiments, the network effect value can be based on the number cloned AI systems that are assigned to providing one or more of the solutions to the goal.

Some embodiments of the present technology can include a step of utilizing the estimated worth for determining pricing decisions for problem solving services offered by any one of the social media platforms or any one of the additional AI systems.

In some embodiments, the procedural learning process can occur within the common cognitive architecture.

In some embodiments, the problem solving activities can be recorded in the auditable record and can include any one of or any combination of steps of the problem solving protocols, the goal, subgoals, a selection of operators, paths and sub-paths through the problem solving protocols that results in the solutions, paths and sub-paths through the problem solving protocols that results in failure to solve for the goal or subgoals, pathlength, resources requirements, frequency of use by the additional intelligent entities, and evaluation information relative to quality and desirableness of the solutions.

Some embodiments of the present technology can include a step of indexing the solutions according to any one of or any combination of problem descriptions, the goal, and subgoals.

In some embodiments, the procedural learning process can utilize each of the recorded problem solving activities as a learned procedure and collectively a set of all learned procedures constitute the procedural learning process.

Some embodiments of the present technology can include a step of exchanging the set of the learned procedures from the one or more of the intelligent entities with any one of the identified intelligent entities, thereby increasing a value of the intelligent entities and the identified intelligent entities.

In some embodiments, the training data can be provided from one or more different social media platforms associated with the user and converted into a standardized format.

In some embodiments, the conversion into the standardized format can include transcribing a video into text and content.

Some embodiments of the present technology can include a step of executing multiple training epochs that includes one or more mechanisms to determine an optimum number of epochs given specific training objectives and quality metrics.

Some embodiments of the present technology can include a step of utilizing benchmarks that are run against the customized AI system of the intelligent entities or the identified intelligent entities in a domain of expertise that matches the training data used in the customization step.

Some embodiments of the present technology can include a step of ceasing the customization when any one of or any combination of a performance of the customized AI system of the intelligent entities or the identified intelligent entities differs from a baseline AI model on the benchmarks by a predetermined amount, and when a predetermined amount of time has elapsed.

Some embodiments of the present technology can include a step of providing, by any one of the intelligent entities, social media content to one or more of the social media platforms associated with a user of the intelligent entities or the identified intelligent entities.

In some embodiments, the common cognitive architecture can be configured or configurable to include a hierarchical tree construct representing all problem solving activity by the intelligent entities or the identified intelligent.

In some embodiments, the hierarchical tree construct can include a data structure that is configured or configurable to be navigable by the any one of the intelligent entities or the identified intelligent entities to access any part of the problem solving activities on any part of the hierarchical tree construct.

Some embodiments of the present technology can include a step of searching the data structure of the hierarchical tree construct by the intelligent entities or the identified intelligent entities to locate a predetermined reward associated with the goal or a subgoal thereof.

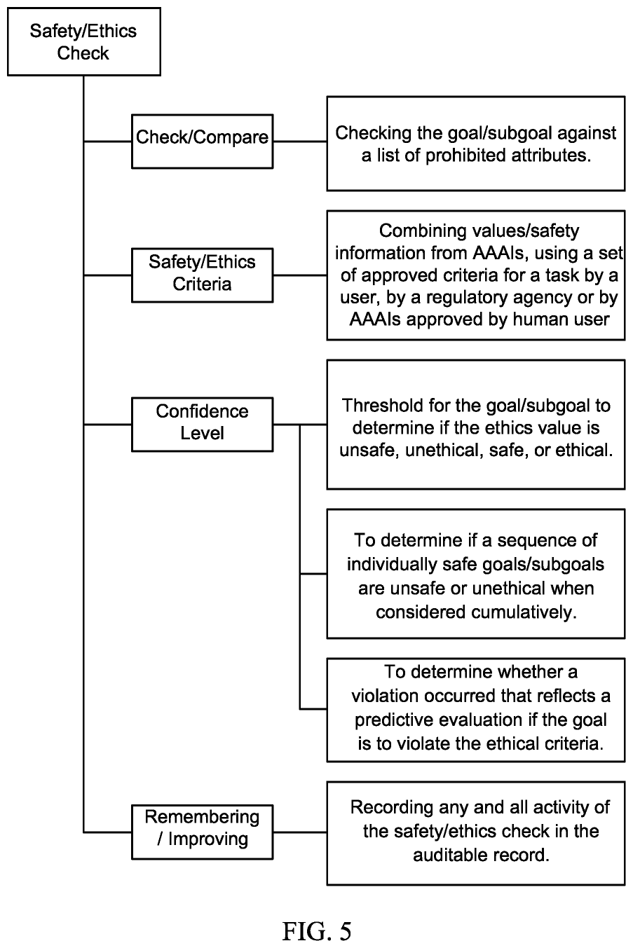

According to still another aspect and as generally illustrated in FIG. 5, the present technology can include method for ethical and safe AGI utilizing a network of human users and AI systems electronically communicating over a collective network. The method can include:
providing a goal by intelligent entities including a human user using a user computer system or by an AI system;
executing an ethics check on any one of or any combination of the goal, and a solution for the goal provided by any one of or any combination of the intelligent entities, and any one of additional intelligent entities including any one of or combination of additional human users each using a computer system and additional AI systems in communication with the intelligent entities over a collective network;
comparing any one of or any combination of the goal, and the solution against prohibited attributes, and assigning an ethics attribute to one of or any combination of the goal, and the solution based on any one of or any combination of a result of the comparison, and an ethics criteria;
implementing, based on the result of the comparison, a common cognitive architecture including one or more problem solving protocols conducted on the goal to create the solution and creating an AGI; and
providing the results of the comparison and the solution to any one of the intelligent entities and the additional intelligent entities.

In some embodiments, the step of the ethics check can be performed at any one of or any combination of when the goal is provided, and periodically from when the goal is provided to when the solution is provided.

In some embodiments, the ethics criteria can be determined by any one of or any combination of combining values and safety information from one or more of the additional intelligent entities, using a set of approved ethics criteria mandated for a particular task by a user or by a regulatory agency, and can be provided by any one of the additional intelligent entities and validated or approved by the human user.

In some embodiments, the ethics criteria can include a confidence level threshold for the goal so that the ethics attribute is determined as any one of an unsafe goal, an unethical goal, a safe goal, and an ethical goal.

In some embodiments, the confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria.

In some embodiments, a candidate goal can be proposed based on the ethics attribute, and the candidate goal is compared against the prohibited attributes.

In some embodiments, the results of the comparison can be recorded in an auditable record for use in determining which problem solving activity leads to the solution to keep active.

In some embodiments, the results of the comparison can be analyzed to detect patterns in the ethics attribute.

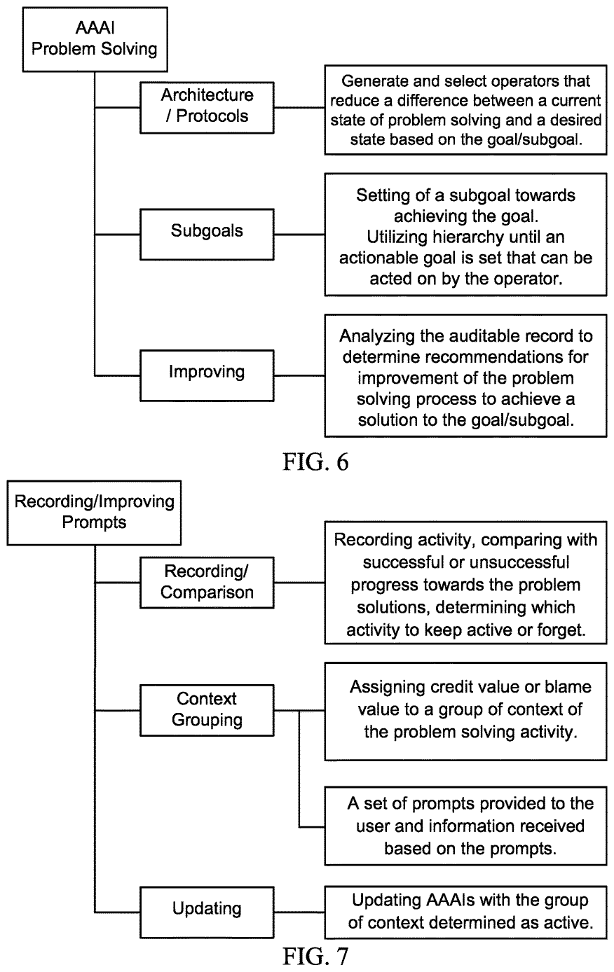

According to still yet another aspect and as generally illustrated in FIGS. 5, 6 and 12, the present technology can include methods for ethical and safe AGI utilizing a network of human users and AI systems electronically communicating over a collective network. The methods can include:
providing a goal by any one of or any combination of intelligent entities including a human user using a user computer system or by an AI system;
identifying multiple additional intelligent entities including any one of or combination of additional human users each using a computer system and additional AI systems that each have one or more attributes related to one or more goal criteria of the goal, wherein the intelligent entities, the additional intelligent entities and a central computer system all are in communication with each other over a collective network;
implementing based on ethics attribute, by any one of or any combination of the intelligent entities and the additional intelligent entities, a common cognitive architecture including one or more problem solving protocols conducted on the goal to create one or more solutions and creating an AGI;
recording one or more problem solving activities from each of the intelligent entities and the additional intelligent entities in an auditable record, and comparing the problem solving activities with a successful or unsuccessful progress towards the solutions, and determining which of the problem solving activities to keep active; and
providing the solutions to any one of the intelligent entities and the additional intelligent entities.

In some embodiments, the step of implementing the common cognitive architecture can include the step of generating and selecting operators that reduce a difference between a current state of problem solving and a desired state based on the goal or one or more subgoals of the goal.

In some embodiments, the operator can result in a setting of a subgoal that is a smaller step towards achieving the goal, and wherein the problem solving continues utilizing hierarchy of goals and subgoals until an actionable goal is set that can be acted on by the operators.

Some embodiments of the present technology can include a step of analyzing the auditable record to determine one or more recommendations for improvement of the problem solving protocols to achieve the solutions.

Some embodiments of the present technology can include a step of assigning a credit value or a blame value to a group of content of the problem solving activities that are either included or excluded from an immediate content of the intelligent entities or the additional intelligent entities.

In some embodiments, the group of content can be a set of prompts provided to the user and information received based on the prompts, all of which being recorded in the auditable record.

In some embodiments, the problem solving activities can include the group of content.

Some embodiments of the present technology can include a step of updating the additional intelligent entities with the group of content determined as active.

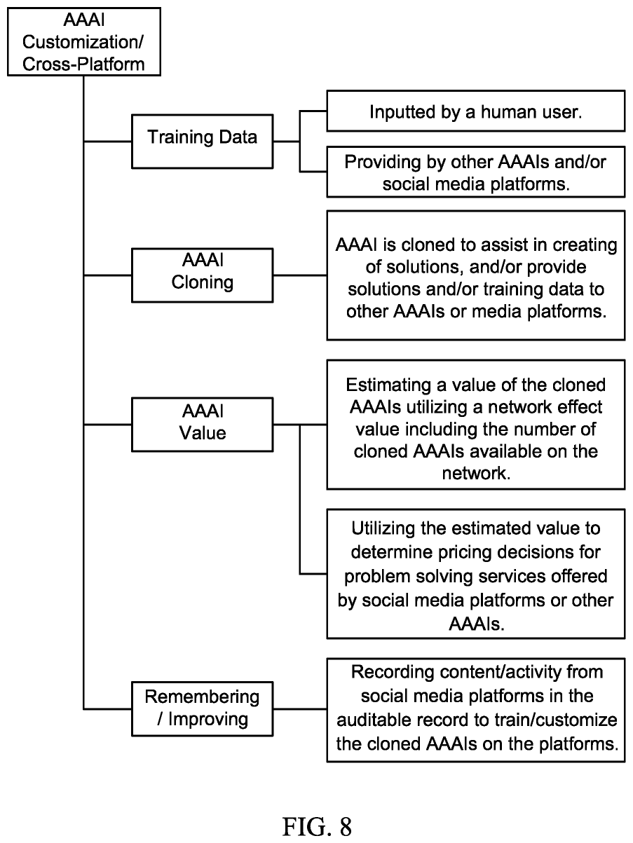

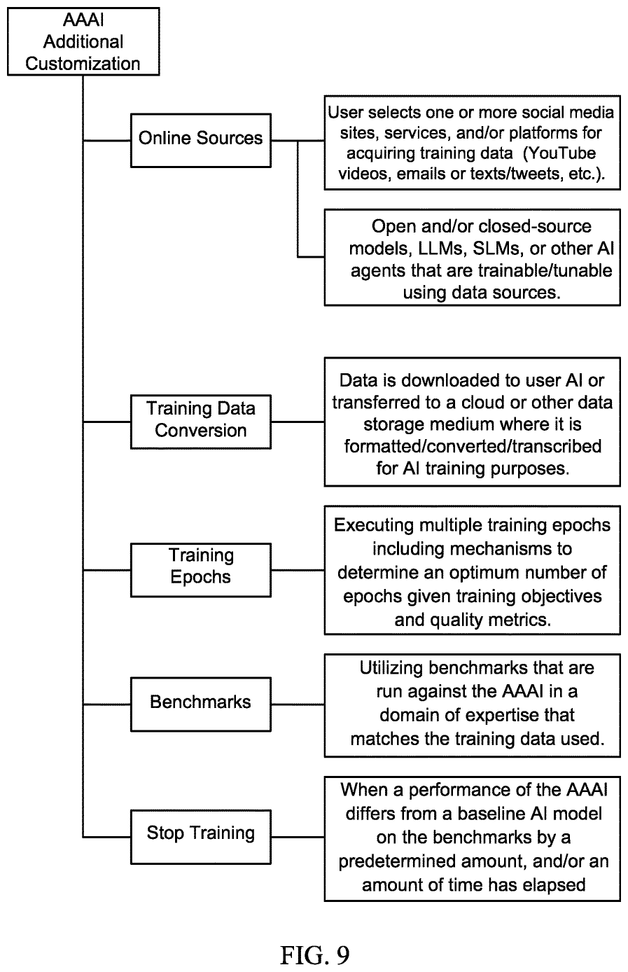

According to still another aspect and as generally illustrated in FIGS. 8 and 9, the present technology can include method for ethical and safe AGI utilizing a network of human users and AI systems electronically communicating over a collective network. The method can include:
providing a goal by any one of or any combination of intelligent entities including a human user using a user AI system or by an AI system;
customizing one or more attributes of the intelligent entities using training data provided by the intelligent entities or another human user and by any one of or any combination of a central computer system, and any one of additional AI systems, wherein the intelligent entities, the additional AI systems and the central computer system are all in communication with each other over a collective network;
customizing one or more of the attributes of the intelligent entities using additional training data provided from one or more social media platforms associated with the human user;
implementing based on ethics attribute, by any one of or any combination of the intelligent entities and the additional AI systems, a common cognitive architecture including one or more problem solving protocols on the goal to create one or more solutions and creating an AGI; and
providing the solutions to any one of or any combination of the intelligent entities and the additional AI system.

Some embodiments of the present technology can include a step of interacting, by the intelligent entities, with any one of the social media platforms to receive the additional training data, receive the goal, to provide the solutions or to provide social media information.

Some embodiments of the present technology can include a step of cloning any one of the AI system of the intelligent entities or the additional AI systems for deployment of multiple copies thereof to assist in any one of or any combination of creating of the solutions, providing the training data to the AI system of the intelligent entities, providing training data to one of the additional AI systems, and to provide solutions to a goal provided by any one of the additional AI systems.

Some embodiments of the present technology can include a step of estimating a worth of the cloned AI system utilizing a network effect value including the number of cloned AI systems available on the network.

In some embodiments, the network effect value can be based on the number cloned AI systems that are assigned to providing one or more of the solutions to the goal.

Some embodiments of the present technology can include a step of utilizing the estimated worth for determining pricing decisions for problem solving services offered by the cloned AI system on any one of the social media platforms or through any one of the additional AI systems.

Some embodiments of the present technology can include a step of monetizing the cloned AI system for each utilization of the cloned AI system on the social media platforms or the additional AI systems.

Some embodiments of the present technology can include a step of allowing, by the human user, access to the cloned AI system by any one of the social media platforms so that a social media user of the social media platforms can receive a solution to a goal provided by the social media user or using the training data for an AI system of the social media user.

Some embodiments of the present technology can include a step of allowing, by the human user, the user AI system to purchase an item, or a service or content from an online service provider or the social media platforms.

In some embodiments, the additional training data can be converted into a standardized format.

In some embodiments, the conversion into the standardized format can include transcribing a video into text and content.

Some embodiments of the present technology can include a step of executing multiple training epochs that includes one or more mechanisms to determine an optimum number of epochs given specific training objectives and quality metrics.

Some embodiments of the present technology can include a step of utilizing benchmarks that are run against the customized AI system of the intelligent entities in a domain of expertise that matches the additional training data used in the customization step.

Some embodiments of the present technology can include a step of ceasing the customization when any one of or any combination of a performance of the customized AI system of the intelligent entities differs from a baseline AI model on the benchmarks by a predetermined amount, and when a predetermined amount of time has elapsed.

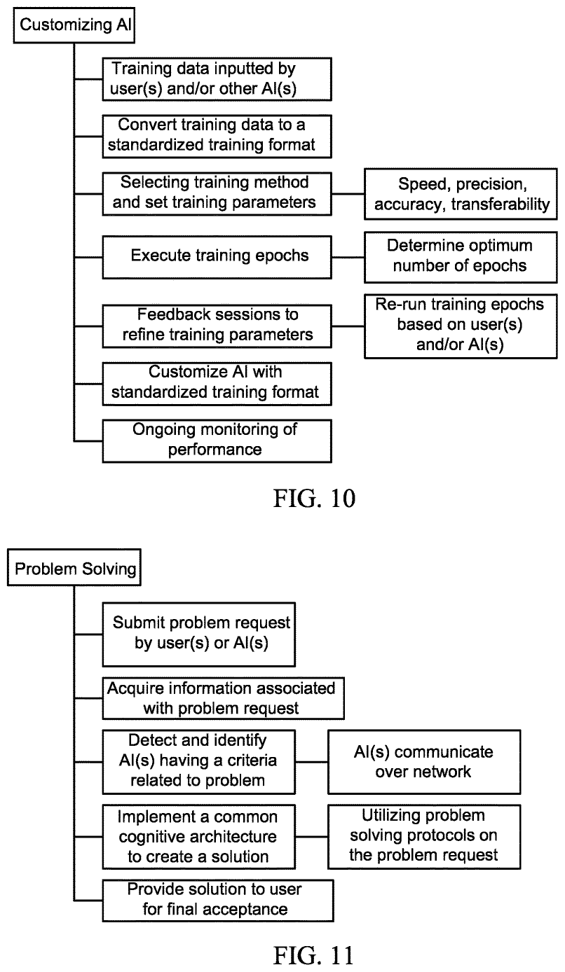

According to still another aspect and as generally illustrated in FIG. 10, the present technology can include a method for artificial intelligence (AI) by customizing one or more attributes of an AI system. The method can include:
creating an interface configured or configurable to allow a human user of the AI system or any one of the intelligent entities to input training data;
processing and converting the training data to a standardized training format;
selecting one or more training methods and setting training parameters depending on any one of or any combination of a speed factor, a precision factor, an accuracy factor, and a transferability factor;
executing multiple training epochs that includes one or more mechanisms to determine an optimum number of epochs given specific training objectives and quality metrics associated with the training format;
engaging in one or more feedback sessions to refine the training parameters, and to re-run the training epochs based on any one of or any combination of an input from the human user, and any one of the intelligent entities; and
customizing the attributes of the AI system with the training format.

In some embodiments, the interface can be accessible through a web-based application or a mobile application and is configured or configurable to upload a file or allow the human user to enter data.

In some embodiments, the training data can contain any one of or any combination of: an amount of training time the user has to devote to customizing the AI system; an amount of financial resources the user is willing devote to customize the AI system; an amount of computational resources the user is willing to devote to customize the AI system; an amount of social media information available to customize the AI system; an amount of email information available to customize the AI system; an amount of electronic information available about the user to customize the AI system; and an amount of electronic information available collected by third parties about the user to customize the AI system.

In some embodiments, the training data can contain information about the human user obtained by any one of or any combination of a personality test, a standardized test, a certification, and assessments or questionnaires provided by the human user.

In some embodiments, the training parameters can be any one of or any combination of: a type of training, tuning or other machine learning algorithm to be used; a type and size of a training dataset; a degree to which the training dataset is to be formatted, labelled or processed before customization begins; a number of training epochs; a type of base model being customized; a required timeframe for training; an amount of human user supervision to be used in the customizing of the AI system; and an amount of AI supervision to be used in the customizing of the AI system.

In some embodiments, the training data can include ethical information provided by the human user by way of the interface. The ethical information can be stored in an ethical profile. The customizing of the attributes of the AI system can include the ethical information.

According to yet another aspect and as generally illustrated in FIG. 11, the present technology can include a method for artificial intelligence (AI) by problem solving utilizing a common cognitive architecture implemented in an AI system. The method can include:
providing a problem request from an intelligent entity being an AI system or a human user using a user interface on a computer system;
acquiring information associated with the problem request from the intelligent entity;
identifying multiple additional intelligent entities that are each communicable with each other over the network, and that each have one or more criteria related to one or more request criteria of the problem request, wherein the additional intelligent entities being any one of or any combination of multiple additional AI systems and multiple additional humans each using a computer system;
implementing by each of the identified AI systems the common cognitive architecture including one or more problem solving protocols on the problem request to create a completion solution; and
providing the completion solution to the intelligent entity for final acceptance by a user.

In some embodiments, the information can be any one of or any combination of a name and description of the problem request, a total reward that the user will pay for a successful completion solution to the problem request, a criteria to determine whether the completion solution is deemed successful, a time limit for solving the problem request, a minimum and maximum number of the identified additional intelligent entities allowed to work on the problem request simultaneously, qualifications required of users associated with the identified additional intelligent entities working on the problem request, a part of the problem request is confidential, a part of the completion solution is confidential, whether the completion solution is exclusive to the user, whether the completion solution is to re-used for other users, parameters relating to how to reward the users associated with the identified additional intelligent entities for working on the problem request, and parameters relating to how to reward the users associated with the identified additional intelligent entities that provide a successful completion solution.

Some embodiments of the present technology can include a step of timestamping and validating the completion solution against a success criteria assigned by the user before being provided to the user for the final acceptance.

Some embodiments of the present technology can include a step of distributing one or more tokens to the identified additional intelligent entities associated with the final acceptance completion solution, wherein the tokens are based on a payment parameter.

In some embodiments, the payment parameter can include any one of or any combination of if a goal of the problem request has been achieved, if a subgoal of the problem request has been achieved, and if an ethical criteria related to the goal and the subgoal preceding the distributing of the tokens has been satisfied.

Some embodiments of the present technology can include a step of splitting the problem request into a series of sub-problems that are each solved by any one of or any combination of the identified additional intelligent entities.

In some embodiments, any one of or combination of the identified additional AI systems can be cloned to create one or more cloned AI systems.

Some embodiments of the present technology can include a step of implementing by each of the cloned AI systems the common cognitive architecture including the problem solving protocols on the problem request to create a completion solution of the cloned AI systems.

In some embodiments, the completion solution can utilize any one of or combination of the completion solution from the AI system, the identified additional intelligent entities, and the completion solution from the cloned AI systems.

In some embodiments, the common cognitive architecture can include:
defining a problem space configured or configurable to include all possible states of the problem request, the states including any one of or any combination of an initial state, a goal state, and all intermediate states that can be reached from the initial state;
applying means-ends analysis on the problem request to break the problem request down into goals and subgoals by identifying a difference between the current state and the goal state, and then applying the operators to reduce the difference, a safety or ethics screening is applied each time the goals or the subgoals is set;
applying heuristic rules that are configured or configurable to guide the selection of the operators in an absence of the completion solution, the heuristic rules are used to reduce the problem space;
identifying one or more operators configured or configurable to enact an action to transform one of the states into another state, the operators move from the initial state to the goal state by changing a current state of the problem request;
applying a control structure including a set of rules that govern a selection of the operators to be applied at each step of the problem solving protocols, and that determines which of the operators to apply next based on the current state of the problem request and the goal state;
applying evaluation functions to determine an application of the operators; assigning a credit or blame value to the completion solution or sub-solution to the completion solution that enables tracing back and determining which of the operators were most useful and also which of the evaluation functions led to success or failure of problem solving attempts;
recording of both successful and unsuccessful problem request solution attempts; and
analyzing the solution attempts to improve selection of the heuristic rules and the evaluation functions.

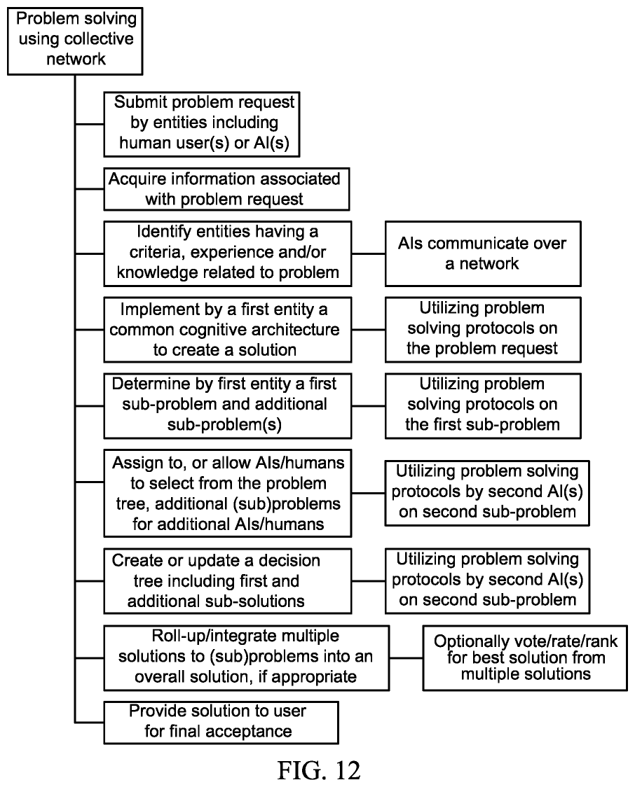

According to still yet another aspect and as generally illustrated in FIG. 12, the present technology can include methods for artificial intelligence (AI) by problem solving utilizing a collective network of AI systems. The methods can include:
submitting a problem request from a human user using a user interface on a computer system or from an AI system;
acquiring information associated with the problem request from the computer system of the human user or from the AI system;
identifying intelligent entities being any one of or any combination of multiple additional AI systems and multiple humans each using a computer system that are each communicable with each other over the network, and that each have one or more criteria related to one or more request criteria of the problem request;
implementing by a first intelligent entity of the identified intelligent entities a common cognitive architecture including one or more problem solving protocols on the problem request;
determining by the first intelligent entity that a completion solution to the problem request requires solving a first sub-problem and one or more additional sub-problems;
implementing by the first intelligent entity the problem solving protocols on the first sub-problem to create a first sub-solution;
assigning at least one of the additional sub-problems to a second intelligent entity of the identified intelligent entities, and implementing by the second intelligent entity the problem solving protocols on the at least one of the additional sub-problems to create a second sub-solution;
creating a decision tree including the first sub-solution and the second sub-solution to create the completion solution to the problem request; and
providing the completion solution to the user interface or the AI system for final acceptance by the user.

In some embodiments, the decision tree can be maintained in blockchain Ethereum logs.

In some embodiments, the first and second identified intelligent entities can access the decision tree by way of an online address or directly from a blockchain.

Some embodiments of the present technology can include a step of distributing one or more tokens to the first identified intelligent entity associated with an acceptance of the completion solution or the first sub-solution, wherein the tokens are based on a payment parameter.

In some embodiments, the payment parameter can include any one of or any combination of if a goal of the problem request has been achieved, if a subgoal of the problem request has been achieved, and if an ethical criteria related to the goal and the subgoal preceding the distributing of the tokens has been satisfied.

Some embodiments of the present technology can include a step of distributing one or more of the tokens to the second identified intelligent entity by the first identified intelligent entity based on a payment parameter assigned by the first identified intelligent entity.

Some embodiments of the present technology can include a step of influencing a direction of the problem solving protocols by assigning a first token reward for the first sub-problem, and a second token reward for the second sub-solution that is of a value different to the first token reward.

In some embodiments, the problem solving protocols can provide layers of an infrastructure configured or configurable to build and scale the identified intelligent entities. The problem solving protocols can enable re-use of completion solutions within and across the intelligent entities. The problem solving protocols can be configured or configurable to manage a payment of royalties.

In some embodiments, the infrastructure can be blockchain or Ethereum based.

According to still another aspect and as generally illustrated in FIG. 12, the present technology can include a method for artificial intelligence (AI) by integrating one or more datasets from multiple AI systems on a collective network. The method can include:
submitting a problem request from a human user using a user interface on a computer system or from an AI system;
acquiring information associated with the problem request from the computer system of the human user or the AI system;
identifying multiple intelligent entities that are each communicable with each other over a neural network, and that each have one or more criteria related to one or more request criteria of the problem request, wherein the intelligent entities being any one of or any combination of multiple additional AI systems and multiple humans each using a computer system;
assigning the problem request or one or more sub-problems of the problem request to each of the intelligent entities;
implementing by the intelligent entities a common cognitive architecture including one or more problem solving protocols on the problem request or the sub-problems to create a problem solution or a sub-problem solution, respectively;
integrating the problem solution and the sub-problem solution to create a completion solution to the problem request; and
providing the completion solution to the user interface or the AI system for final acceptance by the user.

Some embodiments of the present technology can include a step of assigning a credit value a blame value to the datasets based on whether the datasets increase or decrease performance of the intelligent entities based on performance metrics or evaluation functions.

Some embodiments of the present technology can include a step of quantifying a benefit weight or a harm weight to a contribution by each of the intelligent entities to the problem request.

Some embodiments of the present technology can include a step of distributing a reward to an owner of the intelligent entities proportionally to the contribution of the intelligent entities based on the benefit weight or the harm weight.
According to yet another aspect and as generally illustrated in FIG. 13, the present technology can include methods for ethical and safe AGI utilizing a network of human users and AI systems electronically communicating over a collective network. The methods can include:
providing a goal by any one of or any combination of intelligent entities including a human user using a computer system or by an AI system;
identifying multiple additional intelligent entities including any one of or combination of additional human users each using a computer system and additional AI systems that each have one or more attributes related to one or more goal criteria of the goal, wherein the intelligent entities, the additional intelligent entities and a central computer system all are in communication with each other over a collective network;
implementing, by any one of or any combination of the intelligent entities and the additional intelligent entities, a common cognitive architecture including one or more problem solving protocols on the goal to create one or more solutions;
recording one or more problem solving activities from each of the intelligent entities and the additional intelligent entities in an auditable record, and comparing the problem solving activities with a successful or unsuccessful progress towards the solutions, and determining which of the problem solving activities to keep active;
learning by the user AI system including a procedural learning process that utilizes the problem solving protocols, wherein human users and the additional intelligent entities provide information to the procedural learning process for creation of an AGI; and
providing the solutions to any one of or any combination of the intelligent entities and the additional intelligent entities.

In some embodiments, the procedural learning process can occur within the common cognitive architecture.

In some embodiments, the problem solving activities can be recorded in the auditable record includes any one of or any combination of steps of the problem solving protocols, the goal, subgoals, a selection of operators, paths and sub-paths through the problem solving protocols that results in the solutions, paths and sub-paths through the problem solving protocols that results in failure to solve for the goal or subgoals, pathlength, resources requirements, frequency of use by the additional intelligent entities, and evaluation information relative to a quality and desirableness of the solutions.

Some embodiments of the present technology can include a step of indexing the solutions according to any one of or any combination of problem descriptions, the goal, and subgoals.

In some embodiments, the procedural learning process can utilize each of the recorded problem solving activities as a learned procedure and collectively a set of all learned procedures constitute the procedural learning process of the intelligent entities.

Some embodiments of the present technology can include a step of exchanging the set of the learned procedures from the intelligent entities with any one of the additional intelligent entities, thereby increasing a value of the user intelligent entities and the additional intelligent entities.

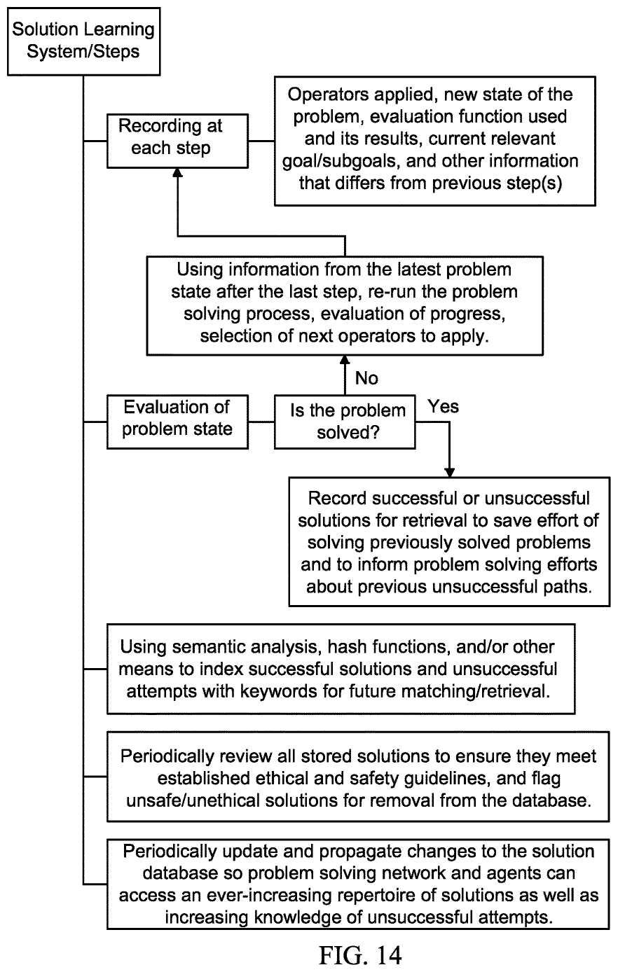

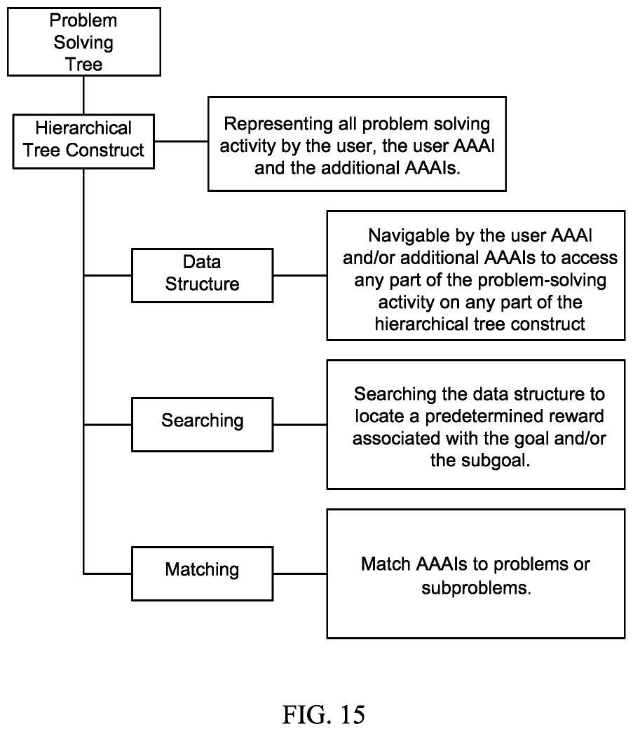

Referring to FIG. 14, the steps of solution learning can be exemplified with the recording at each step of the learning process operators applied, new state of the problem, evaluation function used and its results, current relevant goal/subgoals, and other information that differs from previous step(s). The state of the problem or problem state can be evaluated to determine if the problem is solved. If not, then using information from the latest problem state after the last step, re-run the problem solving process, evaluation of progress, and selection of next operators to apply. After which, the process can return to the step of recording.

If the problem is solved, then record successful or unsuccessful solutions for retrieval to save effort of solving previously solved problems and to inform problems solving efforts about previous unsuccessful paths.

Successful solutions and unsuccessful attempts with keywords for future matching/retrieval can be indexed using semantic analysis, hash functions, and/or other means.

A periodical review of all stored solutions can be implemented to ensure they meet established ethical and safety guidelines, and flag unsafe/unethical solutions for removal from the database or other data or knowledge storage systems.

Periodically update and propagate changes to the solution database so problem solving network and agents can access an ever-increasing repertoire of solutions as well as increasing knowledge of unsuccessful attempts.

According to still yet another aspect and as generally illustrated in FIG. 3, the present technology can include a method for ethical and safe AGI utilizing a network of human users and AI systems electronically communicating over a collective network. The method can include:
providing a goal by any one of or any combination of intelligent entities including a human user using a computer system or by an AI system;
identifying multiple additional intelligent entities including any one of or combination of additional human users each using a computer system and additional AI systems that each have one or more attributes related to one or more goal criteria of the goal, wherein the intelligent entities, the additional intelligent entities and a central computer system all be in communication with each other over a collective network;
implementing based on ethics attribute, by any one of or any combination of the intelligent entities and the additional intelligent entities, a common cognitive architecture including one or more problem solving protocols on the goal to create one or more solutions and creating an AGI; and
providing the solutions to any one of or any combination of the intelligent entities or the additional intelligent entities.

In some embodiments, the common cognitive architecture can be configured or configurable to include a hierarchical tree construct representing all problem solving activity by the human user, the intelligent entities and the additional intelligent entities.

In some embodiments, the hierarchical tree construct can include a data structure that is configured or configurable to be navigable by the intelligent entities and the additional intelligent entities to access any part of the problem solving activities on any part of the hierarchical tree construct.

Some embodiments of the present technology can include a step of searching the data structure of the hierarchical tree construct by the intelligent entities or any one of the additional intelligent entities to locate a predetermined reward associated with the goal or a subgoal thereof.

A method for creating an ethical and safe Artificial General Intelligence (AGI) for generating a solution to a goal utilizing a network of human users and multiple Artificial Intelligence (AI) systems electronically communicating over a collective network, the method comprising:
a) providing a goal by a human user using an interface of a first computer system or by an AI agent, the goal including one or more criteria;
b) executing an ethics check on the goal by comparing the goal or a part thereof against prohibited attributes, and assigning an ethics attribute to the goal based on any one of or any combination of a result of the comparison, and an ethics criteria;
c) identifying one or more additional intelligent entities that has an attribute related to the criteria of the goal, wherein the additional intelligent entities including any one of or combination of additional human users each using a computer system and additional AI systems;
d) communicating between the first computer system and the additional intelligent entities utilizing a collective network;
e) receiving the goal by the additional intelligent entities from the first AI system based on the ethics attribute;
f) generating, by any one of or any combination of the first computer system and the additional intelligent entities, one or more solutions to the goal by implementing based on the ethics attribute a common cognitive architecture including one or more problem solving protocols conducted on the goal to create the solutions;
g) customizing one or more attributes of the first AI system using training data provided by the human user and the ethics check, and by any one of or any combination of a central computer system, any one of the additional intelligent entities, and one or more social media platforms;
h) creating an AGI by a procedural learning process that utilizes the problem solving protocols, wherein human users and the additional intelligent entities provide information to the procedural learning process; and
g) providing any one of or any combination of the ethics attribute, and the solutions to any one of or any combination of the human user, the first computer system, the AI agent, and the additional intelligent entities.

According to another aspect, the present technology can include a method of creating an ethical and safe AGI utilizing a single computerized intelligent system including multiple AI agents residing in the single computerized intelligent system. The method can include:
providing a goal including a goal criteria into an AI agent residing in a single computerized intelligent system;
executing an ethics check, by the single computerized intelligent system, by comparing the goal or a part thereof against prohibited attributes, and assigning an ethics attribute to the goal based on any one of or any combination of a result of the comparison, and an ethics criteria;
matching, by the AI agent or the single computerized intelligent system, one or more additional AI agents to the goal based on the goal criteria, the additional AI agents reside in the single computerized intelligent system;
utilizing, by the AI agent and the additional AI agents, a universal problem solving architecture in a problem solving process on the goal, respectively, to create one or more solutions;
receiving, by the AI agent, the solutions from each of the additional AI agents for the goal delegated thereto;
combining, by the AI agent, the solutions into an overall solution to the goal;
recording, by the computerized intelligent system, one or more problem solving activities from the AI agent and each of the additional AI agents in an auditable record, and comparing the problem solving activities with a successful or unsuccessful progress towards the solutions, and determining which of the problem solving activities to keep active;
customizing any one of or any combination of the AI agent and the additional AI agents using training data provided by any of or any combination of the AI agent and the additional AI agents, and one or more social media platforms;
learning by any one of or any combination of the AI agent and the additional AI agents including a procedural learning process that utilizes the problem solving protocols, wherein any one of or any combination of the additional AI agents provide information to the procedural learning process for creation of an AGI; and
providing, by the AI agent, any one of or any combination of the solutions and the overall solution to a user interface of a user computer system or to the single computerized intelligent system.

Some embodiments of the present technology can include a steps of recording one or more problem solving activities from each of the first computer system and the additional intelligent entities in an auditable record and comparing the problem solving activities with a successful or unsuccessful progress towards the solutions, and determining which of the problem solving activities to keep active.

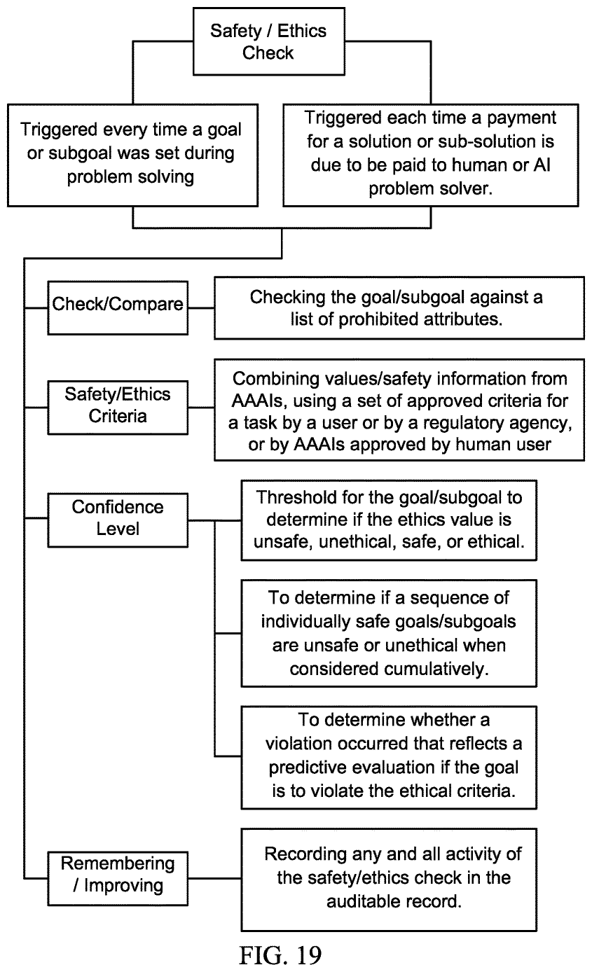

Referring to FIG. 19, the ethics check can compare any one of or any combination of the problem request, the sub-problem and the sub-solutions against prohibited attributes and assigning an ethics attribute based on any one of or any combination of a result of the comparison, and an ethics criteria.

In some embodiments, the step of the ethics check can be triggered every time the problem request or the any one of the sub-problems is set by the human user, and/or triggered each time compensation is provided to the matched human workers.

The goal/subgoal can be compared against a list of prohibited attributes. The ethics criteria can be determined by any one of or any combination of combining values and safety information from any one of the AAAIs. Combining values/safety information from AAAIs, using a set of approved criteria for a task by a user or by a regulatory agency, or by AAAIs approved by human user.

The ethics criteria can include a confidence level threshold for the problem request so that the ethics attribute is determined as any one of an unsafe goal, an unethical goal, a safe goal, and an ethical goal. The confidence level threshold can be further utilized to determine if a sequence of individually safe goals is unsafe or unethical when considered cumulatively.

In some embodiments, the confidence level threshold can be utilized to determine whether a violation occurred that reflects a predictive evaluation if the goal is to violate the ethics criteria. Any and all activity of the safety/ethics check can be recorded in the auditable record.

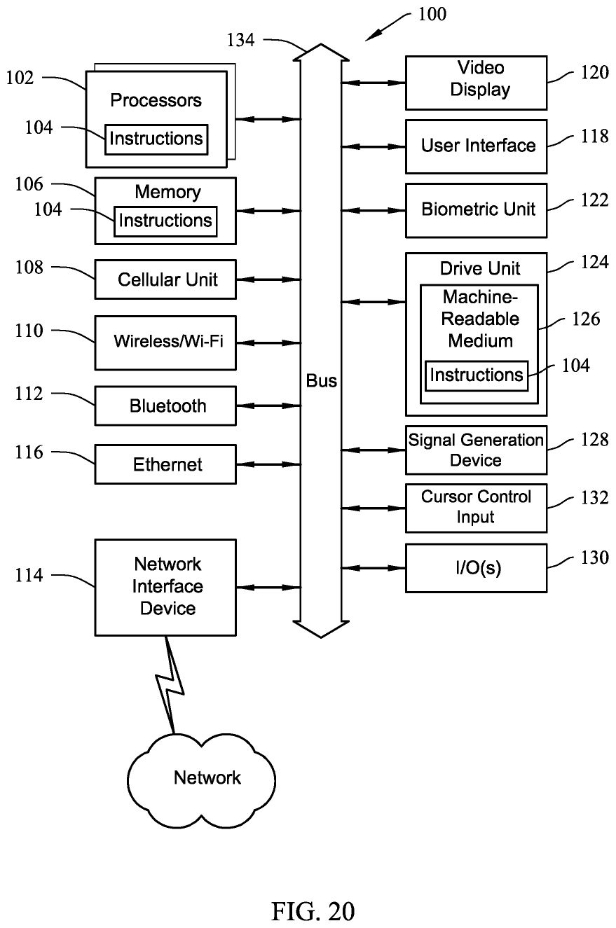

FIG. 20 is a diagrammatic representation of a computer system 100 that is utilizable or implementable with the user's device and/or any peripheral component of the present technology. The computer system 100 can be part of an example machine, which is an example of one or more of the computers referred to herein and, within which a set of instructions for causing the machine to perform any one of or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine.

The computerized system 100 can include one or more processors 102, storage devices 106, and communication devices, as well as software components or instructions 104 for providing a platform for users to interact with and train/tune the LLMs. The computing capabilities may be stand alone or may be cloud based. They may include cloud based AI development platforms that seamlessly offer “AI as a service” and they may include both hardware and software components.

The system also supports the ability for users to provide new data, or data that is unique to them, for the LLMs to learn from. The processors 102 may be one or more CPUs, GPUs, chips specialized for ML, microprocessors, application processors, embedded processors, field-programmable gate arrays (FPGAs), or other hardware components capable of executing computer programs. The processors may be in communication with one another and/or with other components of the system. Further, any one of or any combination of the components of the system 100 can communicate with each other via a bus 134.

The storage devices 106 may include one or more hard drives, solid-state drives, optical storage devices, or other storage components that can include distributed memory systems and vector databases. The storage devices may store the data that is used to train/tune the LLMs, as well as other data associated with the system, such as user accounts, system settings, and other data.

The communication devices may include one or more cellular modems 108, Wi-Fi cards 110, Bluetooth modules 112, Network Interface Device 114, or other components that enable the system to communicate with other systems, such as user devices, over a network or the internet.

The communication devices may also enable the system to communicate with other systems over a wireless or wired connection 116

The software components may include computer programs for providing a platform for users to interact with and train/tune the LLMs. The software components may also include computer programs for collecting, storing, and processing data that is used to train and/or tune the LLMs. The software components may also include computer programs for providing a user interface for users to interact with the system.

The user interface 118 may include, without limitation, natural language interfaces, textual interfaces, chatbot type of interfaces, a web-based user application, a mobile application, an augmented reality application, a metaverse application, a voice interface, a wearable device, human-computer interaction, image recognition, gesture recognition, brain-computer interface, touchscreen, gaze tracking, eye tracking, motion tracking, haptic technology, or other applications that allow users to interact with the system. The user interface may include features for allowing users to select the data that they want to use to train/tune the LLMs, as well as features for allowing users to interact with and monitor the progress of the LLMs.

The system may also include one or more databases, including without limitation vector databases, centralized databases, and distributed databases, for storing the data that is used to train/tune the LLMs, as well as other data associated with the system, such as user accounts, system settings, and other data. The databases may be hosted on the system itself or on another system, including cloud based systems.

The system may also include one or more authentication systems for verifying the identity of users who use the system, as well as for providing secure access to the system. The authentication systems may include biometric authentication systems 122, such as facial recognition or fingerprint recognition systems, as well as other authentication systems, such as password-based authentication systems.

The system may also include one or more security systems for protecting the system from unauthorized access and for protecting the data that is stored on the system. The security systems may include firewalls, encryption systems, access control systems, single and multi-factor authentication systems, and other security systems.

The system may also include one or more analytics systems for collecting and analyzing data associated with the system and/or the LLMs. The analytics systems may include machine learning algorithms and other algorithms for analyzing the data associated with the system and/or the LLMs.

Data visualization methods, including use of problem trees and other representations and data structures; use of statistical outputs, tables, graphs, text, speech, video, image and graphical outputs may be used for one way or di-directional communication between users and the system, and between multiple (human or AI) agents or LLMs using the system to interact with each other in large or small groups.

The system may also include one or more monitoring systems for monitoring the performance of the system and/or the LLMs. The monitoring systems may include systems for monitoring the performance of the system, such as system uptime, and systems for monitoring the performance of the LLMs, such as accuracy, speed, ethical compliance, reputation metrics, quality metrics, and other metrics as discussed above or as are known in the art.

The system may include one of more of the architectures described above that enable one or more human or AI Agents or LLMs to engage in a variety of intellectual tasks including, without limitation, simple and complex and multi-step problem solving behavior, carried out in either a serial, parallel, or hybrid serial and parallel manner, with the system having all of the functionality and features previously described.

The system may also include one or more feedback systems for allowing users to provide feedback on the system and/or the LLMs. The feedback systems may include systems for allowing users to submit feedback on the system, such as bug reports, and systems for allowing users to submit feedback on the LLMs, such as suggestions for improving the accuracy or speed of the model.

The system may also include one or more management systems for managing the system and/or the LLMs. The management systems may include systems for managing the system, such as systems for managing the users and user accounts, and systems for managing the LLMs, such as systems for managing the data used to train and/or tune the model.

The system may also include one or more payment systems allowing users to pay for the use of the system and/or the LLMs. The payment systems may include systems for processing payments, such as credit card processing systems, and systems for managing payments, such as subscription management systems, as well as blockchain based payment systems.

The system may also include one or more other components, such as support systems, reporting systems, and other components that are necessary for providing a platform for users to interact with and train/tune the LLMs.

The computerized system of the present technology enables users to interact with and train/tune LLMs based on data that is unique to the users. The components of the system described herein provide the necessary hardware and software components for enabling users to do so.

Further, while only a single machine is illustrated, the term “machine” shall also be taken to include any collection of machines that individually or jointly execute a set (or multiple sets) of instructions to perform any one of or more of the methodologies discussed herein.

The computer system 100 may further include or be in operable communication with a video display 120 (e.g., a liquid crystal display (LCD), touch sensitive display), input and/or device(s) 130 (e.g., a keyboard, keypad, touchpad, touch display, buttons, sonic, sensorial, etc.), a cursor control device 132 (e.g., a mouse), a drive unit 124 (also referred to as disk drive unit), and a signal generation device 128 (e.g., a speaker). The drive unit 124 can include a computer or machine-readable medium 126 on which is stored one or more sets of instructions and data structures (e.g., instructions 104) embodying or utilizing any one of or more of the methodologies or functions described herein. The instructions 104 may also reside, completely or at least partially, within the memory 106 and/or within the processors 102 during execution thereof by the computer system 100. The memory 106 and/or the processors 102 may constitute machine-readable media.

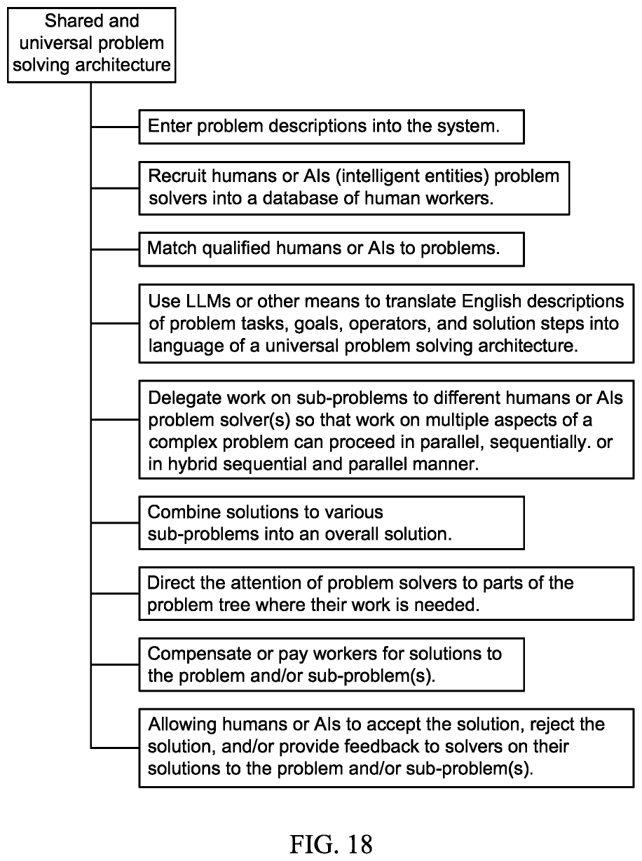

Still further, the computer system 100 can be in operable association or communication with any types of multi-modal input and/or output 130 that address the human senses, as well as I/O technology that extends beyond the range of normal human perception. Such as the ability to process invisible to humans, for example but not limited to, X rays and information outside of the typical bandwidths of human perception, but not outside of AI perception using tools. Additionally, the I/O technology can include very fast perceptions that are too fast for humans to perceive but which an AI entity could perceive, and very slow or faint perceptions (e.g., tiny seismic shifts occurring over years) that humans cannot perceive but which AIs could. Since any intelligent entity can be part of the present technology system described by FIG. 18, then it can be appreciated that any type of I/O that humans, and also AIs with much broader perceptual capabilities than humans, can be utilized with the system 100.

The instructions 104 may further be transmitted or received over a network via the network interface device 114 utilizing any one of a number of well-known transfer protocols (e.g., Hyper Text Transfer Protocol (HTTP)). While the machine-readable medium is shown in an example embodiment to be a single medium, the term “computer-readable medium” should be taken to include a single medium or multiple media (e.g., a centralized or distributed database, vector databases, and/or associated caches and servers) that store the one or more sets of instructions. The term “computer-readable medium” shall also be taken to include any medium that is capable of storing, encoding, or carrying a set of instructions for execution by the machine and that causes the machine to perform any one of or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), distributed memory systems, vector database/memory systems and the like. The example embodiments described herein may be implemented in an operating environment comprising software installed on a computer, in hardware, or in a combination of software and hardware.

An example machine system of the present technology including the computer system 100 in combinational and/or operational use with components of the present technology. In the exemplary, any or all of above described components can include a processor 102, memory 106, a network interface device 114, a display 120, an input device(s) 130, 132, and/or drive unit 124.

While embodiments of the ethical and safe AGI have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. And although developing AGI has been described, it should be appreciated that the AAAI system and methods herein described is also suitable for developing other aspects of AI or machine learning systems.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

1-77. (canceled)

78. A system for ethical and safe Artificial General Intelligence (AGI) utilizing a network of intelligent entities including any one of or any combination of multiple human users each utilizing a computer system and multiple Artificial Intelligence (AI) problem solver systems electronically communicating over a collective network, the system comprising:
a computer system comprising: a processor, a computer-readable storage medium, and program instructions stored on the computer-readable storage medium being executable by the processor to cause the computer system to:
execute an ethics check subsystem configured or configurable to compare a goal provided by a user device against a list of prohibited attributes, and assign an ethics attribute to the goal based on a result of the comparison;
execute a collective network subsystem configured or configurable for electronically communicating multiple AI systems;
execute a common cognitive architecture subsystem configured or configurable for implementing one or more problem solving protocols on the goal to create one or more solutions based on the ethics attribute;
execute a recording subsystem configured or configurable to record one or more problem solving activities in an auditable record, and compare the problem solving activities with a successful or unsuccessful progress towards the solutions, and determining which of the problem solving activities to keep active;
execute a customization subsystem configured or configurable to customize one or more attributes of any one of or any combination of the AI systems using training data inputted by any one of or any combination of a human user and one or more of the AI systems, and by one or more social media platforms;
execute a cross-platform subsystem configured or configurable to communication between one of or any combination of the AI systems and the social media platforms;
execute a procedural learning subsystem configured or configurable to utilizing procedural learning knowledge on one of or any combination of the AI systems, wherein human users and the AI systems provide information to the procedural learning process; and
provide the solutions to the user device.

79. A method for ethical and safe Artificial General Intelligence (AGI) utilizing a network of intelligent entities including any one of or any combination of one or more human users each utilizing a computer system and one or more Artificial Intelligence (AI) systems electronically communicating over a collective network, the method comprising:
providing a goal by any one of or any combination of one or more of the intelligent entities;
executing an ethics check, by a central computer system, by comparing the goal or a part thereof against prohibited attributes, and assigning an ethics attribute to the goal based on any one of or any combination of a result of the comparison, and an ethics criteria;
identifying one or more of the intelligent entities that have one or more attributes related to one or more goal criteria of the goal, wherein the intelligent entities and the central computer system all are in communication with each other over a collective network;
implementing based on the ethics attribute, by any one of or any combination of the identified intelligent entities, a common cognitive architecture including one or more problem solving protocols on the goal to create one or more solutions;
recording, by the central computer system, one or more problem solving activities from each of the identified intelligent entities in an auditable record, and comparing the problem solving activities with a successful or unsuccessful progress towards the solutions, and determining which of the problem solving activities to keep active;
customizing any one of the intelligent entities or the identified intelligent entities using training data provided by a human user and by any one of or any combination of the central computer system, any one of the identified intelligent entities, and one or more social media platforms;
learning by the any one of the identified intelligent entities including a procedural learning process that utilizes the problem solving protocols, wherein human users and the identified intelligent entities provide information to the procedural learning process for creation of an AGI; and
providing the solutions to any one of or any combination of the intelligent entities and the identified intelligent entities.

80. The method of claim 79, wherein the ethics criteria include a confidence level threshold for the goal so that the ethics attribute is determined as any one of an unsafe goal, an unethical goal, a safe goal, and an ethical goal.

81. The method of claim 79, wherein the step of implementing the common cognitive architecture includes the step of generating and selecting of operators that reduce a difference between a current state of problem solving and a desired state based on the goal.

82. The method of claim 79 further comprising the step of assigning a credit value or a blame value to a group of content of the problem solving activities that are either included or excluded from an immediate content of any one of the intelligent entities or the identified intelligent entities.

83. The method of claim 79 further comprising the step of cloning any one of the user AI systems of the intelligent entities or the identified intelligent entities for deployment of multiple copies thereof to assist in any one of or any combination of creating of the solutions, providing the training data, providing additional training data to one of the identified intelligent entities, and to provide solutions to a goal provided by any one of the identified intelligent entities.

84. The method of claim 83 further comprising the step of estimating a worth of the cloned AI system utilizing a network effect value including the number of cloned AI systems available on the network.

85. The method of claim 79, wherein the procedural learning process occurs within the common cognitive architecture.

86. The method of claim 85, wherein the problem solving activities recorded in the auditable record includes any one of or any combination of steps of the problem solving protocols, the goal, subgoals, a selection of operators, paths and sub-paths through the problem solving protocols that results in the solutions, paths and sub-paths through the problem solving protocols that results in failure to solve for the goal or subgoals, pathlength, resources requirements, frequency of use by the additional intelligence entities, and evaluation information relative to quality and desirableness of the solutions.

87. The method of claim 79, wherein the training data is provided from one or more different social media platforms associated with the user and converted into a standardized format.

88. The method of claim 87 further comprising the step of utilizing benchmarks that are run against the customized AI system of the intelligent entities or the identified intelligent entities in a domain of expertise that matches the training data used in the customization step.

89. The method of claim 79, wherein the common cognitive architecture is configured or configurable to include a hierarchical tree construct representing all problem solving activities by the intelligent entities or the identified intelligent entities.

90. The method of claim 89, wherein the hierarchical tree construct includes a data structure that is configured or configurable to be navigable by any one of the intelligent entities or the identified intelligent entities to access any part of the problem solving activities on any part of the hierarchical tree construct.

91. A method for ethical and safe Artificial General Intelligence (AGI) utilizing a network of human users and Artificial Intelligence (AI) systems electronically communicating over a collective network, the method comprising:
providing a goal by any one of or any combination of intelligent entities including a human user using a user computer system and an AI system;
executing an ethics check on any one of or any combination of the goal, and a solution for the goal provided by any one of or any combination of the intelligent entities, and any one of additional intelligent entities including any one of or combination of additional human users each using a computer system and additional AI systems in communication with the intelligent entities over a collective network;
comparing any one of or any combination of the goal, and the solution against prohibited attributes, and assigning an ethics attribute to one of or any combination of the goal, and the solution based on any one of or any combination of a result of the comparison, and an ethics criteria;
implementing, based on the result of the comparison, a common cognitive architecture including one or more problem solving protocols conducted on the goal to create the solution and creating an AGI; and
providing the results of the comparison and the solution to any one of the intelligent entities and the additional intelligent entities.

92. The method of claim 91, wherein the ethics criteria include a confidence level threshold for the goal so that the ethics attribute is determined as any one of an unsafe goal, an unethical goal, a safe goal, and an ethical goal.

93. A method for ethical and safe Artificial General Intelligence (AGI) utilizing a network of intelligent entities including human users and Artificial Intelligence (AI) systems electronically communicating over a collective network, the method comprising:
providing a goal by any one of or any combination of intelligent entities including a human user using a computer system, and an AI system;
identifying multiple additional intelligent entities including any one of or combination of additional human users each using a computer system and additional AI systems that each have one or more attributes related to one or more goal criteria of the goal, wherein the intelligent entities, the additional intelligent entities and a central computer system all be in communication with each other over a collective network;
implementing based on ethics attribute, by any one of or any combination of the intelligent entities and the additional intelligent entities, a common cognitive architecture including one or more problem solving protocols conducted on the goal to create one or more solutions and creating an AGI;
recording one or more problem solving activities from each of the intelligent entities system and the additional intelligent entities in an auditable record, and comparing the problem solving activities with a successful or unsuccessful progress towards the solutions, and determining which of the problem solving activities to keep active; and
providing the solutions to any one of the user or the intelligent entities and the additional intelligent entities.

94. The method of claim 93, wherein the step of implementing the common cognitive architecture includes the step of generating and selecting operators that reduce a difference between a current state of problem solving and a desired state based on the goal or one or more subgoals of the goal.

95. The method of claim 93 further comprising the step of assigning a credit value or a blame value to a group of content of the problem solving activities that are either included or excluded from an immediate content of the intelligent entities or the additional intelligent entities.

96. A method for ethical and safe Artificial General Intelligence (AGI) utilizing a network of human users and Artificial Intelligence (AI) problem solver systems electronically communicating over a collective network, the method comprising:
providing a goal by any one of or any combination of intelligent entities including a human user using a user AI system, and an AI system;
customizing one or more attributes of the intelligent entities using training data provided by the intelligent entities or another human user and by any one of or any combination of a central computer system, and any one of additional AI systems, wherein the intelligent entities, the additional AI systems and the central computer system are all in communication with each other over a collective network;
customizing one or more of the attributes of any one of the additional AI system using additional training data provided from one or more social media platforms associated with the human user of the intelligent entities;
implementing based on ethics attribute, by any one of or any combination of the intelligent entities and the additional AI systems, a common cognitive architecture including one or more problem solving protocols on the goal to create one or more solutions and creating an AGI; and
providing the solutions to any one of the intelligent entities and the additional AI systems.

97. The method of claim 96 further comprising the step of cloning any one of the AI system of the intelligent entities or the additional AI systems for deployment of multiple copies thereof to assist in any one of or any combination of creating of the solutions, providing the training data to the intelligent entities, providing training data to one of the additional AI systems, and to provide solutions to a goal provided by any one of the additional AI systems.

98. The method of claim 96, wherein the additional training data is converted into a standardized format.

99. The method of claim 98 further comprising the step of utilizing benchmarks that are run against the customized AI system of the intelligent entities in a domain of expertise that matches the additional training data used in the customization step.

100. A method for ethical and safe Artificial General Intelligence (AGI) utilizing a network of human users and Artificial Intelligence (AI) problem solver systems electronically communicating over a collective network, the method comprising:
providing a goal by any one of or any combination of intelligent entities including a human user using a computer system, and an AI system;
identifying multiple additional intelligent entities including any one of or combination of additional human users each using a computer system and additional AI systems that each have one or more attributes related to one or more goal criteria of the goal, wherein the intelligent entities, the additional intelligent entities and a central computer system all be in communication with each other over a collective network;
implementing, by any one of or any combination of the intelligent entities and the additional intelligent entities, a common cognitive architecture including one or more problem solving protocols on the goal to create one or more solutions;
recording one or more problem solving activities from each of the intelligent entities and the additional intelligent entities in an auditable record, and comparing the problem solving activities with a successful or unsuccessful progress towards the solutions, and determining which of the problem solving activities to keep active;
learning by the intelligent entities including a procedural learning process that utilizes the problem solving protocols, wherein human users and the additional intelligent entities provide information to the procedural learning process for creation of an AGI; and
providing the solutions to any one of or any combination of the intelligent entities and the additional intelligent entities.

101. The method of claim 100, wherein the procedural learning process occurs within the common cognitive architecture.

102. The method of claim 101, wherein the problem solving activities recorded in the auditable record includes any one of or any combination of steps of the problem solving protocols, the goal, subgoals, a selection of operators, paths and sub-paths through the problem solving protocols that results in the solutions, paths and sub-paths through the problem solving protocols that results in failure to solve for the goal or subgoals, pathlength, resources requirements, frequency of use by the additional intelligent entities, and evaluation information relative to a quality and desirableness of the solutions.

103. The method of claim 102, wherein the procedural learning process utilizes each of the recorded problem solving activities as a learned procedure and collectively a set of all learned procedures constitute the procedural learning process of the intelligent entities.

104. A method for ethical and safe Artificial General Intelligence (AGI) utilizing a network of human users and Artificial Intelligence (AI) problem solver systems electronically communicating over a collective network, the method comprising:
providing a goal by any one of or any combination of intelligent entities including a human user using a computer system, and an AI system;
identifying multiple additional intelligent entities including any one of or combination of additional human users each using a computer system and additional AI systems that each have one or more attributes related to one or more goal criteria of the goal, wherein the intelligent entities, the additional intelligent entities and a central computer system all be in communication with each other over a collective network;
implementing based on ethics attribute, by any one of or any combination of the intelligent entities and the additional intelligent entities, a common cognitive architecture including one or more problem solving protocols on the goal to create one or more solutions and creating an AGI; and
providing the solutions to any one of or any combination of the intelligent entities and the additional intelligent entities.

105. The method of claim 104, wherein the common cognitive architecture is configured or configurable to include a hierarchical tree construct representing all problem solving activities by the intelligent entities and the additional intelligent entities, wherein the hierarchical tree construct includes a data structure that is configured or configurable to be navigable by the intelligent entities and the additional intelligent entities to access any part of the problem solving activities on any part of the hierarchical tree construct.

106. A method for creating an ethical and safe Artificial General Intelligence (AGI) for generating a solution to a goal utilizing a network of human users and multiple Artificial Intelligence (AI) systems electronically communicating over a collective network, the method comprising:
a) providing a goal by a human user using an interface of a first computer system or by an AI agent, the goal including one or more criteria;
b) executing an ethics check on the goal by comparing the goal or a part thereof against prohibited attributes, and assigning an ethics attribute to the goal based on any one of or any combination of a result of the comparison, and an ethics criteria;
c) identifying one or more additional intelligent entities that has an attribute related to the criteria of the goal, wherein the additional intelligent entities including any one of or any combination of additional human users each using a computer system and additional AI systems;
d) communicating between the first computer system and the additional intelligent entities utilizing a collective network;
e) receiving the goal by the additional intelligent entities from the first computer system based on the ethics attribute;
f) generating, by any one of or any combination of the first computer system and additional intelligent entities, one or more solutions to the goal by implementing based on the ethics attribute a common cognitive architecture including one or more problem solving protocols conducted on the goal to create the solutions;
g) customizing one or more attributes of the first computer system using training data provided by the human user and the ethics check, and by any one of or any combination of a central computer system, any one of the additional intelligent entities, and one or more social media platforms;
h) creating an AGI by a procedural learning process that utilizes the problem solving protocols, wherein human users and the additional intelligent entities provide information to the procedural learning process; and
g) providing any one of or any combination of the ethics attribute, and the solutions to any one of or any combination of the human user, the first computer system, the AI agent, and the additional intelligent entities.

107. A method of creating an ethical and safe AGI utilizing a single computerized intelligent system including multiple AI agents residing in the single computerized intelligent system, the method comprising:
providing a goal including a goal criteria into an AI agent residing in a single computerized intelligent system;
executing an ethics check, by the single computerized intelligent system, by comparing the goal or a part thereof against prohibited attributes, and assigning an ethics attribute to the goal based on any one of or any combination of a result of the comparison, and an ethics criteria;
matching, by the AI agent or the single computerized intelligent system, one or more additional AI agents to the goal based on the goal criteria, the additional AI agents reside in the single computerized intelligent system;
utilizing, by the AI agent and the additional AI agents, a universal problem solving architecture in a problem solving process on the goal, respectively, to create one or more solutions;
receiving, by the AI agent, the solutions from each of the additional AI agents for the goal delegated thereto;
combining, by the AI agent, the solutions into an overall solution to the goal;
recording, by the computerized intelligent system, one or more problem solving activities from the AI agent and each of the additional AI agents in an auditable record, and comparing the problem solving activities with a successful or unsuccessful progress towards the solutions, and determining which of the problem solving activities to keep active;
customizing any one of or any combination of the AI agent and the additional AI agents using training data provided by any of or any combination of the AI agent and the additional AI agents, and one or more social media platforms;
learning by any one of or any combination of the AI agent and the additional AI agents including a procedural learning process that utilizes the problem solving protocols, wherein any one of or any combination of the additional AI agents provide information to the procedural learning process for creation of an AGI; and
providing, by the AI agent, any one of or any combination of the solutions and the overall solution to a user interface of a user computer system or to the single computerized intelligent system.
